(19) United States
(12) Patent Application Publication
(10) Pub. No.: US 2026/0350240 A1
(43) Pub. Date: Nov. 5, 2026

(54) SYSTEM FOR DETECTION AND REMEDIATION OF SECURITY CONFIGURATION DRIFTS IN WEB APPLICATIONS USING INTERFACE-CENTRIC AI AGENTS

(71) Applicant: RedBlock Security, Inc., San Ramon, CA (US)

(72) Inventors: Indus KHAITAN, Dublin, CA (US); Rajvardhan KHAITAN, Dublin, CA (US); Basem RIZK, Pleasant Hill, CA (US); Aviral SRIVASTAVA, Bengaluru (IN)

(73) Assignee: RedBlock Security, Inc., San Ramon, CA (US)

(21) Appl. No.: 19/666,228

(22) Filed: May 2, 2026

Related U.S. Application Data
(60) Provisional application No. 63/799,167, filed on May 2, 2025.
(60) Provisional application No. 63/799,176, filed on May 2, 2025.
(60) Provisional application No. 63/799,184, filed on May 2, 2025.
(60) Provisional application No. 63/799,188, filed on May 2, 2025.
(60) Provisional application No. 63/799,193, filed on May 2, 2025.
(60) Provisional application No. 63/799,199, filed on May 2, 2025.
(60) Provisional application No. 63/810,356, filed on May 22, 2025.
(60) Provisional application No. 63/837,276, filed on Jul. 2, 2025.
(60) Provisional application No. 63/872,640, filed on Aug. 29, 2025.
(60) Provisional application No. 63/872,656, filed on Aug. 29, 2025.
(60) Provisional application No. 63/872,665, filed on Aug. 29, 2025.
(60) Provisional application No. 63/878,629, filed on Sep. 9, 2025.
(60) Provisional application No. 63/880,059, filed on Sep. 11, 2025.
(60) Provisional application No. 63/881,837, filed on Sep. 15, 2025.
(60) Provisional application No. 63/887,721, filed on Sep. 25, 2025.

(51) Int. Cl. G06F 21/84; G06F 3/0482; G06F 3/04847; G06F 21/45; G06F 21/57

(52) U.S. Cl. CPC G06F 21/84; G06F 3/0482; G06F 3/04847; G06F 21/45; G06F 21/577

(57) ABSTRACT

A computer-implemented technique for automated compliance verification and remediation of interface elements in a graphical user interface of a web application is disclosed. A language model determines, for each interface element associated with a security configuration setting, a first compliance state based on on-screen textual content visible at runtime. For interface elements identified as non-compliant with a predefined security baseline, a configuration state is altered through simulated user interaction. A second compliance state is determined from updated on-screen textual content produced in response to the simulated interaction, and the altered interface element is confirmed against an expected compliant configuration. The technique further supports generation of verification failure alerts and tamper-evident audit records. The approach accommodates dynamic interface changes and enables periodic compliance enforcement across multiple web applications, thereby improving consistency, auditability, and reliability of security configuration management.

### PRIORITY PARA

This application claims the benefit of U.S. Provisional Patent Application No. 63/799,167, filed on May 2, 2025, titled “SYSTEM AND METHOD FOR AGGREGATING API KEYS FROM APPLICATIONS USING ARTIFICIAL INTELLIGENCE”; U.S. Provisional Patent Application No. 63/799,176, filed on May 2, 2025, titled “SYSTEM AND METHOD FOR UPDATING AND PROPAGATING API KEYS USING ARTIFICIAL INTELLIGENCE”; U.S. Provisional Patent Application No. 63/799,184, filed on May 2, 2025, titled “SYSTEM FOR REPORTING AND ACTIONING OF USER ROLES IN IDENTITY GOVERNANCE CONTEXT USING ARTIFICIAL INTELLIGENCE”; U.S. Provisional Patent Application No. 63/799,188, filed on May 2, 2025, titled “SYSTEM FOR DETECTION AND REMEDIATION OF SECURITY CONFIGURATION DRIFTS IN WEB APPLICATIONS USING INTERFACE-CENTRIC AI AGENTS”; U.S. Provisional Patent Application No. 63/799,193, filed on May 2, 2025, titled “SYSTEM AND METHOD FOR CAPTURING AND AUDITING WEB-BASED AI AGENT INTERACTIONS”; U.S. Provisional Patent Application No. 63/799,199, filed on May 2, 2025, titled “SYSTEM AND METHOD FOR AUTOMATED CREDENTIAL GENERATION AND PROPAGATION BASED ON ARTIFICIAL INTELLIGENCE AGENTS”; U.S. Provisional Patent Application No. 63/810,356, filed on May 22, 2025, titled “System and Method for Deterministic Validation of Automation Workflows Guided by Large Language Models”; U.S. Provisional Patent Application No. 63/837,276, filed on Jul. 2, 2025, titled “SYSTEM AND METHOD FOR AUTOMATED EXPLORATION OF APPLICATION SOFTWARE”; U.S. Provisional Patent Application No. 63/880,059, filed on Sep. 11, 2025, titled “SYSTEM AND METHOD FOR AUTOMATED EXPLORATION OF APPLICATION SOFTWARE”; U.S. Provisional Patent Application No. 63/872,640, filed on Aug. 29, 2025, titled “SYSTEM AND METHOD FOR INTEGRATING NON-API APPLICATIONS WITH IDENTITY PLATFORMS BASED ON ARTIFICIAL INTELLIGENCE”; U.S. Provisional Patent Application No. 63/878,629, filed on Sep. 9, 2025, titled “SYSTEM AND METHOD FOR INTEGRATING NON-API APPLICATIONS WITH IDENTITY PLATFORMS BASED ON ARTIFICIAL INTELLIGENCE”; U.S. Provisional Patent Application No. 63/887,721, filed on Sep. 25, 2025, titled “HIERARCHICAL STRUCTURING OF GRAPHICAL USER INTERFACE ELEMENTS IN APPLICATION SOFTWARE PAGES”; U.S. Provisional Patent Application No. 63/872,656, filed on Aug. 29, 2025, titled “SYSTEM AND METHOD FOR IDENTITY-CENTRIC ACTIVITY LOG CAPTURE FROM APPLICATIONS LACKING PROGRAMMATIC INTERFACES”; U.S. Provisional Patent Application No. 63/872,665, filed on Aug. 29, 2025, titled “AGENTIC ARTIFICIAL INTELLIGENCE FOR AUTOMATED CONNECTOR CONFIGURATION AND APPLICATION ONBOARDING IN IDENTITY PLATFORMS”; and U.S. Provisional Patent Application No. 63/881,837, filed on Sep. 15, 2025, titled “TASK-SPECIFIC HIGH-LEVEL LANGUAGE FRAMEWORK FOR STRUCTURED INTERACTION WITH LARGE LANGUAGE MODELS”. All of the foregoing provisional applications are hereby incorporated by reference for all purposes.

### TECHNICAL FIELD

The technology disclosed relates to artificial-intelligence-type computers, digital data processing systems, corresponding data processing methods, and products for emulation of intelligence, including knowledge-based systems, reasoning systems, knowledge acquisition systems, systems for reasoning with uncertainty, adaptive systems, machine learning systems, and artificial neural networks. More particularly, the technology relates to application security management, and specifically to automated systems and methods for detecting and remediating security configuration drifts across enterprise web applications using AI agents configured to read and interact with graphical user interfaces (GUIs) of those applications.

### BACKGROUND OF THE INVENTION

Modern enterprises rely on a heterogeneous estate of web applications, including cloud productivity suites, customer relationship management platforms, video conferencing applications, collaboration platforms, human capital management platforms, and identity and access management portals. Each web application exposes its own administrative graphical user interface for configuring security settings, including authentication policies, data sharing permissions, third-party integration controls, notification and logging settings, and user role and privilege configurations. A material subset of these web applications exposes security configuration settings through rendered administrative graphical user interfaces without providing corresponding structured application programming interfaces or configuration data exports for those settings. Security administrators are therefore required to navigate each administrative graphical user interface and inspect each setting individually. The manual workflow does not scale across an enterprise estate of tens or hundreds of monitored applications and is difficult to reconcile with regulatory and contractual frameworks that require ongoing evidence of security configuration compliance.

Existing automated approaches do not adequately address this problem. Application-programming-interface-based compliance scanners query each web application's backend through structured interfaces and accordingly have limited reach over security configuration settings that are accessible through the rendered graphical user interface of the respective web application. Robotic process automation tools and productivity overlays navigate rendered interfaces, but they are designed for general task automation and do not address the specific requirements of security configuration management across an enterprise web application estate. As a result, an unaddressed gap exists between application-programming-interface-based compliance tools and general-purpose interface automation tools, and a need remains for an improved technique for managing security configuration of web applications at scale

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary system architecture of an application management platform for deploying one or more artificial intelligence (AI) agent systems for enterprise application management, according to certain embodiments.

FIG. 1B illustrates an exemplary system architecture of a single AI agent system deployed within a network environment including a plurality of enterprise users, a plurality of agent command systems, and a set of enterprise applications, according to certain embodiments.

FIG. 1C illustrates an alternative system architecture of the application management platform in which the AI agent system is communicatively coupled to agent command systems and a set of enterprise applications through a plurality of networks, according to certain embodiments.

FIG. 2A illustrates an architectural diagram depicting an evolution of enterprise infrastructure models from network centric paradigms to application and data centric paradigms, according to certain embodiments.

FIG. 2B is a block diagram of an AI agent based enterprise identity orchestration and credential automation platform, according to certain embodiments.

FIG. 2C is an architectural diagram illustrating integration of AI agent based identity governance across connected applications and disconnected applications within a hybrid enterprise infrastructure, according to certain embodiments.

FIG. 2D is a connectivity framework diagram between enterprise users, an identity control system, and a plurality of applications integrated with an AI agent system, according to certain embodiments.

FIG. 2E is a system workflow diagram showing an AI agent driven remediation process initiated by contextual security signals and executed across enterprise applications, according to certain embodiments.

FIG. 2F illustrates a conceptual diagram depicting AI agent behavioral learning for autonomous execution of identity lifecycle tasks across a large set of business applications, according to certain embodiments.

FIG. 3A illustrates an exemplary internal architecture of an agentic AI platform including a perception module, a planning module, an execution module, and supporting identity governance modules deployed within an enterprise network infrastructure, according to certain embodiments.

FIG. 3B illustrates a system architecture of a graphical user interface (GUI)-based agentic AI credential automation system configured to interface with producer applications, consumer applications, and a credential vault via GUI-based interactions, according to certain embodiments.

FIG. 4 illustrates a system for detecting and remediating security configuration drifts in enterprise web applications using interface-centric artificial intelligence agents, according to certain embodiments.

FIG. 5 illustrates a method for detecting and remediating security configuration drifts in enterprise web applications using interface-centric artificial intelligence agents, according to certain embodiments.

FIG. 6 illustrates an internal architecture of an AI agent of the system of FIG. 4 including a perception module, a semantic interpretation module, and an execution module, according to certain embodiments.

FIG. 7 illustrates a semantic interpretation process performed by the semantic interpretation module of the AI agent for producing a per-element structured output comprising a security policy classification and a compliance state, according to certain embodiments.

FIG. 8 illustrates a multi-source textual context process by which a language model of the semantic interpretation module determines a compliance state and a security policy classification of a security-relevant interface element from on-screen textual content drawn from multiple sources, according to certain embodiments.

FIG. 9 illustrates a dual-path execution process by which a remediation engine selects between a programmatic interface path and a graphical user interface path for executing a corrective modification on a non-compliant interface element, according to certain embodiments.

FIG. 10 illustrates a three-step remediation process by which a non-compliant interface element is altered through a rendered graphical user interface of a web application using a simulated user interaction, according to certain embodiments.

FIG. 11 illustrates a post-correction verification process by which the AI agent re-detects an altered non-compliant interface element and confirms whether the altered non-compliant interface element matches an expected compliant configuration, according to certain embodiments.

FIG. 12 illustrates a multi-application coordinated pipeline by which the system of FIG. 4 sequentially monitors and remediates a plurality of web applications within a continuous monitoring loop, according to certain embodiments.

FIG. 13 illustrates a tamper-evident audit record system by which a compliance logging module generates and transmits a tamper-evident audit record to one or more external security information and event management (SIEM) and security orchestration, automation, and response (SOAR) systems, according to certain embodiments.

FIG. 14 illustrates a dynamic interface adaptation system by which the AI agent continues to detect and interpret a security-relevant interface element across successive version updates of a web application without reconfiguration, according to certain embodiments.

FIG. 15 illustrates a drift alert generation and severity classification system by which a configuration deviation is classified by severity and routed for auto-remediation or administrator approval, according to certain embodiments.

FIG. 16 is a schematic representation of an encoder-decoder architecture.

FIG. 17 shows an overview of an attention mechanism added onto an RNN encoder-decoder architecture.

FIG. 18 is a schematic representation of the calculation of self-attention showing one attention head.

FIG. 19 is a depiction of several attention heads in a Transformer block.

FIG. 20 is an illustration that shows how one can use multiple workers to compute the multi-head attention in parallel, as the respective heads compute their outputs independently of one another.

FIG. 21 is a portrayal of one encoder layer of a Transformer network.

FIG. 22 shows a schematic overview of a Transformer model.

FIG. 23 is a depiction of a Vision Transformer (ViT).

FIG. 24 illustrates a processing flow of the Vision Transformer (ViT).

FIG. 25 shows example software code that implements a Transformer block.

FIG. 26 illustrates an example configuration of a computing device that can be used to implement the systems and techniques described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Overview

The implementations described herein introduce systems and methods for detecting and remediating security configuration drifts in web applications using interface-centric artificial intelligence agents. In some implementations, an artificial intelligence agent visually reads a rendered graphical user interface (GUI) of a web application, applies a language model to on-screen textual content associated with each of a plurality of interface elements rendered on the GUI, and produces, for each interface element, a first compliance state indicating whether the interface element is compliant or non-compliant with a predefined security baseline. The artificial intelligence agent then alters a non-compliant interface element by generating a simulated user interaction with the interface element through the same rendered GUI and re-applies the language model to on-screen textual content associated with the altered interface element as rendered after the altering. The on-screen textual content associated with the altered interface element as rendered after the altering is produced by the web application in response to the simulated user interaction. A second compliance state of the altered interface element is produced from the re-application, and the altered interface element is confirmed to match an expected compliant configuration defined by the predefined security baseline based on the second compliance state.

The disclosed approach treats visually rendered interface state as the primary technical surface for security configuration management. The approach enables compliance management of web applications whose security configuration settings are accessible through administrative graphical user interfaces and are not exposed through application programming interfaces (APIs) or structured configuration data exports. The approach closes a verification loop on every corrective modification by re-reading the same rendered GUI after the simulated user interaction to confirm that the altered interface element transitioned to a compliant state, and produces a tamper-evident audit record of each detected configuration deviation, each corrective modification, and each post-correction verification outcome.

### Indicia of Novelty, Inventiveness, Non-Obviousness, and Subject-Matter Eligibility

The system is directed to a concrete technological process executed by an artificial intelligence agent operating on a computing device communicatively coupled to a plurality of web applications through a network. The graphical user interface agent of the artificial intelligence agent accesses a security configuration interface of each web application by authenticating to the web application using an administrator credential, navigating to an administrative section of the web application, and causing the web application to render the security configuration interface within a rendered graphical user interface. The computer vision module of the artificial intelligence agent applies a computer vision model to a rendered display produced by a rendering pipeline of the web application to detect interface elements rendered on the security configuration interface and to determine a current visual state of each detected interface element. The semantic interpretation module of the artificial intelligence agent applies a language model to on-screen textual content visible on the rendered graphical user interface for each detected interface element to determine, for the detected interface element, a current compliance state indicating whether the detected interface element is compliant or non-compliant with a predefined security baseline. The policy evaluation engine evaluates the current compliance state determined for each detected interface element against the predefined security baseline to identify a non-compliant interface element. The remediation engine generates a simulated user-facing input event with the non-compliant interface element through the rendered graphical user interface, the simulated user-facing input event being dispatched to the rendering pipeline of the web application, the rendering pipeline of the web application updating an internal configuration store of the web application and re-rendering the non-compliant interface element in an altered displayed state in response to the simulated user-facing input event. The compliance logging module generates a tamper-evident audit record for the non-compliant interface element and the corresponding corrective modification, the tamper-evident audit record being preserved in a tamper-resistant data store. The technology disclosed thereby improves a concrete technological process by integrating rendered graphical user interface based detection, language model based per-element compliance determination, simulated user-facing input event based remediation, and tamper-evident audit record generation into a coordinated system that performs specific computational operations on defined data structures through specific hardware components of the computing device.

### Rendered Graphical User Interface as the Operative Technical Surface

In certain implementations, the closed-loop visual compliance pipeline treats a rendered graphical user interface generated by a rendering pipeline of a web application as a technical input and output surface for security configuration management. The graphical user interface agent causes the web application to render the security configuration interface within the rendered graphical user interface and reads the rendered display through the computer vision module of the artificial intelligence agent. The remediation engine dispatches the simulated user-facing input event to the rendering pipeline of the web application, the rendering pipeline of the web application receiving the simulated user-facing input event in the same manner as a keyboard or pointing device input event generated by an administrator. The technology disclosed thereby extends automated security configuration management coverage to web applications whose security configuration settings are accessible through the rendered graphical user interface, and produces a coverage extension that complements application programming interface based tools.

### Language Model Applied to On-Screen Textual Content of the Rendered Graphical User Interface

In certain implementations, the technology disclosed applies a language model to on-screen textual content visible on the rendered graphical user interface for each detected interface element to determine the current compliance state of the detected interface element. The on-screen textual content comprises a label of the detected interface element, descriptive text rendered in proximity to the detected interface element, a tooltip rendered on hover or focus of the detected interface element, and a section heading under which the detected interface element is rendered, each being textual content produced by the rendering pipeline of the web application and visible on the rendered graphical user interface at a time of the determining. The language model produces, for each detected interface element, a structured representation comprising a security policy classification identifying a security control category governed by the detected interface element and a binary indicator of compliance or non-compliance of the detected interface element with the predefined security baseline. The structured representation is produced from the rendered textual content, supporting per-element compliance determination across heterogeneous web applications and across successive version updates of each web application without reconfiguration of the system for each version update.

### Simulated User-Facing Input Event Dispatched to the Rendering Pipeline

In certain implementations, the technology disclosed dispatches a simulated user-facing input event with the non-compliant interface element through the rendered graphical user interface of the web application, the simulated user-facing input event comprising at least one of a simulated mouse click, a simulated keyboard input, or a simulated control selection on the non-compliant interface element. The simulated user-facing input event is dispatched by the remediation engine to the rendering pipeline of the web application, the rendering pipeline receiving the simulated user-facing input event in the same manner as an input event generated by a pointing device or keyboard operated by an administrator. The web application updates the internal configuration store of the web application and re-renders the non-compliant interface element in an altered displayed state in response to the simulated user-facing input event. The technology disclosed thereby alters the security configuration setting of the web application through the rendered graphical user interface as the modification surface, producing an altered security configuration setting persisted in the internal configuration store of the web application.

### Closed-Loop Verification of the Altered Security Configuration

In certain implementations, the technology disclosed re-invokes the computer vision module and the semantic interpretation module on the rendered graphical user interface of the web application as rendered after the simulated user-facing input event. The computer vision module re-detects the altered interface element from a rendered display produced by the rendering pipeline of the web application in response to the simulated user-facing input event. The semantic interpretation module re-applies the language model to on-screen textual content associated with the altered interface element as rendered after the simulated user-facing input event, the on-screen textual content as rendered after the simulated user-facing input event being produced by the rendering pipeline of the web application in response to the simulated user-facing input event. The re-application of the language model yields a second compliance state of the altered interface element. The policy evaluation engine compares the second compliance state against an expected compliant configuration defined by the predefined security baseline and produces a verification output indicating whether the altered interface element matches the expected compliant configuration. The technology disclosed thereby produces a closed-loop verification of each corrective modification through observation of the rendered graphical user interface after the simulated user-facing input event, grounding the compliance determination in the actual altered state rendered by the web application.

### Tamper-Evident Audit Record Preserved in a Tamper-Resistant Data Store

In certain implementations, the technology disclosed generates a tamper-evident audit record for each configuration deviation and each corresponding corrective modification, the tamper-evident audit record comprising an application identifier of the web application, an interface element identifier of the non-compliant interface element, the current compliance state of the non-compliant interface element prior to the corrective modification, a description of the corrective modification, a timestamp of the corrective modification, and the second compliance state produced after the re-invocation of the computer vision module and the semantic interpretation module. The tamper-evident audit record is preserved in a tamper-resistant data store implemented as an append-only data store, a cryptographically chained data store, a write-once read-many storage medium, or a distributed ledger. The compliance logging module further transmits the tamper-evident audit record in real time to an external compliance infrastructure system through a transmission pipeline implemented over a network using at least one of Syslog, a hypertext transfer protocol webhook, or a message queuing protocol. The technology disclosed thereby produces a structured evidentiary record of each compliance determination, each corrective modification, and each post-modification verification outcome, preserved in a tamper-resistant manner and made available in real time to external compliance infrastructure systems for downstream automated workflows, in support of regulatory and contractual frameworks for verifiable security configuration compliance.

### Subject-Matter Eligibility

The technology disclosed is directed to a particular technical solution to a particular technical problem and is rooted in specific technical mechanisms, hardware components, and data structures.

The technology disclosed is rooted in specific technical mechanisms that operate through programmatic interaction with the rendering pipeline of the web application. The operative steps of the technology disclosed are executed through processor instructions of a computing device interacting with the rendering pipeline of the web application through computer vision processing of the rendered display, language model processing of the rendered textual content, and programmatic dispatch of the simulated user-facing input event to the rendering pipeline of the web application. A human administrator does not apply a language model to rendered pixel content of a graphical user interface produced by a rendering pipeline of a web application, does not dispatch a simulated user-facing input event programmatically to the rendering pipeline of a web application, and does not perform a closed-loop verification cycle in which on-screen textual content produced by the web application in response to a programmatically dispatched simulated user-facing input event is re-read by a language model.

The technology disclosed addresses a specific technical problem rooted in computer technology. The specific technical problem is the management of security configuration settings of web applications whose security configuration settings are accessible through rendered administrative graphical user interfaces without corresponding structured application programming interfaces or configuration data exports. The specific technical solution is the closed-loop visual compliance pipeline that operates on the rendered graphical user interface as the operative technical surface for detection, evaluation, and remediation, and that verifies each remediation action through observation of the rendered graphical user interface after the simulated user-facing input event. The specific technical solution is implemented through hardware components of the computing device, including at least one processor, at least one storage device, at least one network interface communicatively coupling the computing device to the web application, and at least one display rendering surface receiving the rendered display produced by the rendering pipeline of the web application. The specific technical solution requires the artificial intelligence agent operating on the computing device, the computer vision module applying the computer vision model, the semantic interpretation module applying the language model, the policy evaluation engine evaluating the structured representation produced by the language model, the remediation engine dispatching the simulated user-facing input event, the rendering pipeline of the web application receiving the simulated user-facing input event, and the compliance logging module preserving the tamper-evident audit record in the tamper-resistant data store.

The technology disclosed produces a tangible alteration of the internal configuration store of the web application, persisted through the rendering pipeline of the web application, and produces a tamper-evident audit record preserved in a tamper-resistant data store. The technology disclosed presents a particular technical solution to a particular technical problem, requires the operation of hardware components and the rendering pipeline of the web application, and operates through programmatic interaction with the rendering pipeline of the web application as a technical input and output surface.

### System Architecture

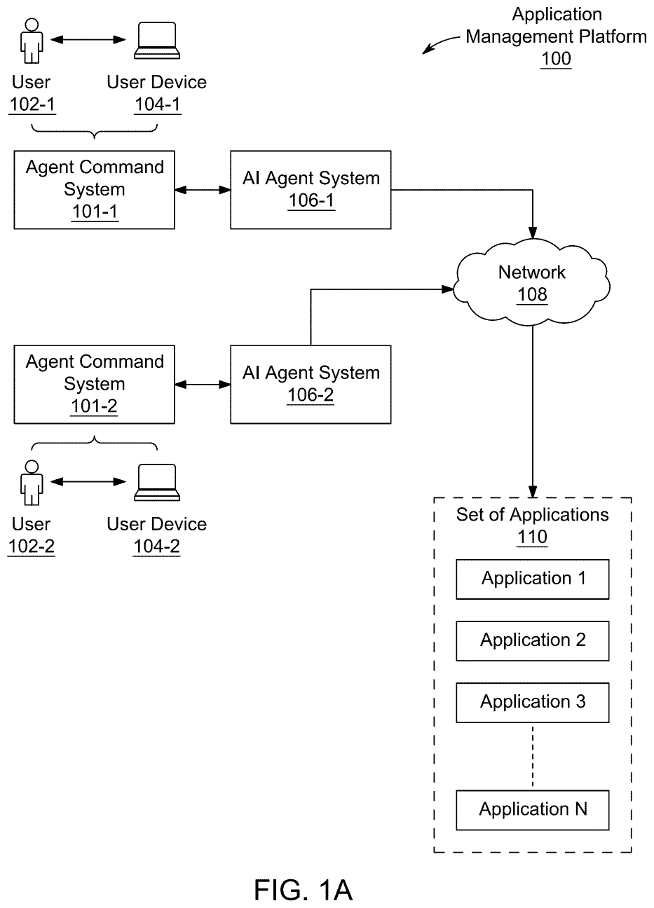

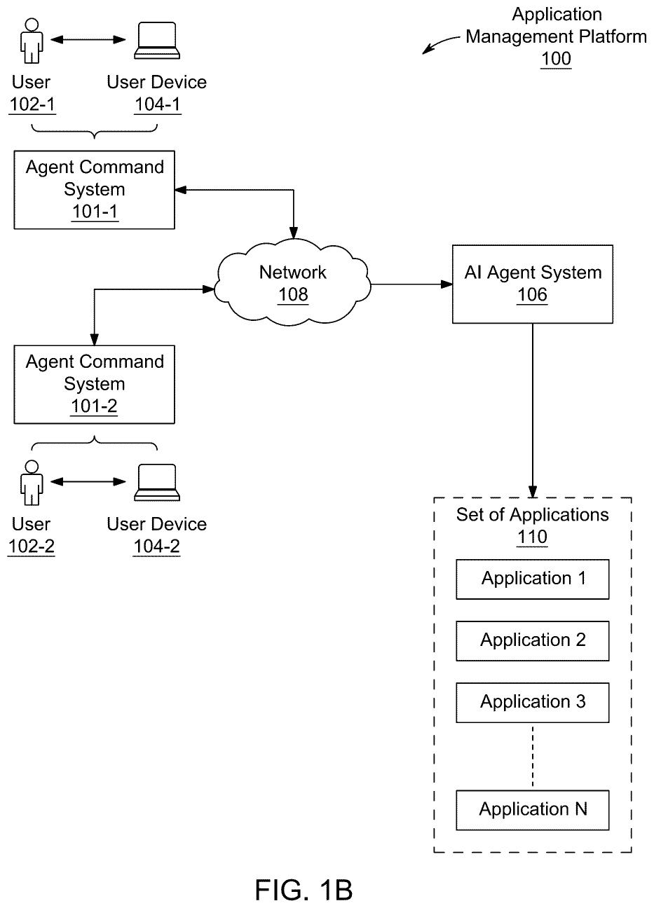

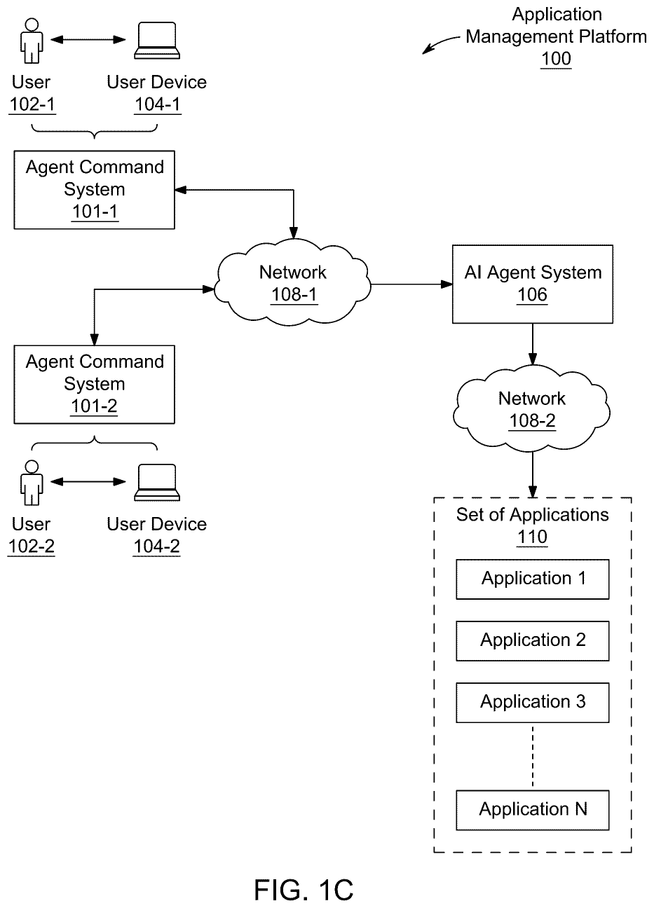

FIG. 1A illustrates an exemplary network diagram depicting an overall system architecture for deploying the application management platform 100, according to various embodiments. FIG. 1A depicts interaction among a plurality of enterprise users, a plurality of user devices, a plurality of agent command systems, a plurality of AI agent systems, and a set of applications over a communication network.

The application management platform 100 includes a plurality of users 102-1 and 102-2, each operating a respective user device 104-1 and 104-2. The user devices 104-1 and 104-2, collectively referred to as user devices 104, may be any computing devices capable of initiating or supporting interaction with components of the application management platform 100. The user devices 104 may include desktop computers, laptops, tablets, smartphones, or other network-enabled terminals. The user devices 104-1 and 104-2 are communicatively linked to other components of the application management platform 100 via a network 108. The network 108 may include any combination of communication technologies, including wired connections, wireless protocols, cellular networks, local area networks (LANs), wide area networks (WANs), metropolitan area networks (MANs), the Internet, or any suitable data transmission medium.

The agent command systems 101-1 and 101-2, collectively referred to as agent command systems 101 and as illustrated in FIG. 1A, refer to command-initiating modules that trigger task execution requests within the AI agent systems 106. The agent command systems 101 operate as entry points into an AI agent execution layer and may originate from a variety of operational contexts within the enterprise environment. Functionally, each agent command system 101 is configured to broker identity and access management instructions, including credential creation, access revocation, entitlement modification, or credential verification, by transmitting structured or unstructured commands to a corresponding AI agent system 106.

In one exemplary embodiment, an agent command system 101 may be realized as an enterprise human resources platform, such as Workday or SuccessFactors, which automatically triggers a new-user provisioning task upon successful onboarding of an employee. Alternatively, an agent command system 101 may be a cloud identity orchestration platform or identity governance solution, such as Okta Workflows or SailPoint, which detects a status change and delegates an appropriate downstream action to an agentic automation layer.

In another scenario, an agent command system 101 may comprise an enterprise-grade ticketing or service desk tool, such as ServiceNow or Jira, where an administrator raises a request for access removal or a credential reset. Once the ticket receives approval, the agent command system 101 generates a task trigger, which an AI agent system 106 receives for execution across relevant applications.

Additionally, an agent command system 101 may be embodied as a Python script or a lightweight command-line utility maintained by enterprise information technology teams. The agent command system 101 may invoke credential management tasks based on custom logic, policy thresholds, or compliance audit findings. For example, a script may be scheduled to review stale accounts, or trigger revocation flows for temporary users whose access is due to expire.

The scope of the agent command systems 101 also extends to externally hosted platforms. For example, a partner organization operating an integration gateway may initiate access modification workflows through representational state transfer (RESTful) callbacks or secure webhooks when a role matrix of a joint project is updated. Similarly, identity-centric middleware, such as Active Directory Federation Services (AD FS) or Azure Conditional Access policies, may initiate dynamic policy enforcement actions through integration with the application management platform 100.

Furthermore, websites that serve as operational hubs for user provisioning, including custom-built contractor registration portals or partner self-service applications, may function as instances of the agent command systems 101. These web portals collect user metadata, roles, and authorization preferences and transmit the metadata, the roles, and the authorization preferences as task directives to the agentic execution layer for automated credential provisioning.

The AI agent systems 106-1 and 106-2, collectively referred to as AI agent systems 106, serve as intermediary execution and orchestration layers between the agent command systems 101 and the set of applications 110. In the embodiment of FIG. 1A, the plurality of AI agent systems 106 may be deployed to manage tasks across various application domains, organizational units, or enterprise environments. Each AI agent system 106 receives task instructions or event triggers from a corresponding agent command system 101 and performs operations with respect to one or more applications in the set of applications 110.

A set of applications 110 is denoted as application 1, application 2, application 3, and continuing through application N. The applications within the set of applications 110 represent tools, platforms, and services utilized by enterprises in operational workflows. Illustrative examples include customer relationship management platforms such as Salesforce, regulatory filing portals such as Securities and Exchange Commission (SEC) submission websites, internal field service management systems, and partner-managed applications hosted on third-party infrastructure. Within the set of applications 110, some applications may be sanctioned enterprise applications that have been vetted and formally approved for use within the enterprise environment. However, not all sanctioned applications are programmatically integrated with enterprise identity systems. For example, Salesforce may be both sanctioned and programmatically connected through secure application programming interfaces (APIs), whereas other sanctioned tools, including a field service application hosted in a partner cloud, may lack programmatic integrations entirely and may be accessible through graphical user interfaces.

In cases of applications lacking programmatic integration, an AI agent system 106 is positioned to bridge the integration gap by executing graphical user interface (GUI)-based workflows. The AI agent system 106 functions across both API-enabled and GUI-only applications without requiring custom connectors for every application, thereby supporting a wide spectrum of use cases. The applications denoted by reference numeral 110, including application 1 through application N, represent the diversity in application connectivity and accessibility.

The application management platform 100 provides an operational control plane for deployment, configuration, and update management of the AI agent systems 106 across the enterprise environment. The application management platform 100 may further serve as an interface through which deployment packages, including deployment application template (DAT) files containing task templates and user interface locators, are delivered and version controlled. Version-controlled deployment ensures that application-specific logic can be updated without requiring modification to enterprise systems or target applications.

Operationally, when a task is initiated, including onboarding a new employee or revoking access for a departing contractor, the AI agent system 106 identifies relevant applications, determines whether the relevant applications are sanctioned or unsanctioned, and further determines whether programmatic access is available. Where APIs exist, the AI agent system 106 may utilize the APIs. Where no APIs are exposed, the AI agent system 106 performs interface-based automation by identifying credential fields, invoking generation elements, interacting with application controls, and confirming task completion through visual confirmation or response logging.

FIG. 1B illustrates an exemplary architecture of the AI agent system 106 deployed in a network environment. As depicted in FIG. 1B, a plurality of users 102-1 through 102-N operate respective user devices 104-1 through 104-N, the user devices being communicatively connected to the AI agent system 106 via the network 108. In the embodiment of FIG. 1B, a single AI agent system 106 serves the plurality of users 102-1 through 102-N and coordinates task execution across the set of applications 110.

The users 102 represent individuals or entities that require interaction with the AI agent system 106 for accessing enterprise functionalities or initiating enterprise workflows. The users 102 may include enterprise employees, external customers, partners, vendors, and contractors. Within an enterprise, the users 102 may take the form of managers, analysts, administrative staff, or compliance officers. For example, a marketing manager may request insights into sales performance metrics, while a data analyst may query historical usage patterns to train predictive models. Each interaction is facilitated through the user devices 104, which may include desktop computers, laptops, mobile phones, or tablets configured to transmit queries or task instructions to the AI agent system 106.

The AI agent system 106 functions as an intelligent middleware layer, interfacing with user instructions or task directives and performing corresponding task executions within the enterprise infrastructure. Upon receiving requests from the user devices 104-1 through 104-N or task directives from the agent command systems 101, the AI agent system 106 interprets an objective of the request or directive, references one or more semantic models, and orchestrates an execution strategy. The execution may involve data extraction from enterprise databases, task automation across enterprise applications, generation of alerts and recommendations, or credential and entitlement management operations.

An underlying semantic model employed by the AI agent system 106 maps concepts, relationships, and terminologies specific to the enterprise and an operational domain of the enterprise. The semantic model may incorporate language-specific and language-independent elements and may maintain a knowledge graph that encapsulates industry-specific vocabularies, inter-entity relationships, and organizational hierarchies. The semantic model allows the AI agent system 106 to provide meaningful and contextually accurate responses, even when user inputs are ambiguous, multilingual, or incomplete. For example, the AI agent system 106 may infer that a query about “partner logins” likely pertains to privileged account access in partner-facing systems and may respond accordingly.

The AI agent system 106 is capable of initiating omni-channel communication, providing task updates, delivering alerts, recommending actions, and handling real-time queries via chat, voice, or system notification interfaces. The AI agent system 106 may also proactively interact with the users 102 to suggest workflow improvements or to flag policy violations. For example, if a departing employee retains access to sensitive systems, the AI agent system 106 may initiate a revocation task and notify a security team.

The architecture is adaptable to various industry verticals including manufacturing, financial services, healthcare, oil and gas, and telecommunications. The AI agent system 106 is designed to accommodate industry-specific models, allowing the AI agent system 106 to process domain-relevant queries and execute tasks with high specificity and compliance.

The network 108 facilitates data transfer between the user devices 104-1 through 104-N and the AI agent system 106. In some embodiments, multiple interconnected networks 108 may be present between the user devices 104-1 through 104-N and the AI agent system 106. The network 108 may be a private network, a public network, or a hybrid network. The network 108 may be a local area network (LAN) or a wide area network (WAN).

The network 108 may be connected via wired or wireless links. Wired links may include digital subscriber line (DSL), coaxial cable lines, Ethernet, fiber optic links, or other links used for network infrastructure. Wireless links may include cellular, BLUETOOTH, Wi-Fi, Worldwide Interoperability for Microwave Access (WiMAX), infrared channels, satellite bands, or other wireless networking technologies. Wireless links may also include any cellular network standards used to communicate among mobile devices, including standards that qualify as 1G, 2G, 3G, 4G, 5G, or Long Term Evolution (LTE). Network standards may qualify as one or more generations of mobile telecommunication standards by fulfilling a specification or standards including specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), High Speed Packet Access (HSPA), LTE, LTE Advanced, Mobile WiMAX, and WiMAX Advanced. Cellular network standards may use various channel access methods, including frequency division multiple access (FDMA), time division multiple access (TDMA), code division multiple access (CDMA), or space division multiple access (SDMA). In some embodiments, different types of data may be transmitted via different links and standards. In other embodiments, the same types of data may be transmitted via different links and standards.

The network 108 may be any type and form of network. The geographical scope of the network 108 may vary widely. The network 108 can be a body area network (BAN), a personal area network (PAN), a LAN including an Intranet, a metropolitan area network (MAN), or a WAN including the Internet. The topology of the network 108 may be of any form and may include point-to-point, serial, bus, star, ring, mesh, or tree topologies. The network 108 may be an overlay network that is virtual and sits on top of one or more layers of other networks. The network 108 may be of any network topology capable of supporting the operations described herein. The network 108 may utilize different techniques and layers or stacks of protocols, including the Ethernet protocol, the Internet protocol suite including Transmission Control Protocol over Internet Protocol (TCP/IP) and User Datagram Protocol over Internet Protocol (UDP/IP), the Asynchronous Transfer Mode (ATM) technique, the Synchronous Optical Networking (SONET) protocol, or the Synchronous Digital Hierarchy (SDH) protocol. The TCP/IP Internet protocol suite may include an application layer, a transport layer, an Internet layer including IPV6, or a link layer. The network 108 may be a type of broadcast network, telecommunications network, data communication network, or computer network.

In some implementations, one or more of the users 102-1 through 102-N may access the AI agent system 106 using one or more of the user devices 104-1 through 104-N. The AI agent system 106 may include one or more user interfaces, including browsers and textual or graphical user interfaces, through which the users 102-1 through 102-N may access the AI agent system 106.

The user devices 104-1 through 104-N and the AI agent system 106 may exist on a shared or segmented network. In some embodiments, the users 102 may access the AI agent system 106 remotely via virtual private networks (VPNs) or federated identity mechanisms, while in other embodiments, the users 102 may be co-located within an enterprise premise. The AI agent system 106 may access one or more databases communicatively coupled to the user devices 104-1 through 104-N through the network 108.

The database may be persistent storage that is capable of storing data. The persistent storage may be a local storage unit or a remote storage unit. The persistent storage may be a magnetic storage unit, an optical storage unit, a solid-state storage unit, an electronic storage unit including main memory, or a similar storage unit. The persistent storage may also be a monolithic single device or a distributed set of devices. Each component may include hardware including processing devices, including processors, central processing units (CPUs), and graphics processing units (GPUs), memory including random access memory (RAM), storage devices including a hard disk drive (HDD) and a solid-state drive (SSD), and other hardware devices including a sound card and a video card. The computing system may comprise any suitable type of computing device or machine that has a programmable processor including server computers, desktop computers, laptop computers, tablet computers, smartphones, and set-top boxes. In some examples, the computing system may comprise a single machine or may include multiple interconnected machines including multiple servers configured in a cluster. The computing system may be implemented by a common entity or organization or may be implemented by different entities or organizations.

FIG. 1C illustrates an alternative embodiment of the application management platform 100 depicting a distributed deployment environment of the AI agent system 106 in connection with an enterprise infrastructure. The architecture reflects system elements distributed across a plurality of communication networks 108-1 and 108-2 and demonstrates interactions between enterprise users, agent command systems, and applications.

As depicted in FIG. 1C, the enterprise users 102-1 and 102-2 operate corresponding user devices 104-1 and 104-2, respectively. The user devices 104-1 and 104-2 may include any computing device capable of establishing a network connection and interfacing with enterprise systems, including desktop computers, laptops, mobile phones, or tablet devices. Each user device may interact with a corresponding agent command system 101-1 or 101-2. The agent command systems 101-1 and 101-2 may be communicatively coupled to the AI agent system 106 through a first network 108-1, and the AI agent system 106 may be communicatively coupled to the set of applications 110 through a second network 108-2.

The AI agent system 106 interfaces with the agent command systems 101 and the set of applications 110 across the plurality of networks 108-1 and 108-2 and acts as an intermediary that facilitates intelligent, automated task execution based on enterprise identity controls. The AI agent system 106 may be communicatively coupled with the application management platform 100 that oversees and orchestrates deployment, access provisioning, and lifecycle management of AI-agent-based automation. The applications form a collective set of applications 110 of enterprise-deployed software systems, comprising commonly used platforms including Salesforce, customer relationship management systems, regulatory filing portals, or internally hosted operational tools. The set of applications 110 varies in accordance with each enterprise. The set of applications 110 is a customized set tailored to address the specific requirements of each enterprise.

The architecture of FIG. 1C emphasizes the role of distributed user interactions wherein different users, command-originating systems, and applications may be connected over different network interfaces. Unlike monolithic enterprise systems, the arrangement of FIG. 1C represents the practical reality of hybrid information technology environments where not all applications are uniformly connected or orchestrated under a single identity governance mechanism.

The AI agent system 106 mediates communication and operational requests between command-originating enterprise systems and the managed application ecosystem. The AI agent system 106 may incorporate logic for parsing user instructions or task directives, orchestrating task flows, validating access policies, updating credential states, and sending execution notifications. The AI agent system 106 enables agentic automation even in cases where application integration is incomplete or where manual processes are still used, by employing techniques including interface automation, synthetic API generation, or remote workflow triggers.

By situating the AI agent system 106 between disparate agent command systems and applications, the architecture shown in FIG. 1C supports a flexible, secure, and intelligent mechanism for managing complex enterprise workflows while maintaining identity and access policies enforced across multiple application types and endpoints.

### Exemplary System Architecture

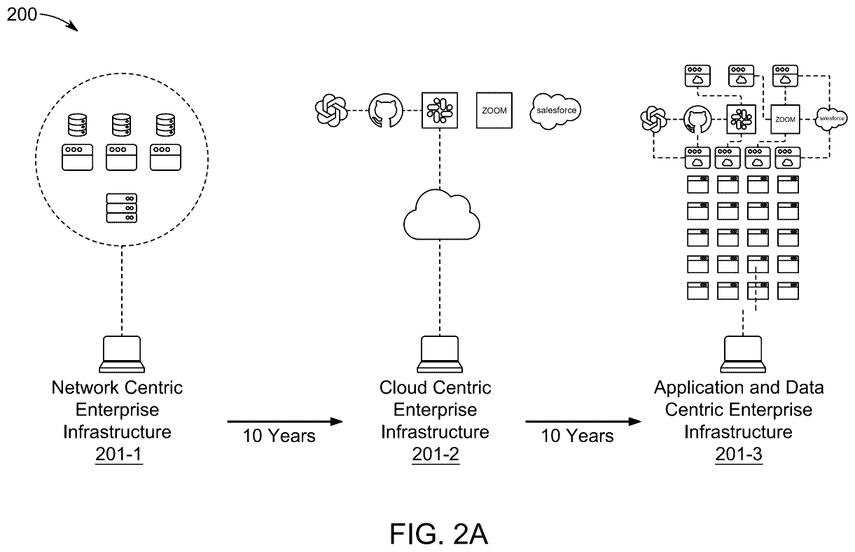

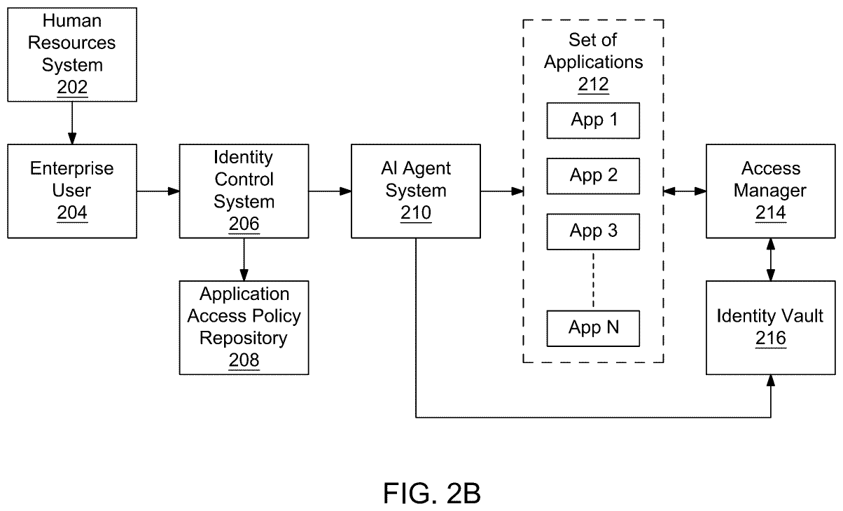

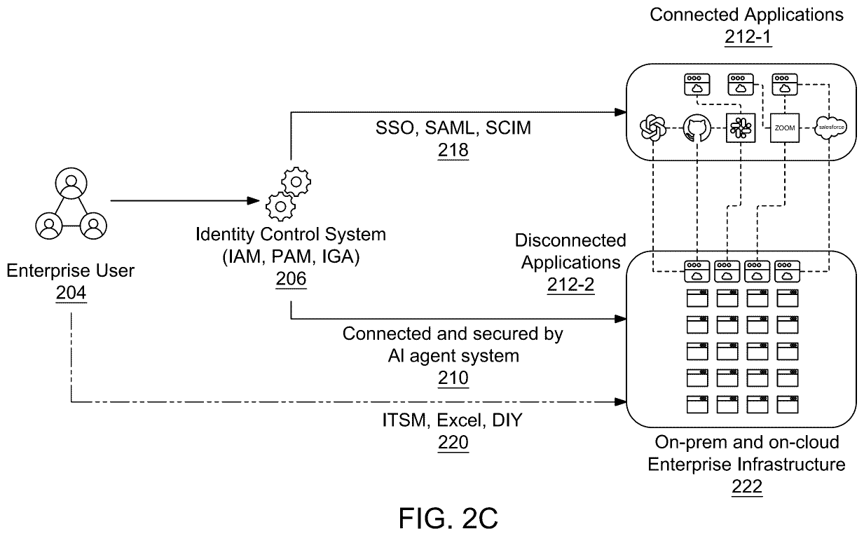

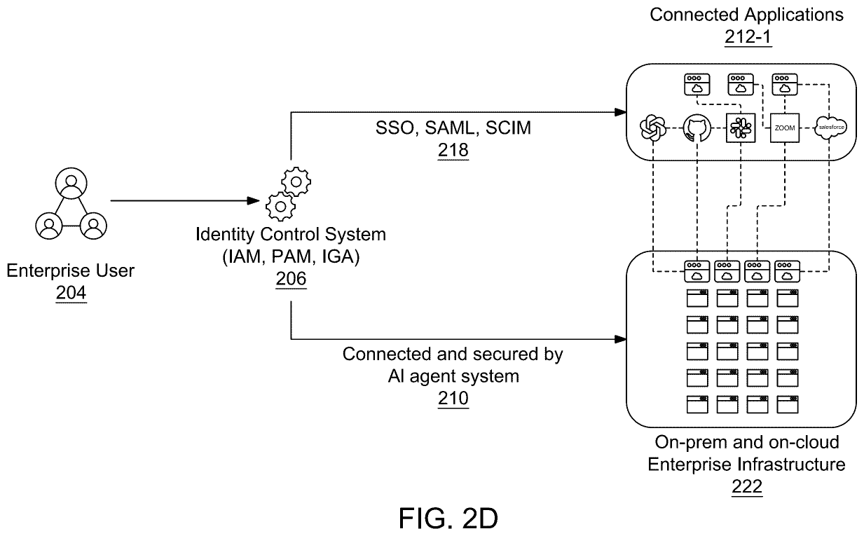

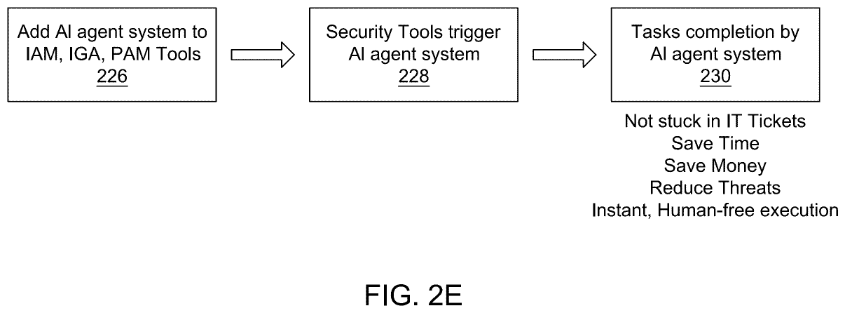

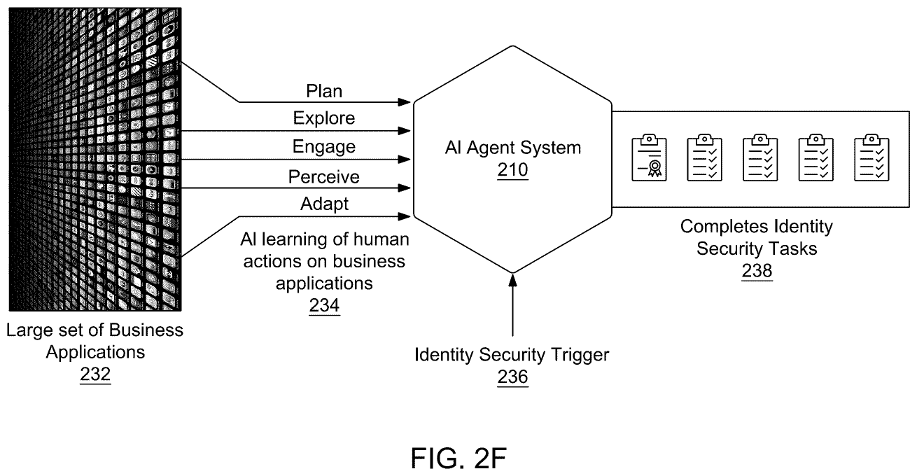

FIG. 2A illustrates an architectural diagram of an exemplary system 200 depicting the evolution of enterprise infrastructure models from network-centric paradigms to application—and data-centric paradigms, in accordance with certain embodiments of the present disclosure. The architectural diagram depicts three successive stages of enterprise infrastructure evolution spanning approximately two decades. A first stage depicts a network-centric enterprise infrastructure 201-1, in which enterprise applications and services are organized around physical network boundaries, on-premises data centers, and perimeter-based security models. A second stage depicts a cloud-centric enterprise infrastructure 201-2, in which enterprise applications and services migrate to cloud-hosted environments, introducing distributed access patterns and multi-tenant service delivery. A third stage depicts an application- and data-centric enterprise infrastructure 201-3, in which the enterprise security and identity perimeter shifts from a network layer to application and data layers, and individual applications and data stores become primary units of access control, policy enforcement, and identity governance. Each transition between successive stages spans approximately ten years. The evolution from the network-centric enterprise infrastructure 201-1 to the application- and data-centric enterprise infrastructure 201-3 creates a heterogeneous application landscape in which enterprise organizations simultaneously operate legacy on-premises applications, cloud-native services, and third-party platforms with varying degrees of integration, connectivity, and programmatic accessibility. The heterogeneity of the application- and data-centric enterprise infrastructure 201-3 forms the operational context in which the AI agent system described herein operates.

FIG. 2B illustrates an exemplary system 200 of an AI agent-based enterprise identity orchestration and credential automation platform, in accordance with certain embodiments of the present disclosure. The system 200 is implemented within a secure enterprise network environment and comprises a plurality of functional modules and system components, including a human resources system 202, an enterprise user 204, an identity control system 206, an application access policy depository 208, an AI agent system 210, a set of applications 212 comprising application 1 through application N, an access manager 214, and an identity vault 216.

The human resources system 202 is a centralized enterprise repository that maintains user-specific attributes and employment metadata, including designation, department, employment status, access eligibility criteria, and historical access records. For example, upon onboarding a new employee into a marketing department, the human resources system 202 stores the relevant role, project assignment, and department-specific flags that inform downstream access decisions. When an employee transitions from one department to another or exits the organization, the human resources system 202 updates the employment status accordingly.

The enterprise user 204 may be an internal administrative system, service entity, or administrative user operating within the enterprise infrastructure that fetches the employee details from the human resources system 202. The employee details include identity attributes, department-based entitlements, project-specific roles, and policy flags that define a scope of application access for the employee. For example, the enterprise user 204 may detect that an employee assigned to a financial audit project is eligible for limited access to an enterprise financial ledger application while being denied access to engineering development platforms.

The identity control system 206 serves as a decision engine that interprets enterprise-defined access control policies and determines an eligible set of applications each employee is permitted to access. The identity control system 206 may utilize static policy rules, dynamic access condition evaluation, or role-based access control logic to determine entitlements. For example, a data analyst joining a compliance team may be granted view-only access to compliance dashboards, whereas a senior compliance officer may be granted editing and submission privileges. Based on the determined scope of access, the identity control system 206 triggers either a credential creation task upon employee onboarding or a revocation task upon employee exit or access expiration.

The application access policy repository 208 is a dedicated storage layer or configuration store that maintains policy documents, compliance checklists, access templates, and entitlement definitions. The application access policy depository 208 may include per-application authentication modes, credential types, and compliance requirements. For example, a customer relationship management system may require multi-factor authentication using time-based tokens, while a regulatory submission platform may require access through a secure virtual private network (VPN). The identity control system 206 consults the application access policy depository 208 when making determinations regarding access provisioning or deprovisioning.

The AI agent system 210 functions as an intelligent execution layer that translates an intent derived from the identity control system 206 into a series of task executions across multiple heterogeneous applications. The AI agent system 210 orchestrates a credential creation, modification, or removal process and communicates with both connected and disconnected applications. For example, a customer relationship management platform may be a sanctioned and programmatically accessible application supporting standard authentication protocols, while a third-party treasury interface hosted on a partner cloud infrastructure may require interface automation using robotic process automation (RPA) or semantic uniform resource locator (URL)-based mapping. The AI agent system 210 handles both categories with equal agility, providing consistent and audit-friendly execution.

The set of applications 212, comprising application 1 through application N, represents a portfolio of enterprise tools and applications that employees may need to access. The set of applications 212 includes customer relationship management platforms, regulatory submission platforms, internal operational tools hosted on private cloud, and third-party partner interfaces. Some applications within the set of applications 212 are classified as sanctioned and support direct programmatic access, while other applications may be unlisted, disconnected, or legacy systems that do not expose modern application programming interfaces. For example, a sanctioned system may allow secure identity federation, while an unsanctioned procurement portal may require screen-based automation or manual form parsing.

The access manager 214 supervises overall task execution and maintains auditability. The access manager 214 verifies that credential lifecycle management activities, including provisioning, updates, and revocations, are completed successfully, logged appropriately, and aligned with enterprise compliance expectations. For example, in scenarios where a deprovisioning task fails due to an unreachable application, the access manager 214 may escalate an issue to an administrator and trigger a retry loop. The access manager 214 may also enforce temporal access constraints, including expiring credentials issued for short-term contractors, and may maintain versioned audit logs to support forensic analysis and compliance reporting.

The identity vault 216 functions as a secure storage module for credentials issued to enterprise users. The identity vault 216 may store usernames, passwords, application programming interface tokens, multi-factor secrets, and biometric templates. For example, when an employee is granted access to a cloud database, generated credentials are securely stored in the identity vault 216 in compliance with encryption-at-rest policies, audit logging, access expiration, and role-based retrieval constraints. The identity vault 216 may support zero-trust integrations with endpoint agents to facilitate secure credential injection at runtime.

The components of the system 200 operate in coordination to provide seamless, policy-compliant, and secure identity orchestration within complex enterprise environments. The AI-driven architecture of the system 200 provisions user access in accordance with verified human resources data and policy data, and executes tasks including application programming interface key refresh and user deactivation proactively, even for applications not directly connected to enterprise identity systems.

FIG. 2C illustrates an architectural diagram depicting integration of AI agent-based identity governance across connected applications and disconnected applications within a hybrid enterprise infrastructure, in accordance with certain embodiments of the present disclosure. FIG. 2C depicts the enterprise user 204 coupled to the identity control system 206 implementing identity and access management (IAM), privileged access management (PAM), and identity governance and administration (IGA) functions. The identity control system 206 is communicatively coupled to the AI agent system 210, which is communicatively coupled to both a set of connected applications 212-1 and a set of disconnected applications 212-2 within an on-premises and on-cloud enterprise infrastructure 222. The connected applications 212-1 are integrated with the identity control system 206 via standardized protocols including single sign-on (SSO), security assertion markup language (SAML), and system for cross-domain identity management (SCIM) 218. The disconnected applications 212-2 are applications that lack native protocol integration and are managed using alternative methods, including information technology service management (ITSM) tickets, spreadsheet-based tracking, or custom-built tools 220. The AI agent system 210 bridges a gap between the connected applications 212-1 and the disconnected applications 212-2 by providing automated identity governance capabilities across both categories of applications irrespective of availability of a programmatic interface.

FIG. 2D illustrates an exemplary connectivity framework between enterprise users, the identity control system, and a plurality of applications integrated with the AI agent system, in accordance with certain embodiments of the present disclosure. FIG. 2D depicts the enterprise user 204 coupled to the identity control system 206 implementing IAM, PAM, and IGA functions. The identity control system 206 is communicatively coupled to the AI agent system 210, which is communicatively coupled to the connected applications 212-1 deployed on the on-premises and on-cloud enterprise infrastructure 222 via SSO, SAML, and SCIM 218. FIG. 2D illustrates an alternative embodiment in which an enterprise application landscape comprises primarily connected applications 212-1, and the AI agent system 210 operates alongside standardized identity federation and provisioning protocols.

FIG. 2E is a system workflow diagram showing an AI agent-driven remediation process initiated by contextual security signals and executed across enterprise applications, in accordance with certain embodiments of the present disclosure. FIG. 2E depicts three sequential stages. At a first stage 226, the AI agent system 210 is added to IAM, IGA, and PAM tools, integrating agentic automation capabilities into existing identity governance infrastructure. At a second stage 228, security tools trigger the AI agent system 210 in response to identity lifecycle events, policy violations, or security incidents. At a third stage 230, the AI agent system 210 completes identity security tasks across an enterprise application estate, achieving instant, human-free execution, time savings, cost reduction, and threat mitigation.

FIG. 2F is a conceptual diagram depicting AI agent behavioral learning for autonomous execution of identity lifecycle tasks in enterprise applications, in accordance with certain embodiments of the present disclosure. FIG. 2F depicts the AI agent system 210 that learns from human actions on business applications 234 within a large set of business applications 232. The AI agent system 210 acquires behavioral patterns through a sequence of learning stages comprising plan, explore, engage, perceive, and adapt. Upon receiving an identity security trigger 236, the AI agent system 210 completes identity security tasks 238 across the large set of business applications 232 by applying learned behavioral patterns to autonomously navigate, interpret, and interact with enterprise application interfaces.

### Internal Functional Modules

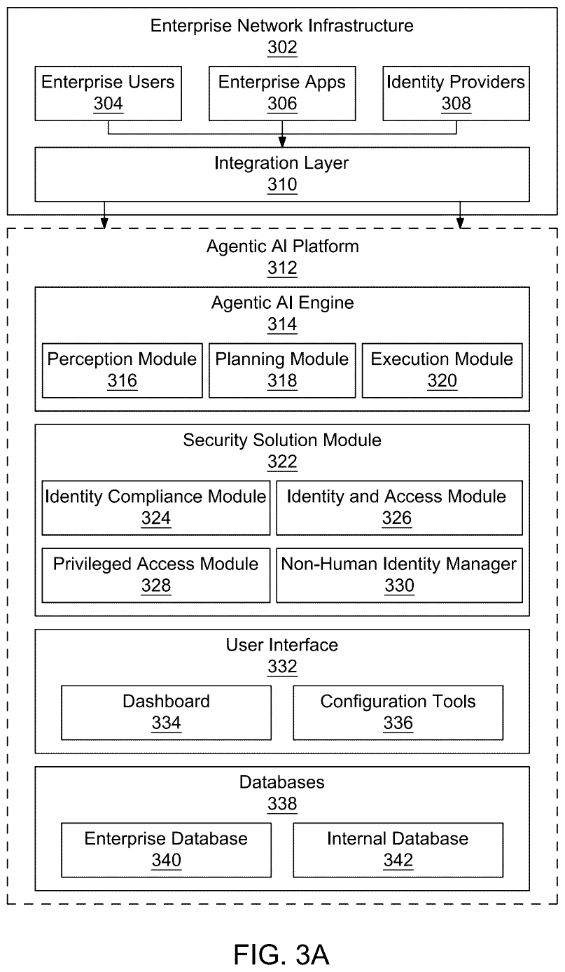

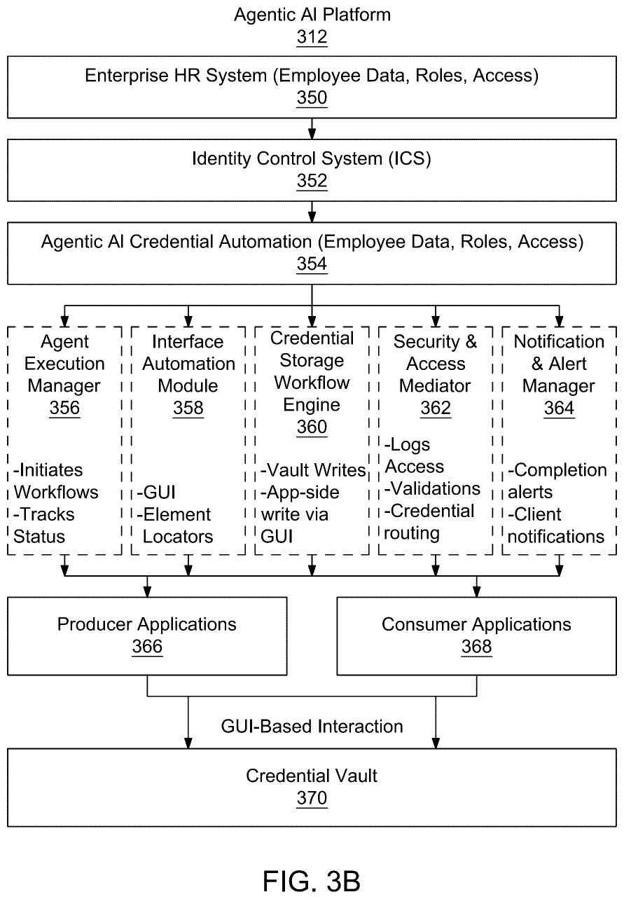

FIG. 3A illustrates an exemplary system architecture depicting internal functional modules of the agentic AI platform, in accordance with certain embodiments of the present disclosure. The architecture is deployed within an enterprise network infrastructure 302 and is communicatively coupled to enterprise users 304, enterprise applications 306, and identity providers 308 via an integration layer 310.

The architecture comprises an agentic AI platform 312 containing an agentic AI engine 314. The agentic AI engine 314 comprises a perception module 316, a planning module 318, and an execution module 320. The perception module 316 is configured to detect and interpret user interface elements rendered on graphical interfaces of enterprise applications using computer vision and image recognition techniques. The planning module 318 is configured to decompose identity governance intents into structured execution plans by interpreting user instructions, evaluating policy constraints, and determining a sequence of actions to be performed across target enterprise applications. The execution module 320 is configured to carry out actions determined by the planning module 318 by generating and executing simulated user interactions with the enterprise application interfaces, including mouse-click simulation, keyboard-input simulation, and form-field population.

The agentic AI platform 312 further comprises a security solution module 322, an identity compliance module 324, an identity and access module 326, a privileged access module 328, and a non-human identity manager 330. The security solution module 322 provides security validation and enforcement across platform workflows. The identity compliance module 324 monitors and enforces compliance with regulatory and organizational access control policies. The identity and access module 326 manages user identity lifecycle operations including provisioning, deprovisioning, and entitlement review. The privileged access module 328 manages elevated access privileges and privileged session controls. The non-human identity manager 330 manages credentials and access privileges associated with service accounts, machine identities, and automated processes.

The architecture comprises a user interface 332 including a dashboard 334 and configuration tools 336 accessible to enterprise administrators and compliance personnel. The architecture is communicatively coupled to databases 338 including an enterprise database 340 and an internal database 342 that store identity records, access policies, credential metadata, and audit logs.

### Agentic AI Credential Automation System

FIG. 3B illustrates the agentic AI platform 312, described with reference to FIG. 3A, configured as an agentic AI credential automation system for performing graphical user interface (GUI)-based orchestration for enterprise identity workflows, in accordance with certain embodiments of the present disclosure. FIG. 3B depicts a credential automation subsystem within the agentic AI platform 312, bridging enterprise policy engines with application endpoints through an intelligent middleware capable of credential generation, injection, and lifecycle management.

The agentic AI platform 312, as depicted in FIG. 3B, comprises an enterprise human resources (HR) system 350 that functions as an authoritative data source for user identity attributes, including employee data, roles, and access entitlements. The enterprise HR system 350 maintains updated metadata about each employee and acts as an originator of identity provisioning or deprovisioning events.

An identity control system (ICS) 352 receives the user identity attributes from the enterprise HR system 350 and evaluates organizational access policies. The identity control system 352 determines application access, triggers credential creation or removal, and stores policy metadata. For example, upon offboarding, the identity control system 352 triggers workflows to remove application-level access, which are then delegated to the credential automation subsystem.

An agentic AI credential automation module 354 functions as a middleware execution engine configured to translate access decisions into executable actions. The agentic AI credential automation module 354 receives the employee data, the roles, and the access entitlements from the identity control system 352 and serves as a core protocol abstraction layer capable of interacting with a heterogeneous application ecosystem. The agentic AI credential automation module 354 orchestrates credential issuance, revocation, and updates across both connected and disconnected systems.

The agentic AI credential automation module 354 comprises an agent execution manager 356, an interface automation module 358, a credential storage workflow engine 360, a security and access mediator 362, and a notification and alert manager 364. The agent execution manager 356 initiates workflows and tracks execution status by decomposing incoming identity intents into atomic sub-tasks and routing the sub-tasks to appropriate modules. For example, upon receiving an instruction to generate a new application programming interface key, the agent execution manager 356 may trigger the credential storage workflow engine 360 and a credential generation workflow in parallel.

The interface automation module 358 facilitates GUI-level automation for applications that lack standard application programming interface connectivity. The interface automation module 358 includes logic for identifying GUI elements including input fields, buttons, dropdowns, and dynamic frames using element locators. The interface automation module 358 enables the agentic AI platform 312 to perform programmatic interactions with external systems in a human-like manner.

The credential storage workflow engine 360 manages secure handling and routing of credentials. The credential storage workflow engine 360 supports vault write operations to a centralized credential vault 370 and application-side write operations via GUI interfaces. For example, a newly created application programming interface key for a field service application may be stored in the credential vault 370 while also being simultaneously injected into an application user management portal.

The security and access mediator 362 logs access events, performs policy validations, and manages credential routing during workflow execution. The security and access mediator 362 monitors transactional success or failure and is configured to enforce conditional logic including time-based access expiry and escalation rules.

The notification and alert manager 364 handles completion alerts and client notifications across the agentic AI platform 312. Upon successful completion of credential-related operations, the notification and alert manager 364 sends alerts to appropriate stakeholders including system administrators, compliance officers, or application owners.

Producer applications 366 represent internal enterprise systems configured to generate credentials, including credential generators, application programming interface key generators, and internal administrative user interfaces. Consumer applications 368 are target systems that rely on generated credentials for user access, including regulatory submission applications, customer relationship management platforms, field operations tools, and treasury systems. The agentic AI credential automation module 354 interacts with both the producer applications 366 and the consumer applications 368 via GUI-based interaction.

The credential vault 370 serves as a centralized storage repository for enterprise credentials. The credential vault 370 is updated via the credential storage workflow engine 360 and supports credential rotations and time-to-live (TTL) enforcement. The credential vault 370 stores credentials including passwords, application programming interface keys, and authentication tokens in an encrypted format, and maintains credentials that are valid and within expiration boundaries.

The agentic AI platform 312, as depicted in FIG. 3B, facilitates a GUI-driven, application-agnostic, and audit-enforced identity orchestration mechanism that reduces dependency on application-specific application programming interfaces. The agentic AI platform 312 is updatable through deployment application template (DAT) files, allowing new applications to be integrated without system reengineering.

FIGS. 1A through 3B describe a generic agentic artificial intelligence (AI) platform for enterprise environments, including overall system architectures in which AI agents interact with a plurality of enterprise applications, identity control systems, credential vaults, and supporting infrastructure. The platform of FIGS. 1A through 3B provides a general operating framework in which AI agents perform autonomous tasks on behalf of human administrators across both applications exposing programmatic interfaces and applications accessible through graphical user interfaces.

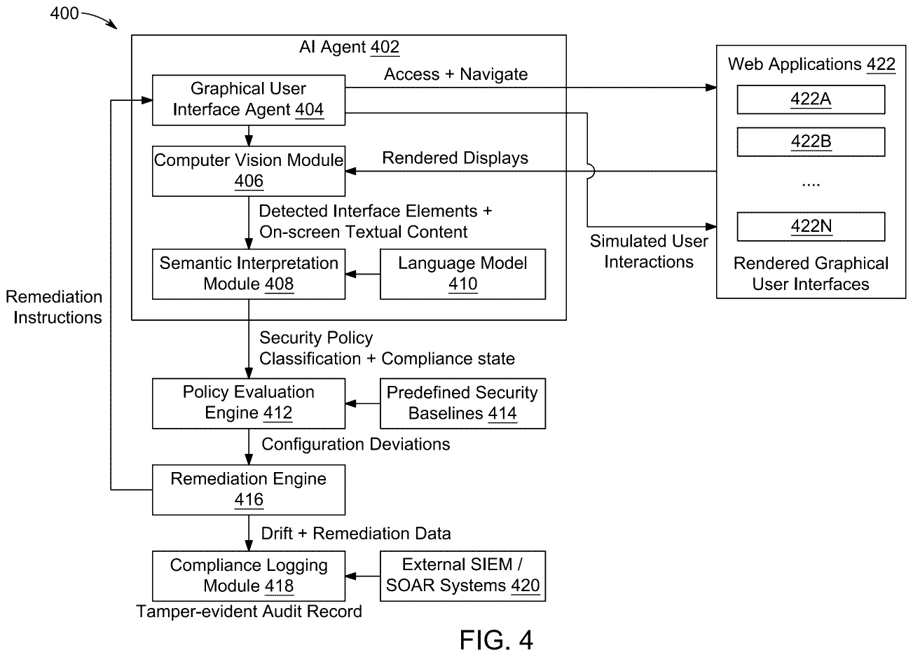

The present disclosure, beginning at FIG. 4, applies the foregoing operating framework to a specific technical problem of detecting and remediating security configuration drift in web-based applications whose security configuration settings are accessible through rendered graphical user interfaces. FIG. 4 and the figures that follow describe a closed-loop visual compliance architecture in which an AI agent visually reads a security configuration interface of a web-based application, determines a per-element compliance state against a predefined security baseline using a language model applied to on-screen textual content, alters a non-compliant interface element through a simulated user interaction with the same rendered graphical user interface, and verifies the altered interface element by re-reading the rendered graphical user interface after the simulated user interaction.

### System for Detecting and Remediating Security Configuration Drifts in Web Applications

FIG. 4 illustrates a system 400 for detecting and remediating security configuration drifts in web applications using interface-centric artificial intelligence agents. The system 400 is configured to perform automated compliance management of security configuration settings of one or more web applications by visually reading a rendered graphical user interface (GUI) of each web application; determining, for each of a plurality of interface elements rendered in the GUI of a web application, a first compliance state by applying a language model to on-screen textual content associated with the interface element, each interface element being associated with a respective security configuration setting of the web application; altering, through the GUI, a configuration state of an interface element whose first compliance state indicates non-compliance by generating a simulated user interaction with the interface element; determining, after the altering, a second compliance state of the altered interface element by applying the language model to on-screen textual content associated with the altered interface element as rendered after the altering; and confirming, based on the second compliance state, that the altered interface element matches an expected compliant configuration defined by a predefined security baseline. The on-screen textual content associated with the altered interface element as rendered after the altering is produced by the web application in response to the simulated user interaction.

The system 400 implements a closed-loop visual compliance architecture for enterprise security management, in which many enterprise web applications expose security configuration settings through administrative graphical user interfaces and, in some embodiments, do not expose those security configuration settings through application programming interfaces (APIs) or structured configuration data exports. A web application refers to a software application that renders one or more administrative configuration interfaces on a graphical user interface accessible through a web browser or an equivalent rendering environment. The web applications include, for example, cloud productivity suites, customer relationship management (CRM) platforms, video conferencing applications, collaboration platforms, human capital management platforms, identity and access management (IAM) portals, and third-party software-as-a-service (SaaS) platforms having configuration options accessible through user interface controls.

The system 400 comprises an artificial intelligence agent 402 communicatively coupled to one or more web applications 422 including a first web application 422A, a second web application 422B, and additional web applications through an Nth web application 422N. The artificial intelligence agent 402 is configured to access and interact with each web application of the web applications 422 through the rendered graphical user interface of the web application and, in some embodiments, in a manner that mirrors a human administrator navigating the same rendered graphical user interface, without invoking an application programming interface of the web application and without requiring a structured configuration data export from the web application. The artificial intelligence agent 402 is implemented as one or more software processes executing on a computing device communicatively coupled to the web applications 422 through a network, as a headless browser session rendering the administrative graphical user interface of each web application in a controlled environment, as a browser automation driver operating against a hosted web browser, or as a set of browser-embedded processes operating within an administrator browser session. In one embodiment, the artificial intelligence agent 402 is deployed independently for each web application of the web applications 422. In another embodiment, the artificial intelligence agent 402 is deployed as a unified agent operating concurrently across a plurality of the web applications 422.

The artificial intelligence agent 402 includes a graphical user interface agent 404. The graphical user interface agent 404 is configured to access a security configuration interface of each web application of the web applications 422 by authenticating to the web application using an administrator credential or another authorized credential, navigating to an administrative section of the web application, and causing the web application to render the security configuration interface within the rendered graphical user interface. For example, the graphical user interface agent 404 accesses a security settings page of a cloud productivity suite using a predefined login credential and a predefined navigation routine, whereupon the cloud productivity suite renders the security settings page on the rendered graphical user interface. In further examples, the graphical user interface agent 404 accesses an administrative console of a customer relationship management platform, an administrative dashboard of a video conferencing application, or an organizational settings page of a collaboration platform. The graphical user interface agent 404 is implemented using a headless browser framework, a browser automation driver, a remote execution endpoint, an accessibility-tree-aware rendering agent, or any combination of the foregoing, and in certain embodiments is further configured to maintain a persistent session with each of the web applications 422 across successive monitoring cycles.

The artificial intelligence agent 402 further includes a computer vision module 406 communicatively coupled to the graphical user interface agent 404. The computer vision module 406 is configured to detect and segment interface elements from a rendered display of the graphical user interface of each web application of the web applications 422 accessed by the graphical user interface agent 404. Each of the plurality of interface elements is associated with a respective security configuration setting of the web application. The interface elements include, without limitation, toggles, dropdown menus, radio buttons, sliders, checkboxes, and status indicators rendered on the security configuration interface. The computer vision module 406 further classifies each detected interface element based on visual presentation to determine a current visual state of the detected interface element, including whether the detected interface element reflects an enabled or a disabled configuration state, based on spatial position, color profile, rendering pattern, and visual indicators of the detected interface element. For example, the computer vision module 406 identifies a toggle labeled as a sharing control and determines the current visual state of the toggle as enabled based on a positional indicator of the toggle. In a further example, the computer vision module 406 identifies a checkbox labeled as a multi-factor authentication control and determines the current visual state of the checkbox as inactive based on an absence of a checkmark. In yet a further example, the computer vision module 406 identifies a dropdown menu labeled as a session timeout control and determines the current visual state of the dropdown menu as reflecting a selected session timeout duration based on visible text within the dropdown menu. The computer vision module 406 is implemented using a convolutional neural network detector, a transformer-based vision model, a vision transformer (ViT), a template matching algorithm, an optical character recognition (OCR) pipeline, an accessibility-tree inspection process combined with a visual cross-reference, or any combination of the foregoing.

The artificial intelligence agent 402 further includes a semantic interpretation module 408 communicatively coupled to the computer vision module 406. The semantic interpretation module 408 is configured to interpret a meaning of each interface element detected by the computer vision module 406 and to determine, for each detected interface element, a first compliance state by applying a language model 410 to on-screen textual content associated with the interface element, the on-screen textual content being textual content visible on the graphical user interface at the time of the determining, and the first compliance state indicating whether the interface element is compliant or non-compliant with a predefined security baseline. The semantic interpretation module 408 is further configured to determine, for each detected interface element, a security control category identifying a type of security policy governed by the interface element. The on-screen textual content comprises textual content visible on the graphical user interface at the time of the detection of the detected interface element, and is produced by a rendering pipeline of the respective web application of the web applications 422. In one embodiment, the on-screen textual content associated with a detected interface element comprises a label of the interface element, descriptive text rendered in proximity to the interface element, a tooltip rendered on hover or focus of the interface element, and a section heading under which the interface element is rendered. For example, a label adjacent to a toggle is interpreted by the semantic interpretation module 408 to represent a configuration relating to external user permissions or authentication requirements. In a further example, a tooltip associated with a checkbox is interpreted by the semantic interpretation module 408 to indicate that the checkbox governs a multi-factor authentication enforcement policy.

The language model 410 is implemented as a trained large language model (LLM), a transformer-based text classifier, a multimodal model configured to consume rendered textual content, or any trained text-input model capable of producing a structured semantic representation of an input text sequence. In certain embodiments, the language model 410 is pre-trained on a corpus comprising security configuration documentation, enterprise security policy corpora, and security benchmark specifications, and a single pre-trained instance of the language model 410 is applied uniformly across the web applications 422 to determine the security control category and the first compliance state for detected interface elements rendered by each of the web applications 422. An output of the semantic interpretation module 408 for each detected interface element comprises a structured representation having the security control category identifying a type of security policy governed by the detected interface element, and a binary indicator of compliance or non-compliance with the predefined security baseline. The security control category includes, without limitation, authentication and access control settings, data sharing and privacy settings, third-party application integration permissions, notification and logging settings, and user role and privilege configurations. The semantic interpretation module 408 is further configured to discriminate between interface elements associated with respective security configuration settings and non-security interface content within the security configuration interface, and to exclude non-security interface content from the determination of the security control category and the first compliance state.

The system 400 further comprises a policy evaluation engine 412 communicatively coupled to the semantic interpretation module 408. The policy evaluation engine 412 is configured to evaluate the security control category and the first compliance state determined by the semantic interpretation module 408 for each detected interface element against one or more predefined security baselines 414 accessible to the policy evaluation engine 412. The predefined security baselines 414 specify an expected security configuration value for each of a plurality of security control categories, and are maintained in a data store operably coupled to the policy evaluation engine 412. In various embodiments, the predefined security baselines 414 are derived from at least one of Center for Internet Security (CIS) benchmark controls for enterprise web applications, National Institute of Standards and Technology (NIST) Special Publication 800-53 security control requirements, SOC 2 trust service criteria, and an organizational security policy defining an expected configuration state for each monitored web application. For example, a predefined security baseline of the predefined security baselines 414 specifies that external file sharing is to be disabled for a cloud productivity suite. In a further example, a predefined security baseline of the predefined security baselines 414 specifies that two-factor authentication is to remain active across all supported web applications of the web applications 422. The policy evaluation engine 412 compares the first compliance state of each detected interface element against the corresponding expected security configuration value in the predefined security baselines 414, and identifies one or more configuration deviations in one or more of the web applications 422. Each configuration deviation identified by the policy evaluation engine 412 is associated with a respective non-compliant interface element whose first compliance state does not satisfy the predefined security baselines 414. In certain embodiments, the policy evaluation engine 412 is further configured to generate a per-element deviation report identifying each non-compliant interface element whose first compliance state differs from the expected security configuration value.

The system 400 further comprises a remediation engine 416 communicatively coupled to the policy evaluation engine 412. The remediation engine 416 is configured to execute, upon identification of a configuration deviation by the policy evaluation engine 412, at least one corrective modification to the non-compliant interface element associated with the configuration deviation by altering, through the graphical user interface, a configuration state of the non-compliant interface element through generating a simulated user interaction with the non-compliant interface element through the rendered graphical user interface of the respective web application of the plurality of web applications 422. The at least one simulated user interaction is dispatched by the remediation engine 416 through the graphical user interface agent 404 to a rendering pipeline of the respective web application as a simulated user-facing input event. The simulated user-facing input event is received by the rendering pipeline of the respective web application in the same manner as a keyboard or pointing device input event generated by an administrator, and causes the respective web application to update an internal configuration store of the respective web application and to re-render the non-compliant interface element in an altered displayed state in response to the simulated user-facing input event.

The remediation engine 416 transmits a remediation instruction to the graphical user interface agent 404 identifying the security configuration interface containing the non-compliant interface element and the corrective modification to be applied, and causes the graphical user interface agent 404 to navigate to the security configuration interface containing the non-compliant interface element. The computer vision module 406 locates the non-compliant interface element within the rendered display of the security configuration interface, and the remediation engine 416 causes the graphical user interface agent 404 to generate at least one simulated user interaction with the non-compliant interface element through the rendered graphical user interface. The simulated user interaction comprises at least one of a simulated mouse click, a simulated keyboard input, or a simulated control selection on the non-compliant interface element, and is dispatched to the rendering pipeline of the respective web application as a user-facing input event. For example, to revert an externally enabled file-sharing toggle to a disabled state, the remediation engine 416 directs the graphical user interface agent 404 to dispatch a simulated click on the toggle, whereupon the respective web application responds by updating an internal configuration store of the respective web application and re-rendering the toggle in the disabled position. In a further example, to enforce multi-factor authentication, the remediation engine 416 directs the graphical user interface agent 404 to dispatch a simulated click on a checkbox labeled as a multi-factor authentication control, whereupon the respective web application re-renders the checkbox in a checked state.

After the altering, the computer vision module 406 and the semantic interpretation module 408 are re-invoked to determine a second compliance state of the altered interface element by applying the language model 410 to on-screen textual content associated with the altered interface element as rendered after the altering, the on-screen textual content associated with the altered interface element as rendered after the altering being produced by the respective web application in response to the simulated user interaction. The computer vision module 406 re-detects the altered interface element from the rendered display produced by the respective web application after the simulated user interaction. The semantic interpretation module 408 re-applies the language model 410 to on-screen textual content associated with the altered interface element as rendered after the altering. The re-application yields the second compliance state of the altered interface element. The policy evaluation engine 412 compares the second compliance state of the altered interface element against an expected compliant configuration defined by the predefined security baselines 414 and produces a verification output indicating whether the altered interface element matches the expected compliant configuration. If the second compliance state indicates that the altered interface element matches the expected compliant configuration, the policy evaluation engine 412 produces a verification success output confirming that the simulated user interaction transitioned the altered interface element to a compliant state. If the second compliance state indicates that the altered interface element is non-compliant with the predefined security baseline, the policy evaluation engine 412 produces a verification failure alert, and the remediation engine 416 initiates a retry of the at least one corrective modification or escalates the verification failure alert to an administrator.

The system 400 further comprises a compliance logging module 418 communicatively coupled to the policy evaluation engine 412 and to the remediation engine 416. The compliance logging module 418 is configured to generate a tamper-evident audit record comprising an identifier of the web application, an identifier of the altered interface element, the first compliance state, the simulated user interaction, a timestamp, and the second compliance state. In certain embodiments, the tamper-evident audit record further comprises a description of the corrective modification performed by the remediation engine 416. The tamper-evident audit record is stored by the compliance logging module 418 in a tamper-resistant audit trail for regulatory compliance and administrative oversight, and in certain embodiments is cryptographically hashed or chained across successive audit records to preserve tamper-evidence.

The compliance logging module 418 is further communicatively coupled to an external compliance infrastructure system 420. The external compliance infrastructure system 420 comprises at least one of a security information and event management platform or a security orchestration, automation, and response system, and includes, for example, Splunk, IBM QRadar, and Microsoft Sentinel. The compliance logging module 418 transmits the tamper-evident audit record in real time to the external compliance infrastructure system 420 via at least one of Syslog, an HTTP webhook, or a message queuing protocol comprising Apache Kafka or Advanced Message Queuing Protocol (AMQP). The real-time transmission allows drift detection events and corresponding remediation actions generated by the system 400 to be received by the external compliance infrastructure system 420 as the drift detection events and corresponding remediation actions are generated, without manual export, and facilitates downstream automated policy enforcement and incident response workflows of the external compliance infrastructure system 420.

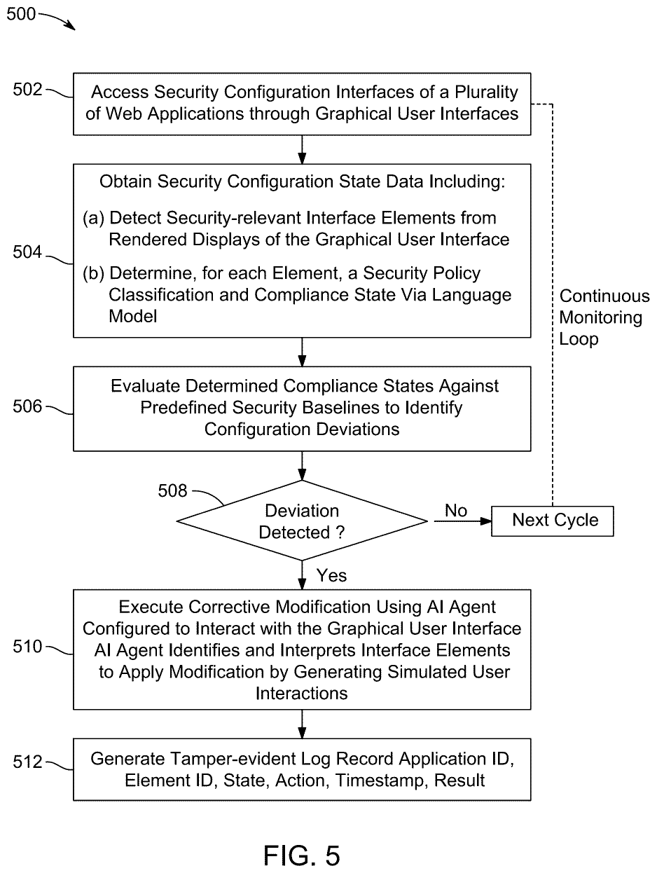

The determining of the first compliance state by the graphical user interface agent 404, the computer vision module 406, and the semantic interpretation module 408 accommodates changes to the graphical user interface of each web application of the web applications 422 across successive version updates of each web application, including at least one of repositioned interface elements, modified labels of interface elements, or updated interface layouts, and, in some embodiments, redesigned configuration page structures, so that the system 400 continues to operate across the web applications 422 without reconfiguration of the system 400 for each application version update. In one embodiment, the artificial intelligence agent 402, the policy evaluation engine 412, the remediation engine 416, and the compliance logging module 418 are deployed as a unified monitoring service operating concurrently or sequentially across the web applications 422 within a single operational cycle. In a further embodiment, the system 400 is configured to operate in a continuous monitoring loop that periodically repeats the determining of the first compliance state, the altering, the determining of the second compliance state, and the confirming for each of a plurality of web applications, and triggers the graphical user interface agent 404, the computer vision module 406, the semantic interpretation module 408, the policy evaluation engine 412, the remediation engine 416, and the compliance logging module 418 in sequence for each periodic access, as described in further detail with reference to FIG. 5.

### Method for Detecting and Remediating Security Configuration Drifts in Web Applications

FIG. 5 illustrates a method 500 for detecting and remediating security configuration drifts in web applications using interface-centric artificial intelligence agents. The method 500 is a computer-implemented method executed by the system 400 described with reference to FIG. 4 and comprises a sequence of automated operations executed across the rendered graphical user interfaces of one or more web applications. The method 500 implements a closed-loop visual compliance cycle in which a rendered graphical user interface of a web application is visually read to determine, for each of a plurality of interface elements rendered in the graphical user interface of the web application, a first compliance state; a non-compliant interface element is altered through a simulated user interaction with the rendered graphical user interface; and the altered interface element is evaluated to determine a second compliance state and to confirm whether the altered interface element matches an expected compliant configuration defined by a predefined security baseline.

In some embodiments, the method 500 is performed without invoking an application programming interface (API) of the web application and without requiring a structured configuration data export from the web application, and is suited to web applications whose security configuration settings are accessible through administrative graphical user interfaces. The method 500 is executed on one or more computing devices and is implemented as computer-readable instructions stored on a non-transitory computer-readable medium that, when executed by at least one processor, cause the at least one processor to perform the operations described below. In various embodiments, the method 500 is executed across a plurality of web applications concurrently or sequentially within a single operational cycle and is executed in a continuous monitoring loop that periodically repeats the operations of the method 500 for each of the web applications without manual initiation of each monitoring cycle.

The method 500 begins at step 502, wherein a graphical user interface agent 404 accesses security configuration interfaces of a plurality of web applications 422 through rendered graphical user interfaces of the plurality of web applications 422. The graphical user interface agent 404 authenticates to each web application of the plurality of web applications 422 using an administrator credential or another authorized credential, navigates to an administrative section of the web application, and causes the web application to render the security configuration interface within the rendered graphical user interface. For example, the graphical user interface agent 404 accesses a security settings page of a cloud productivity suite using a predefined login credential and a predefined navigation routine, whereupon the cloud productivity suite renders the security settings page on the rendered graphical user interface. In a further example, the graphical user interface agent 404 accesses an administrative console of a customer relationship management (CRM) platform, an administrative dashboard of a video conferencing application, or an organizational settings page of a collaboration platform. In some embodiments, at least one web application of the plurality of web applications 422 has security configuration settings that are accessed through the rendered graphical user interface of the web application rather than through an application programming interface of the web application, and the graphical user interface agent 404 accesses the security configuration interface of the at least one web application through the rendered graphical user interface of the web application.

The method 500 proceeds to step 504, wherein the system 400 obtains security configuration state data from at least one web application of the plurality of web applications 422. Obtaining the security configuration state data includes a first sub-operation 504(a) and a second sub-operation 504(b), performed for each of a plurality of interface elements rendered in the graphical user interface of the web application, wherein each of the plurality of interface elements is associated with a respective security configuration setting of the web application.

At sub-operation 504(a), a computer vision module 406 detects interface elements from rendered displays of the graphical user interface of the web application. In one embodiment, the interface elements are implemented as security-relevant interface elements, each security-relevant interface element referring to an interactive control whose displayed state reflects or governs a security configuration setting of the web application. The interface elements include, without limitation, toggles, dropdown menus, radio buttons, sliders, checkboxes, and status indicators rendered on the security configuration interface. The computer vision module 406 further classifies each detected interface element based on visual presentation to determine a current visual state of the detected interface element, including whether the detected interface element reflects an enabled or a disabled security configuration state. For example, at sub-operation 504(a), the computer vision module 406 identifies a toggle labeled as a multi-factor authentication control and determines the current visual state of the toggle as active or inactive based on a positional indicator of the toggle. In a further example, the computer vision module 406 identifies a dropdown menu labeled as a session timeout control and determines the current visual state of the dropdown menu as reflecting a selected session timeout duration based on visible text within the dropdown menu.

At sub-operation 504(b), a semantic interpretation module 408 determines, for each detected interface element, a first compliance state by applying a language model 410 to on-screen textual content associated with the interface element, the on-screen textual content being textual content visible on the graphical user interface at the time of the determining, and the first compliance state indicating whether the interface element is compliant or non-compliant with a predefined security baseline. In one embodiment, the first compliance state is alternatively implemented as or represented by a security policy classification and a compliance state, wherein the security policy classification identifies a security control category governed by the interface element and the compliance state comprises a binary indicator of compliance or non-compliance with the predefined security baseline. The on-screen textual content comprises textual content visible on the graphical user interface at the time of the detection of the detected interface element, and is produced by a rendering pipeline of the web application. In one embodiment, the on-screen textual content associated with a detected interface element comprises a label of the interface element, descriptive text rendered in proximity to the interface element, a tooltip rendered on hover or focus of the interface element, and a section heading under which the interface element is rendered. The security control category includes, without limitation, authentication and access control settings, data sharing and privacy settings, third-party application integration permissions, notification and logging settings, and user role and privilege configurations. For example, at sub-operation 504(b), the semantic interpretation module 408 applies the language model 410 to on-screen textual content comprising a visible label “Allow users to share files externally,” an adjacent descriptive label “External sharing,” and a section heading “Data Sharing,” and determines a first compliance state indicating non-compliance with a predefined security baseline of the predefined security baselines 414 that specifies external file sharing is to be disabled. In one embodiment of that example, the semantic interpretation module 408 further produces a security policy classification identifying the data sharing and privacy settings category. In a further example, the semantic interpretation module 408 applies the language model 410 to on-screen textual content comprising a visible label “Require multi-factor authentication for all users,” a tooltip reading “When enabled, all users must verify identity,” and a section heading “Multi-Factor Authentication,” and determines a first compliance state indicating non-compliance with a predefined security baseline of the predefined security baselines 414 that specifies multi-factor authentication is to remain active. In one embodiment of that example, the semantic interpretation module 408 further produces a security policy classification identifying the authentication and access control settings category. The semantic interpretation module 408 further discriminates between interface elements associated with respective security configuration settings and non-security interface content within the security configuration interface, and excludes non-security interface content from the determination of the first compliance state.

The method 500 proceeds to step 506, wherein a policy evaluation engine 412 evaluates the first compliance state determined by the semantic interpretation module 408 for each detected interface element against one or more predefined security baselines 414 to identify one or more configuration deviations in the at least one web application. In one embodiment, the evaluation further uses a security policy classification identifying a security control category governed by the interface element. The predefined security baselines 414 specify an expected security configuration value for each of a plurality of security control categories, and in various embodiments are derived from at least one of Center for Internet Security (CIS) benchmark controls for enterprise web applications, National Institute of Standards and Technology (NIST) Special Publication 800-53 security control requirements, SOC 2 trust service criteria, or an organizational security policy defining an expected configuration state for each monitored web application. For example, at step 506, the policy evaluation engine 412 compares the first compliance state of a toggle governing external file sharing against a predefined security baseline of the predefined security baselines 414 specifying that external file sharing is to be disabled, and identifies a configuration deviation if the first compliance state indicates that external file sharing is enabled. In a further example, the policy evaluation engine 412 compares the first compliance state of a checkbox governing multi-factor authentication against a predefined security baseline of the predefined security baselines 414 specifying that multi-factor authentication is to be active, and identifies a configuration deviation if the first compliance state indicates that multi-factor authentication is inactive. Each configuration deviation identified by the policy evaluation engine 412 is associated with a respective non-compliant interface element whose first compliance state does not satisfy the predefined security baselines 414.

The method 500 proceeds to decision 508, wherein a determination is made as to whether a configuration deviation has been detected by the policy evaluation engine 412 at step 506. If no configuration deviation is detected at decision 508, the method 500 returns to step 502 for a next cycle of the continuous monitoring loop, without executing a corrective modification. If at least one configuration deviation is detected at decision 508, the method 500 proceeds to step 510.

At step 510, the system 400 executes at least one corrective modification using an artificial intelligence agent 402 configured to interact with the graphical user interface of the at least one web application. The artificial intelligence agent 402 identifies and interprets interface elements rendered on the graphical user interface, the interface elements being associated with security configuration settings of the at least one web application, and alters, through the graphical user interface, a configuration state of a non-compliant interface element by generating and executing a simulated user interaction with the non-compliant interface element. Step 510 is performed by a remediation engine 416 causing the graphical user interface agent 404 to navigate to the security configuration interface containing the non-compliant interface element, the computer vision module 406 to locate the non-compliant interface element within the rendered display of the security configuration interface, and the remediation engine 416 to cause the graphical user interface agent 404 to generate at least one simulated user interaction with the non-compliant interface element through the rendered graphical user interface. The simulated user interaction comprises at least one of a simulated mouse click, a simulated keyboard input, or a simulated control selection on the non-compliant interface element, and is dispatched to the rendering pipeline of the at least one web application as a user-facing input event. For example, at step 510, to revert an externally enabled file-sharing toggle to a disabled state, the remediation engine 416 directs the graphical user interface agent 404 to dispatch a simulated click on the toggle, whereupon the at least one web application responds by updating an internal configuration store of the at least one web application and re-rendering the toggle in the disabled position. In a further example, to enforce multi-factor authentication, the remediation engine 416 directs the graphical user interface agent 404 to dispatch a simulated click on a checkbox governing multi-factor authentication, whereupon the at least one web application re-renders the checkbox in a checked state.

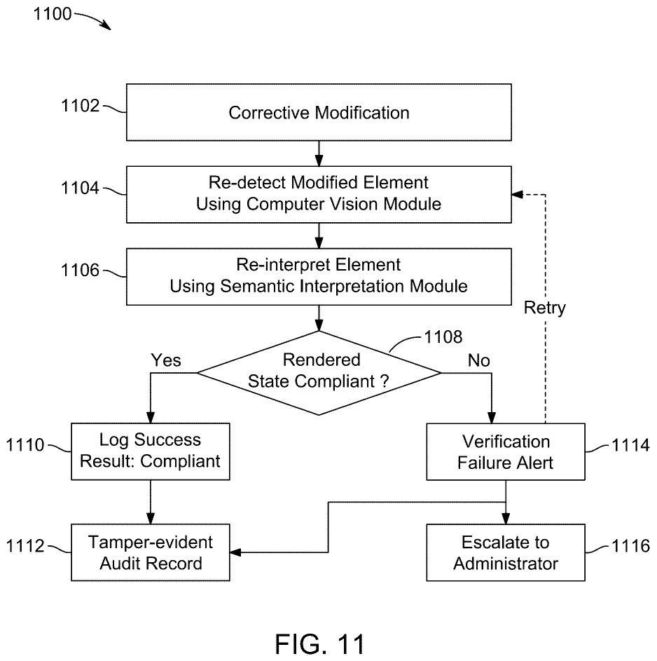

Following the simulated user interaction at step 510, the computer vision module 406 and the semantic interpretation module 408 are re-invoked to determine a second compliance state of the altered interface element by applying the language model 410 to on-screen textual content associated with the altered interface element as rendered after the altering, the on-screen textual content associated with the altered interface element as rendered after the altering being produced by the at least one web application in response to the simulated user interaction. The computer vision module 406 re-detects the altered interface element from the rendered display produced by the at least one web application after the simulated user interaction. The semantic interpretation module 408 re-applies the language model 410 to on-screen textual content associated with the altered interface element as rendered after the simulated user interaction. The re-application yields the second compliance state of the altered interface element. The policy evaluation engine 412 compares the second compliance state against an expected compliant configuration defined by the predefined security baselines 414 and produces a verification output indicating whether the altered interface element matches the expected compliant configuration, as described in further detail with reference to FIG. 11. If the second compliance state indicates that the altered interface element is non-compliant with the predefined security baseline, the policy evaluation engine 412 generates a verification failure alert.

The method 500 proceeds to step 512, wherein a compliance logging module 418 generates a tamper-evident audit record for the configuration deviation identified at step 506 and the corresponding corrective modification executed at step 510. In one embodiment, the tamper-evident audit record is alternatively referred to as a tamper-evident log record. The tamper-evident audit record comprises an identifier of the web application, an identifier of the altered interface element, the first compliance state, the simulated user interaction, a timestamp, and the second compliance state. In one embodiment, the identifier of the web application is implemented as an application identifier, the identifier of the altered interface element is implemented as an interface element identifier or element ID, the first compliance state is alternatively referred to as a state, the simulated user interaction is alternatively referred to as an action, and the second compliance state is alternatively referred to as a result. In a further embodiment, the tamper-evident audit record further comprises a description of the corrective modification performed by the remediation engine 416. The tamper-evident audit record is stored by the compliance logging module 418 in a tamper-resistant audit trail for regulatory compliance and administrative oversight, and in certain embodiments is cryptographically hashed or chained across successive tamper-evident audit records to preserve tamper-evidence. In further embodiments, the tamper-evident audit record is transmitted in real time to an external compliance infrastructure system 420 via at least one of Syslog, an HTTP webhook, or a message queuing protocol comprising Apache Kafka or Advanced Message Queuing Protocol (AMQP), the external compliance infrastructure system 420 comprising at least one of a security information and event management platform or a security orchestration, automation, and response system.

Following step 512, the method 500 returns to step 502 for a next cycle of the continuous monitoring loop. The continuous monitoring loop periodically repeats the operations of step 502, step 504, step 506, decision 508, step 510, and step 512 for each of the plurality of web applications 422 without manual initiation of each monitoring cycle, so that security configuration drift from the predefined security baselines 414 is detected and remediated on an ongoing basis across the plurality of web applications 422. In one embodiment, the continuous monitoring loop is triggered on a predetermined schedule, such as at a fixed interval of hours, days, or weeks. In a further embodiment, the continuous monitoring loop is triggered on an event-driven basis, such as upon detection of an organizational change, a user access event, or a security incident. In some embodiments, the determining of the first compliance state accommodates changes to the graphical user interface of the web application, including at least one of repositioned interface elements, modified labels of interface elements, or updated interface layouts. The method 500 enables closed-loop governance of security configurations by detecting and correcting unauthorized or accidental changes to security configuration settings through a visual interface automation process, and facilitates monitoring of web applications without exposing configuration states through structured interfaces and without manual administrator intervention between the detection of a configuration deviation and the confirmation that a corrective modification achieved an expected compliant state.

### AI Agent Architecture

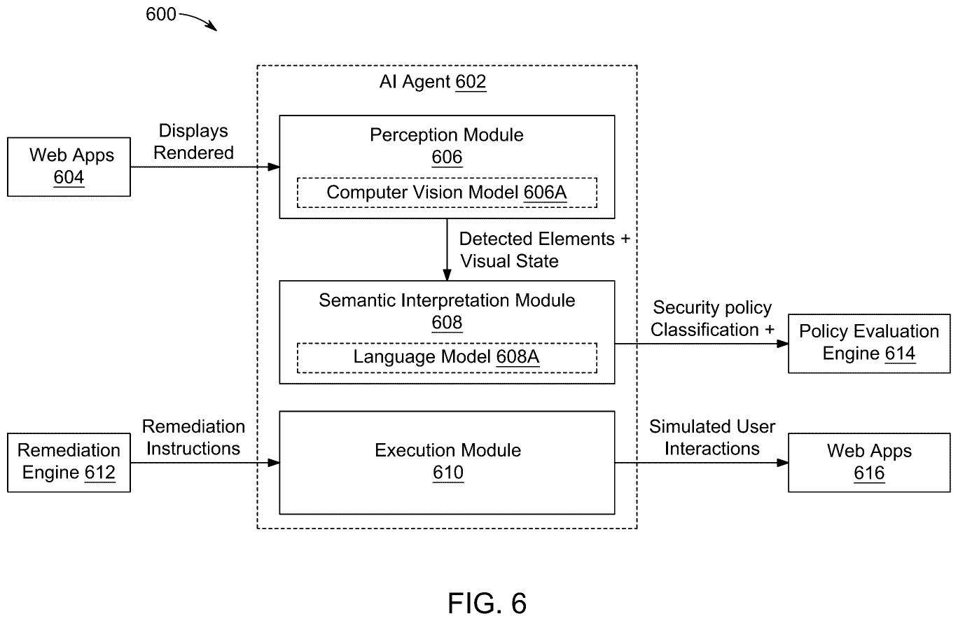

FIG. 6 illustrates an AI agent architecture 600 of an artificial intelligence agent. The AI agent architecture 600 depicts an internal functional decomposition of the artificial intelligence agent into a set of cooperating modules that together perform a closed-loop visual compliance cycle. The AI agent architecture 600 is implemented as one or more software processes executing on one or more computing devices communicatively coupled to a plurality of web applications through a network. In various embodiments, the AI agent architecture 600 is deployed as a unified agent process, as a set of cooperating microservices, or as a collection of browser-embedded processes operating within an administrator browser session. In some embodiments, the AI agent architecture 600 enables the artificial intelligence agent to interact with each web application of the plurality of web applications through a rendered graphical user interface of the web application, without invoking an application programming interface (API) of the web application and without requiring a structured configuration data export from the web application.

The AI agent architecture 600 comprises an AI agent 602. The AI agent 602 performs perception, semantic interpretation, and execution functions by which the AI agent 602 reads, interprets, and acts upon rendered graphical user interfaces of web applications. The AI agent 602 is communicatively coupled to web applications 604 that provide rendered displays to the AI agent 602 and to web applications 616 that receive simulated user interactions from the AI agent 602. In some embodiments, the web applications 604 and the web applications 616 are the same web applications of the plurality of web applications operating in different roles during a compliance cycle, such that rendered displays of the web applications 604 are read by the AI agent 602 and simulated user interactions dispatched by the AI agent 602 are received by the same web applications as the web applications 616. In one embodiment, rendered displays of the web applications 604 are delivered to the AI agent 602 through a headless browser session rendering an administrative graphical user interface of each web application in a controlled environment. In a further embodiment, rendered displays of the web applications 604 are delivered to the AI agent 602 through a browser automation driver operating against a hosted web browser.

The AI agent 602 includes a perception module 606 communicatively coupled to the web applications 604. The perception module 606 is configured to detect interface elements from rendered displays of the graphical user interface of each web application of the web applications 604, each detected interface element being associated with a respective security configuration setting of the web application. In one embodiment, the interface elements are alternatively referred to as security-relevant interface elements. The perception module 606 includes a computer vision model 606A. The computer vision model 606A is applied by the perception module 606 to a rendered display received from a web application of the web applications 604 to identify and classify interface elements rendered on the rendered display and to determine a current visual state of each identified interface element. The interface elements identified by the perception module 606 using the computer vision model 606A include, without limitation, toggles, dropdown menus, radio buttons, sliders, checkboxes, and status indicators rendered on a security configuration interface of the web application. For example, the perception module 606 applies the computer vision model 606A to a rendered display of a cloud productivity suite and identifies a toggle labeled as a sharing control together with a current visual state of the toggle as enabled or disabled. In a further example, the perception module 606 applies the computer vision model 606A to a rendered display of a customer relationship management (CRM) platform and identifies a checkbox labeled as a multi-factor authentication control together with a current visual state of the checkbox as checked or unchecked. The computer vision model 606A is implemented as a convolutional neural network detector, a transformer-based vision model, a vision transformer (ViT), a template matching algorithm, an optical character recognition (OCR) pipeline, an accessibility-tree inspection process combined with a visual cross-reference, or any combination of the foregoing. In certain embodiments, the computer vision model 606A is trained on a corpus of administrative graphical user interface screenshots annotated with labeled interface elements. The perception module 606 outputs, for each rendered display processed by the computer vision model 606A, detected elements together with the current visual state of each detected element, collectively referred to as detected elements and visual state data.

The AI agent 602 further includes a semantic interpretation module 608 communicatively coupled to the perception module 606. The semantic interpretation module 608 is configured to determine, for each detected interface element, a first compliance state by applying a language model 608A to on-screen textual content associated with the interface element. The on-screen textual content is textual content visible on the graphical user interface at the time of the determining, and the first compliance state indicates whether the interface element is compliant or non-compliant with a predefined security baseline. In one embodiment, the first compliance state comprises a security control category identifying a type of security policy governed by the interface element and a binary indicator of compliance or non-compliance with the predefined security baseline, and the security control category is alternatively referred to as a security policy classification. The semantic interpretation module 608 receives, as input from the perception module 606, the detected elements and visual state data produced by the perception module 606. The semantic interpretation module 608 includes the language model 608A. The language model 608A is applied by the semantic interpretation module 608 to on-screen textual content associated with each detected interface element. The on-screen textual content is produced by a rendering pipeline of the respective web application of the web applications 604. In one embodiment, the on-screen textual content associated with a detected interface element comprises a label of the interface element, descriptive text rendered in proximity to the interface element, a tooltip rendered on hover or focus of the interface element, and a section heading under which the interface element is rendered. The language model 608A is implemented as a trained large language model (LLM), a transformer-based text classifier, a multimodal model configured to consume rendered textual content, or any trained text-input model capable of producing a structured semantic representation of an input text sequence. In certain embodiments, the language model 608A is pre-trained on a corpus comprising security configuration documentation, enterprise security policy corpora, and security benchmark specifications. The semantic interpretation module 608 transmits the first compliance state and, in some embodiments, the security policy classification to a policy evaluation engine 614.

The policy evaluation engine 614 is communicatively coupled to the semantic interpretation module 608. The policy evaluation engine 614 is configured to evaluate the first compliance state received from the semantic interpretation module 608 against one or more predefined security baselines to identify one or more configuration deviations, each configuration deviation being associated with a respective non-compliant interface element whose first compliance state does not satisfy the one or more predefined security baselines. In some embodiments, the policy evaluation engine 614 further evaluates a security policy classification identifying a security control category governed by the interface element. For example, the policy evaluation engine 614 compares a first compliance state of a toggle governing external file sharing against a predefined security baseline specifying that external file sharing is to be disabled, and identifies a configuration deviation if the first compliance state indicates that external file sharing is enabled. In a further example, the policy evaluation engine 614 compares a first compliance state of a checkbox governing multi-factor authentication against a predefined security baseline specifying that multi-factor authentication is to be active, and identifies a configuration deviation if the first compliance state indicates that multi-factor authentication is inactive. Upon identification of a configuration deviation, the policy evaluation engine 614 provides deviation information identifying the non-compliant interface element to a remediation engine 612.

The remediation engine 612 is communicatively coupled to the policy evaluation engine 614 and to an execution module 610 of the AI agent 602. The remediation engine 612 is configured to initiate, upon receiving deviation information from the policy evaluation engine 614, at least one corrective modification to the non-compliant interface element associated with the configuration deviation. The remediation engine 612 generates remediation instructions identifying the security configuration interface containing the non-compliant interface element and the corrective modification to be applied, and transmits the remediation instructions to the execution module 610.

The AI agent 602 further includes the execution module 610 communicatively coupled to the remediation engine 612 and to the web applications 616. The execution module 610 is configured to alter, through the graphical user interface, a configuration state of a non-compliant interface element by generating and executing, in response to remediation instructions received from the remediation engine 612, at least one simulated user interaction with the non-compliant interface element through the rendered graphical user interface of the respective web application of the web applications 616. The simulated user interaction comprises at least one of a simulated mouse click, a simulated keyboard input, or a simulated control selection on the non-compliant interface element, and is dispatched by the execution module 610 to a rendering pipeline of the respective web application of the web applications 616 as a user-facing input event. For example, the execution module 610 dispatches a simulated click to a toggle governing external file sharing of a cloud productivity suite of the web applications 616, whereupon the cloud productivity suite responds by updating an internal configuration store of the cloud productivity suite and re-rendering the toggle in a disabled position. In a further example, the execution module 610 dispatches a simulated click to a checkbox governing multi-factor authentication of a CRM platform of the web applications 616, whereupon the CRM platform re-renders the checkbox in a checked state.

Following dispatch of the simulated user interaction by the execution module 610 to a web application of the web applications 616, the web application re-renders the non-compliant interface element with an altered displayed state on the rendered graphical user interface, and the altered displayed state is made available to the AI agent 602 as part of a rendered display of the web application. In one embodiment, the perception module 606 and the semantic interpretation module 608 are re-invoked on the altered rendered display of the web application to determine a second compliance state of the altered interface element. The perception module 606 re-detects the altered interface element from the altered rendered display using the computer vision model 606A, and the semantic interpretation module 608 re-applies the language model 608A to on-screen textual content associated with the altered interface element as rendered after the simulated user interaction, the on-screen textual content as rendered after the simulated user interaction being produced by the respective web application in response to the simulated user interaction. The re-application yields the second compliance state of the altered interface element, and the policy evaluation engine 614 compares the second compliance state against an expected compliant configuration defined by the one or more predefined security baselines to produce a verification output confirming whether the altered interface element matches the expected compliant configuration. If the second compliance state indicates that the altered interface element is non-compliant with the predefined security baseline, the policy evaluation engine 614 generates a verification failure alert.

The AI agent architecture 600 operates as a closed-loop visual compliance cycle in which the perception module 606, the semantic interpretation module 608, the policy evaluation engine 614, the remediation engine 612, and the execution module 610 cooperate to read the rendered graphical user interface of each web application of the web applications 604, to determine a first compliance state for each detected interface element using the computer vision model 606A and the language model 608A, to alter a non-compliant interface element through a simulated user interaction dispatched to the web applications 616 by the execution module 610, and to determine a second compliance state of the altered interface element by re-invoking the perception module 606 and the semantic interpretation module 608 on the altered rendered display. In one embodiment, the AI agent architecture 600 is deployed as a unified agent process operating concurrently or sequentially across a plurality of web applications within a single operational cycle. In a further embodiment, the AI agent architecture 600 is deployed as a distributed set of processes, wherein the perception module 606, the semantic interpretation module 608, and the execution module 610 execute on separate computing devices and communicate through a shared message bus. In some embodiments, determination of the first compliance state by the perception module 606 and the semantic interpretation module 608 accommodates changes to the graphical user interface of the web application, including at least one of repositioned interface elements, modified labels of interface elements, or updated interface layouts.

### Semantic Interpretation Process

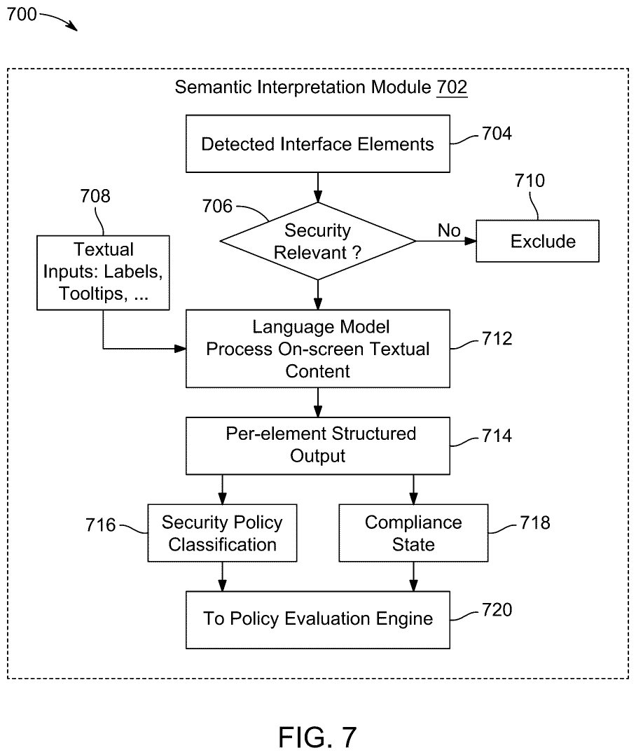

FIG. 7 illustrates a semantic interpretation process 700 performed by a semantic interpretation module 702. The semantic interpretation process 700 depicts operations by which the semantic interpretation module 702 determines, for each detected interface element associated with a respective security configuration setting, a first compliance state by applying a language model to on-screen textual content associated with the detected interface element, and produces a structured output for transmission to a policy evaluation engine. In one embodiment, the semantic interpretation process 700 further discriminates between interface elements associated with security configuration settings and non-security interface content, and determines a security policy classification for each security-relevant interface element. The semantic interpretation process 700 is implemented as one or more software processes executing on one or more computing devices. In various embodiments, the semantic interpretation process 700 is deployed as a dedicated semantic interpretation service, as a shared language model service accessed by a plurality of AI agent deployments, or as an on-device inference process operating within a browser-embedded agent.

The semantic interpretation module 702 is configured to interpret a meaning of each detected interface element received from a computer vision module and to determine, for each detected interface element, a first compliance state. In one embodiment, an interface element associated with a respective security configuration setting is alternatively referred to as a security-relevant interface element. The semantic interpretation module 702 operates on detected interface elements 704 received from the computer vision module. The detected interface elements 704 comprise a set of interface elements that have been detected and segmented by the computer vision module from a rendered display of a graphical user interface of a web application of a plurality of web applications, together with a current visual state of each detected interface element as determined by the computer vision module. In one embodiment, each detected interface element of the detected interface elements 704 comprises an interactive control rendered on a security configuration interface of the web application, the interactive control being selected from one of a toggle, a dropdown menu, a radio button, a slider, a checkbox, or a status indicator, and the current visual state indicates whether the detected interface element reflects an enabled or a disabled security configuration state.

The semantic interpretation process 700 begins at a decision 706, wherein the semantic interpretation module 702 discriminates, for each detected interface element of the detected interface elements 704, whether the detected interface element is associated with a respective security configuration setting or is instead non-security interface content. Non-security interface content refers to interface content that does not reflect or govern a security configuration setting of the web application, including navigation elements, branding elements, productivity controls, and decorative elements rendered on the graphical user interface. At the decision 706, the semantic interpretation module 702 determines whether the detected interface element is associated with a respective security configuration setting based on textual content associated with the detected interface element, a visual context of the detected interface element on the rendered display, and a position of the detected interface element within the security configuration interface of the web application. For example, at the decision 706, the semantic interpretation module 702 determines that a toggle rendered adjacent to a label “Allow users to share files externally” within a section heading “Data Sharing” is associated with a security configuration setting, and determines that a button rendered within a navigation bar and labeled as a productivity shortcut is non-security interface content. In a further example, the semantic interpretation module 702 determines that a checkbox rendered adjacent to a label “Require multi-factor authentication for all users” within a section heading “Multi-Factor Authentication” is associated with a security configuration setting, and determines that a hyperlink rendered within a page footer and labeled as a help link is non-security interface content.

If, at the decision 706, the detected interface element is determined to be non-security interface content, the semantic interpretation process 700 proceeds to an exclude operation 710, wherein the semantic interpretation module 702 excludes the detected interface element from further processing and does not generate a first compliance state for the detected interface element. In one embodiment, the semantic interpretation module 702 also does not generate a security policy classification for the excluded detected interface element. The exclude operation 710 causes non-security interface content to be omitted from subsequent determination of first compliance states by the semantic interpretation module 702, so that downstream evaluation by the policy evaluation engine operates on interface elements associated with respective security configuration settings.

If, at the decision 706, the detected interface element is determined to be associated with a respective security configuration setting, the semantic interpretation process 700 proceeds to textual inputs 708. At the textual inputs 708, the semantic interpretation module 702 assembles textual inputs associated with the detected interface element for processing by a language model 712. The textual inputs 708 comprise on-screen textual content visible on the graphical user interface at a time of the determining and are produced by a rendering pipeline of the web application. In one embodiment, the textual inputs 708 comprise a label of the detected interface element, descriptive text rendered in proximity to the detected interface element, a tooltip rendered on hover or focus of the detected interface element, and a section heading under which the detected interface element is rendered. For example, the semantic interpretation module 702 assembles a visible label “Allow users to share files externally,” descriptive text rendered adjacent to the label, a tooltip rendered on hover of the associated toggle, and a section heading “Data Sharing” as the textual inputs 708. In a further example, the semantic interpretation module 702 assembles a visible label “Require multi-factor authentication for all users,” a tooltip reading “When enabled, all users must verify identity,” and a section heading “Multi-Factor Authentication” as the textual inputs 708.

The semantic interpretation process 700 proceeds from the textual inputs 708 to the language model 712. The language model 712 is applied by the semantic interpretation module 702 to the textual inputs 708 to determine, for the detected interface element, a first compliance state indicating whether the detected interface element is compliant or non-compliant with a predefined security baseline. In one embodiment, the language model 712 is further applied to determine a security control category identifying a type of security policy governed by the detected interface element, the security control category being alternatively referred to as a security policy classification. The language model 712 is implemented as a trained large language model (LLM), a transformer-based text classifier, a multimodal model configured to consume rendered textual content, or any trained text-input model capable of producing a structured semantic representation of an input text sequence. In certain embodiments, the language model 712 is pre-trained on a corpus comprising security configuration documentation, enterprise security policy corpora, and security benchmark specifications including at least one of Center for Internet Security (CIS) benchmark guidelines, National Institute of Standards and Technology (NIST) Special Publication 800-53 security control requirements, or SOC 2 trust service criteria. In certain embodiments, a single pre-trained instance of the language model 712 is applied uniformly across the plurality of web applications to determine the first compliance state for each detected interface element associated with a respective security configuration setting rendered by each of the plurality of web applications.

The semantic interpretation process 700 proceeds to a per-element structured output 714, wherein the semantic interpretation module 702 generates a structured representation for the detected interface element based on processing performed by the language model 712 on the textual inputs 708. The language model 712 processes the textual inputs 708 to derive a semantic meaning of the detected interface element from the label, descriptive text, tooltip, and section heading included in the textual inputs 708. For example, at the per-element structured output 714, the language model 712 processes textual inputs comprising the visible label “Allow users to share files externally,” descriptive text reading “Enables external collaborators to access shared files,” and the section heading “Data Sharing,” and determines a first compliance state indicating that the detected interface element is non-compliant with a predefined security baseline specifying that external file sharing is to be disabled. In one embodiment of that example, the language model 712 further determines a security policy classification identifying a data sharing and privacy settings category. In a further example, the language model 712 processes textual inputs comprising the visible label “Require multi-factor authentication for all users,” the tooltip “When enabled, all users must verify identity,” and the section heading “Multi-Factor Authentication,” and determines a first compliance state indicating whether the detected interface element is compliant or non-compliant with a predefined security baseline specifying that multi-factor authentication is to remain active. In one embodiment of that example, the language model 712 further determines a security policy classification identifying an authentication and access control settings category.

The per-element structured output 714 includes a security policy classification 716 and a compliance state 718. The security policy classification 716 identifies a security control category governed by the detected interface element and includes, without limitation, authentication and access control settings, data sharing and privacy settings, third-party application integration permissions, notification and logging settings, and user role and privilege configurations. The compliance state 718 comprises the first compliance state for the detected interface element and, in one embodiment, comprises a binary indicator of compliance or non-compliance of the detected interface element with one or more predefined security baselines. For example, the per-element structured output 714 for a toggle governing external file sharing includes a security policy classification 716 identifying the data sharing and privacy settings category and a compliance state 718 indicating non-compliance with a predefined security baseline specifying that external file sharing is to be disabled. In a further example, the per-element structured output 714 for a checkbox governing multi-factor authentication includes a security policy classification 716 identifying the authentication and access control settings category and a compliance state 718 indicating compliance or non-compliance with a predefined security baseline specifying that multi-factor authentication is to remain active. In certain embodiments, the per-element structured output 714 further comprises a confidence indicator produced by the language model 712, the confidence indicator representing a reliability of the security policy classification 716 and the compliance state 718.

The security policy classification 716 and the compliance state 718 are provided to a policy evaluation engine at 720. The policy evaluation engine evaluates the per-element structured output 714 against the one or more predefined security baselines to identify one or more configuration deviations, each configuration deviation being associated with a respective detected interface element whose compliance state 718 indicates non-compliance with the one or more predefined security baselines. In one embodiment, the semantic interpretation process 700 is repeated by the semantic interpretation module 702 for each detected interface element of the detected interface elements 704, so that the per-element structured output 714 is produced for each detected interface element associated with a respective security configuration setting. In a further embodiment, the semantic interpretation process 700 is re-invoked on an altered rendered display produced by the web application after a simulated user interaction is dispatched by a remediation engine, so that the per-element structured output 714 is re-generated for an altered interface element and a second compliance state of the altered interface element is produced.

### Multi-Source Textual Context Process

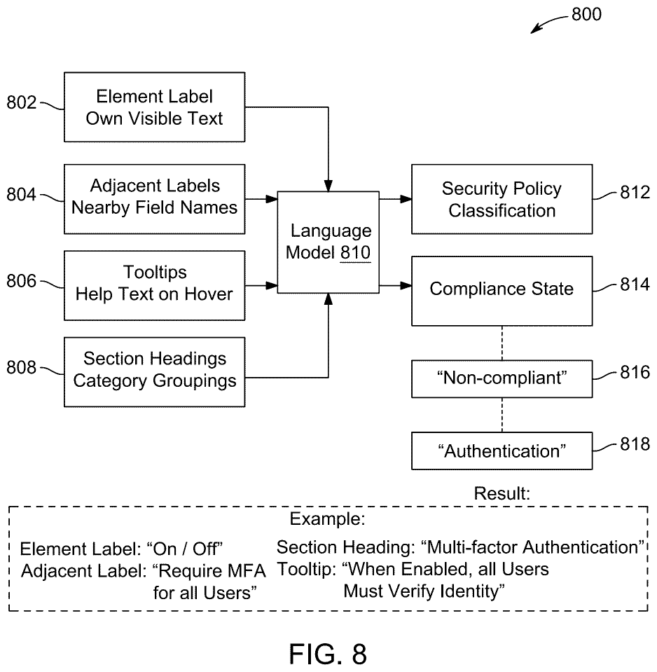

FIG. 8 illustrates a multi-source textual context process 800. The multi-source textual context process 800 depicts a set of textual inputs drawn from multiple sources of on-screen textual content associated with a detected interface element and assembled as input to a language model 810, together with a structured output produced by the language model 810 for the detected interface element. In one embodiment, the detected interface element is associated with a respective security configuration setting and is alternatively referred to as a security-relevant interface element. The multi-source textual context process 800 implements a configuration of a semantic interpretation module in which the language model 810 receives, as input for a given detected interface element, a combined textual context drawn from four distinct sources of on-screen textual content rendered on the graphical user interface of a web application, so that the language model 810 determines a first compliance state for the detected interface element from a full rendered semantic context and not from a label of the detected interface element alone. In one embodiment, the language model 810 further determines a security policy classification for the detected interface element.

The multi-source textual context process 800 draws a first source of on-screen textual content from an element label 802 of the detected interface element. The element label 802 comprises visible text of the detected interface element as rendered on the graphical user interface. The element label 802 refers to textual content rendered within, upon, or immediately attached to the detected interface element by a rendering pipeline of the web application, such that the element label 802 appears visually as a name or caption of the detected interface element. For example, the element label 802 of a toggle governing external file sharing comprises the visible text “On” or “Off” rendered on the toggle itself. In a further example, the element label 802 of a dropdown menu governing a session timeout setting comprises visible text rendered within the dropdown menu representing a currently selected session timeout duration. In yet a further example, the element label 802 of a checkbox governing multi-factor authentication comprises the visible text “On” or “Off” rendered adjacent to the checkbox.

The multi-source textual context process 800 draws a second source of on-screen textual content from adjacent labels 804 rendered in proximity to the detected interface element. The adjacent labels 804 comprise nearby field names, descriptive labels, and captions rendered on the graphical user interface within a predetermined visual proximity of the detected interface element. The adjacent labels 804 describe the security configuration setting governed by the detected interface element in natural language, typically as a short phrase or sentence rendered in proximity to the detected interface element. For example, the adjacent labels 804 of a toggle governing external file sharing comprise a descriptive label reading “Allow users to share files externally” rendered adjacent to the toggle. In a further example, the adjacent labels 804 of a checkbox governing multi-factor authentication comprise a descriptive label reading “Require MFA for all Users” rendered adjacent to the checkbox. The adjacent labels 804 are identified based on spatial proximity to the detected interface element and are provided to the semantic interpretation module as part of the on-screen textual content associated with the detected interface element.

The multi-source textual context process 800 draws a third source of on-screen textual content from tooltips 806 rendered on hover or on focus of the detected interface element. The tooltips 806 comprise help text rendered by the web application when a pointing device hovers over the detected interface element or when the detected interface element receives input focus, and provide additional descriptive information about the security configuration setting governed by the detected interface element. For example, the tooltips 806 of a checkbox governing multi-factor authentication comprise help text reading “When enabled, all users must verify identity” rendered upon hover of the checkbox. In a further example, the tooltips 806 of a dropdown menu governing a session timeout setting comprise help text reading “Users will be logged out after the selected duration of inactivity” rendered upon focus of the dropdown menu. In certain embodiments, the tooltips 806 are retrieved through a programmatic hover or focus event dispatched to the detected interface element, and the resulting rendered tooltip text is extracted from the rendered display and provided to the semantic interpretation module as part of the on-screen textual content.

The multi-source textual context process 800 draws a fourth source of on-screen textual content from section headings 808 under which the detected interface element is rendered. The section headings 808 comprise category groupings, group titles, and page section titles rendered on the graphical user interface and provide a hierarchical context indicating a broader security control category within which the security configuration setting governed by the detected interface element belongs. For example, the section headings 808 of a checkbox governing multi-factor authentication comprise a section heading “Multi-factor Authentication” rendered above the checkbox. In a further example, the section headings 808 of a toggle governing external file sharing comprise a section heading “Data Sharing” or “External Sharing” rendered above the toggle. The section headings 808 are identified based on spatial containment of the detected interface element within a visually demarcated section of the rendered display, and are provided to the semantic interpretation module as part of the on-screen textual content.

The element label 802, the adjacent labels 804, the tooltips 806, and the section headings 808 together constitute a multi-source textual context associated with the detected interface element, and are assembled by the semantic interpretation module as input to the language model 810. The language model 810 is applied by the semantic interpretation module to the multi-source textual context to produce a structured output for the detected interface element. The language model 810 is implemented as a trained large language model (LLM), a transformer-based text classifier, a multimodal model configured to consume rendered textual content, or any trained text-input model capable of producing a structured semantic representation of an input text sequence. In certain embodiments, the language model 810 is pre-trained on a corpus comprising security configuration documentation, enterprise security policy corpora, and security benchmark specifications including at least one of Center for Internet Security (CIS) benchmark guidelines, National Institute of Standards and Technology (NIST) Special Publication 800-53 security control requirements, or SOC 2 trust service criteria.

The language model 810 processes the multi-source textual context to produce a structured output comprising two components for the detected interface element. The first component is a security policy classification 812 identifying a security control category governed by the detected interface element. The security control category identifies a type of security policy governed by the detected interface element and includes, without limitation, authentication and access control settings, data sharing and privacy settings, third-party application integration permissions, notification and logging settings, and user role and privilege configurations. The second component is a compliance state 814 comprising the first compliance state for the detected interface element. In one embodiment, the compliance state 814 comprises a binary indicator of compliance or non-compliance of the detected interface element with one or more predefined security baselines. The security policy classification 812 and the compliance state 814 are transmitted by the semantic interpretation module to a policy evaluation engine for evaluation against the one or more predefined security baselines.

FIG. 8 further illustrates an example application of the multi-source textual context process 800 to a detected interface element governing a multi-factor authentication setting. In the example, the element label 802 reads “On/Off,” the adjacent labels 804 include “Require MFA for all Users,” the section headings 808 include “Multi-factor Authentication,” and the tooltips 806 include “When Enabled, all Users Must Verify Identity.” The example textual inputs are assembled from the four sources together to form the multi-source textual context for the detected interface element and are provided to the language model 810 as input. The language model 810 processes the example textual inputs and produces the compliance state 814 illustrated at 816 as “Non-compliant” and the security policy classification 812 illustrated at 818 as “Authentication.” The security policy classification 812 and the compliance state 814 are transmitted to the policy evaluation engine for evaluation. If the compliance state 814 indicates non-compliance with a predefined security baseline that specifies multi-factor authentication is to remain active, the policy evaluation engine identifies a configuration deviation and triggers a remediation engine to execute at least one corrective modification to the detected interface element.

The multi-source textual context process 800 enables the language model 810 to determine the first compliance state represented by the compliance state 814, and, in one embodiment, the security policy classification 812, of a detected interface element across heterogeneous labeling conventions and presentation styles employed by different web applications, because the combination of the element label 802, the adjacent labels 804, the tooltips 806, and the section headings 808 provides the language model 810 with a full rendered semantic context of the detected interface element and not merely the visible label of the detected interface element. In a further embodiment, the multi-source textual context process 800 is re-executed on a rendered display produced by the respective web application after a simulated user interaction is dispatched to a non-compliant interface element, so that a second compliance state of the altered non-compliant interface element is produced by the language model 810 from the multi-source textual context associated with the altered non-compliant interface element as rendered after the simulated user interaction

### Dual-Path Execution Process

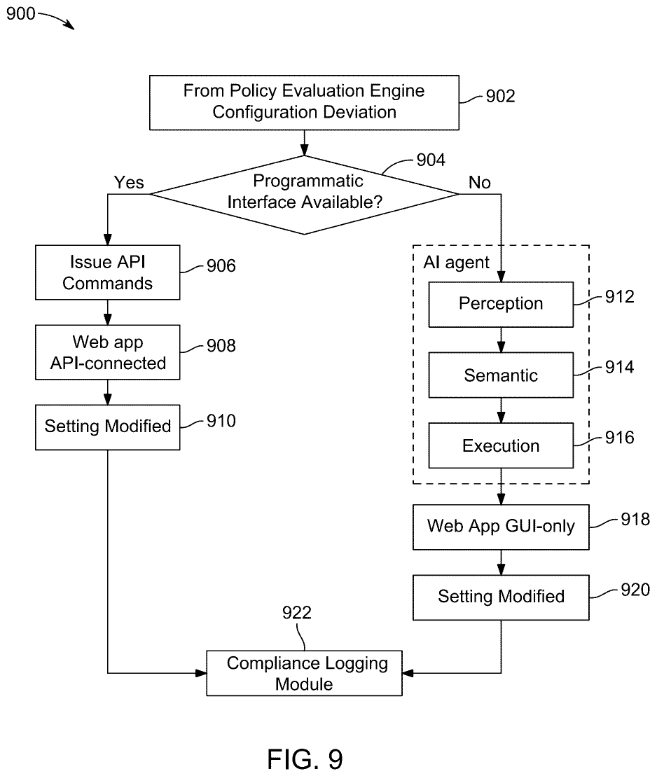

FIG. 9 illustrates a dual-path execution process 900. The dual-path execution process 900 depicts a branching remediation pipeline by which a remediation engine selects, upon identification of a configuration deviation, between a programmatic path and a graphical user interface path for executing at least one corrective modification to a non-compliant interface element associated with the configuration deviation. The dual-path execution process 900 supports heterogeneous web application estates in which a first subset of web applications of a plurality of web applications exposes security configuration settings through application programming interfaces (APIs) and a second subset of web applications of the plurality of web applications exposes security configuration settings through rendered graphical user interfaces. The dual-path execution process 900 is implemented as one or more software processes executing on one or more computing devices.

The dual-path execution process 900 begins at a configuration deviation input 902. The configuration deviation input 902 identifies a non-compliant interface element of a web application of the plurality of web applications, the non-compliant interface element being an interactive control whose first compliance state does not satisfy one or more predefined security baselines. The configuration deviation input 902 further identifies an application identifier of the web application and an expected compliant configuration defined by the one or more predefined security baselines for the non-compliant interface element. In one embodiment, the configuration deviation input 902 further identifies a security policy classification of the non-compliant interface element. For example, the configuration deviation input 902 identifies a non-compliant toggle governing external file sharing in a cloud productivity suite, the expected compliant configuration as a disabled state of the non-compliant toggle, and the security policy classification of the non-compliant toggle as a data sharing and privacy setting. In a further example, the configuration deviation input 902 identifies a non-compliant checkbox governing multi-factor authentication in a customer relationship management (CRM) platform, the expected compliant configuration as a checked state of the non-compliant checkbox, and the security policy classification of the non-compliant checkbox as an authentication and access control setting.

The dual-path execution process 900 proceeds from the configuration deviation input 902 to a decision 904. At the decision 904, a determination is made as to whether a programmatic interface is available for the web application identified in the configuration deviation input 902. A programmatic interface refers to an application programming interface exposed by the web application that permits programmatic modification of the security configuration setting governed by the non-compliant interface element without navigation of the rendered graphical user interface of the web application. At the decision 904, the remediation engine queries a configuration registry accessible to the remediation engine to determine whether the web application exposes a programmatic interface for the security configuration setting associated with the non-compliant interface element. In one embodiment, the remediation engine determines whether the web application exposes a programmatic interface for a security policy classification associated with the non-compliant interface element. The configuration registry maintains, for each web application of the plurality of web applications, an indication of whether the web application exposes a programmatic interface and an identifier of the programmatic interface when exposed. In one embodiment, the configuration registry is pre-populated from an enterprise application inventory. In a further embodiment, the configuration registry is dynamically updated based on previous interactions of an artificial intelligence agent with the plurality of web applications.

If, at the decision 904, a programmatic interface is determined to be available, the dual-path execution process 900 proceeds along a first path to an issue API commands operation 906. At the issue API commands operation 906, the remediation engine issues one or more programmatic commands to the programmatic interface of the web application to modify the security configuration setting governed by the non-compliant interface element. The one or more programmatic commands are generated by the remediation engine based on the expected compliant configuration and modify the security configuration setting such that the security configuration setting conforms to the expected compliant configuration. For example, the remediation engine issues a representational state transfer (REST) API command to a web application exposing a programmatic configuration endpoint to set an external sharing flag to a disabled value. In a further example, the remediation engine issues a Simple Object Access Protocol (SOAP) request to a web application exposing a programmatic administrative interface to set a multi-factor authentication enforcement flag to an active value. The one or more programmatic commands are dispatched over a network by the remediation engine to an API-connected web application 908 of the plurality of web applications, the API-connected web application 908 referring to a web application instance communicatively coupled to the remediation engine through the programmatic interface.

In response to the one or more programmatic commands issued at the issue API commands operation 906, the API-connected web application 908 updates an internal configuration store of the API-connected web application 908 such that the security configuration setting governed by the non-compliant interface element transitions to the expected compliant configuration. The outcome of the first path is a setting modified 910 indicating that the security configuration setting has been modified to the expected compliant configuration through the programmatic interface of the API-connected web application 908.

If, at the decision 904, a programmatic interface is determined not to be available, the dual-path execution process 900 proceeds along a second path to an artificial intelligence agent including a perception 912, a semantic 914, and an execution 916. At the second path, the remediation engine causes the artificial intelligence agent to alter, through the graphical user interface, a configuration state of the non-compliant interface element by generating a simulated user interaction with the non-compliant interface element. The perception 912, the semantic 914, and the execution 916 cooperatively perform the at least one corrective modification on the non-compliant interface element.

At the perception 912 of the artificial intelligence agent, a computer vision module re-detects the non-compliant interface element from a rendered display of a GUI-only web application 918 of the plurality of web applications produced by a rendering pipeline of the GUI-only web application 918. The GUI-only web application 918 refers to a web application instance of the plurality of web applications that does not expose a programmatic interface for the security configuration setting governed by the non-compliant interface element and whose security configuration setting is accessible through the rendered graphical user interface of the GUI-only web application 918. The perception 912 applies a computer vision model to the rendered display of the GUI-only web application 918 to locate the non-compliant interface element within the rendered graphical user interface and to determine a current visual state of the non-compliant interface element. For example, the perception 912 locates a toggle governing external file sharing rendered on a security configuration interface of the GUI-only web application 918 and determines a current visual state of the toggle as enabled. In a further example, the perception 912 locates a checkbox governing multi-factor authentication and determines a current visual state of the checkbox as unchecked.

At the semantic 914 of the artificial intelligence agent, a semantic interpretation module applies a language model to on-screen textual content associated with the non-compliant interface element as rendered on the rendered graphical user interface of the GUI-only web application 918 to confirm, in one embodiment, a security policy classification of the non-compliant interface element and to identify a user-facing control interaction for altering the non-compliant interface element to the expected compliant configuration. The on-screen textual content processed at the semantic 914 comprises textual content visible on the rendered graphical user interface at the time of re-detection and is produced by the rendering pipeline of the GUI-only web application 918. For example, the semantic 914 determines that a toggle governing external file sharing is to be interacted with by a simulated click to transition the toggle from an enabled state to a disabled state. In a further example, the semantic 914 determines that a checkbox governing multi-factor authentication is to be interacted with by a simulated click to transition the checkbox from an unchecked state to a checked state.

At the execution 916 of the artificial intelligence agent, an execution module generates and dispatches at least one simulated user interaction with the non-compliant interface element through the rendered graphical user interface of the GUI-only web application 918. The simulated user interaction comprises at least one of a simulated mouse click, a simulated keyboard input, or a simulated control selection on the non-compliant interface element, and is dispatched to the rendering pipeline of the GUI-only web application 918 as a user-facing input event. For example, the execution 916 dispatches a simulated click to a toggle governing external file sharing, whereupon the GUI-only web application 918 responds by updating an internal configuration store and re-rendering the toggle in a disabled position. In a further example, the execution 916 dispatches a simulated click to a checkbox governing multi-factor authentication, whereupon the GUI-only web application 918 re-renders the checkbox in a checked state.

The outcome of the second path is a setting modified 920 indicating that the security configuration setting has been modified to the expected compliant configuration through the rendered graphical user interface of the GUI-only web application 918 by the at least one simulated user interaction dispatched at the execution 916. In some embodiments, the setting modified 920 is produced without invoking an application programming interface of the GUI-only web application 918 and without requiring a structured configuration data export from the GUI-only web application 918.

Both the first path terminating at the setting modified 910 and the second path terminating at the setting modified 920 of the dual-path execution process 900 converge at a compliance logging module 922. The compliance logging module 922 generates a tamper-evident audit record for the configuration deviation identified at the configuration deviation input 902 and for the corresponding corrective modification executed along the first path or along the second path. The tamper-evident audit record generated by the compliance logging module 922 comprises an identifier of the web application, an identifier of the altered interface element, the first compliance state detected before the corrective modification, the simulated user interaction, a timestamp, and a second compliance state indicating whether the altered interface element matches the expected compliant configuration. In one embodiment, when the corrective modification is executed along the first path, the tamper-evident audit record further includes a path indicator identifying that the corrective modification was executed through the programmatic interface. In a further embodiment, when the corrective modification is executed along the second path, the tamper-evident audit record further includes a path indicator identifying that the corrective modification was executed through the rendered graphical user interface. In a further embodiment, the tamper-evident audit record further includes a description of the corrective modification performed along the first path or along the second path, so that subsequent review of the tamper-evident audit record distinguishes between remediation actions applied by the issue API commands operation 906 and remediation actions applied by the artificial intelligence agent of the second path.

The dual-path execution process 900 enables application of the at least one corrective modification to each configuration deviation regardless of whether the respective web application of the plurality of web applications exposes a programmatic interface for the security configuration setting governed by the non-compliant interface element. The dual-path execution process 900 further enables unified compliance logging across a heterogeneous web application estate by directing both the first path and the second path to the compliance logging module 922 and by causing the tamper-evident audit record to be generated in a common format for remediation actions executed along either path. In one embodiment, the dual-path execution process 900 is executed for each configuration deviation during a single monitoring cycle. In a further embodiment, the dual-path execution process 900 is repeated across successive monitoring cycles of a continuous monitoring loop.

### Three-Step Remediation Process

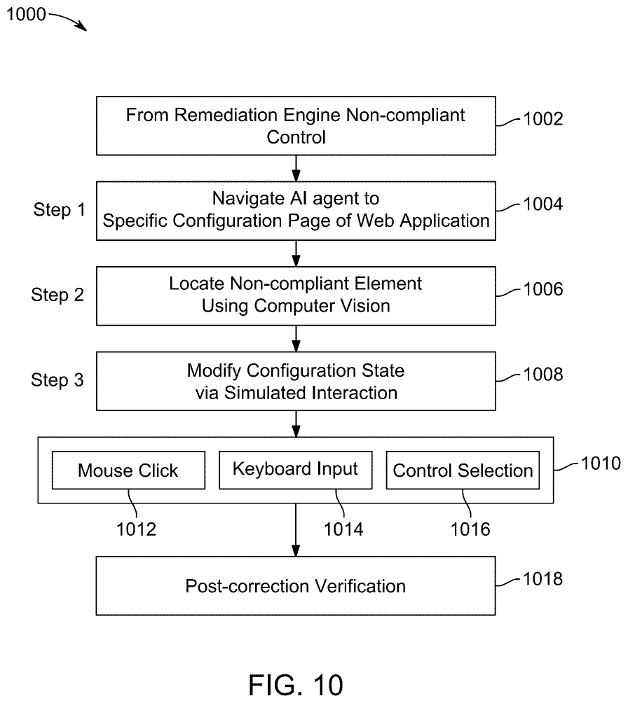

FIG. 10 illustrates a three-step remediation process 1000. The three-step remediation process 1000 depicts an ordered sequence of three operations by which at least one corrective modification is executed on a non-compliant interface element of a web application of a plurality of web applications through the rendered graphical user interface of the web application. The three-step remediation process 1000 operates when a programmatic interface of the web application is not available or when the remediation engine is configured to operate through the rendered graphical user interface. The three-step remediation process 1000 is implemented as one or more software processes executing on one or more computing devices.

The three-step remediation process 1000 begins at a non-compliant interface element input 1002. In one embodiment, the non-compliant interface element is alternatively referred to as a non-compliant control. The non-compliant interface element input 1002 identifies a non-compliant interface element of a web application of the plurality of web applications, the non-compliant interface element being an interactive control whose first compliance state does not satisfy one or more predefined security baselines. The non-compliant interface element input 1002 further identifies an application identifier of the web application, an expected compliant configuration defined by the one or more predefined security baselines for the non-compliant interface element, and a configuration page identifier identifying a configuration page of the web application on which the non-compliant interface element is rendered. In one embodiment, the non-compliant interface element input 1002 further identifies a security policy classification of the non-compliant interface element. For example, the non-compliant interface element input 1002 identifies a non-compliant toggle governing external file sharing in a cloud productivity suite, the configuration page identifier of a data sharing settings page, and the expected compliant configuration as a disabled state of the non-compliant toggle. In a further example, the non-compliant interface element input 1002 identifies a non-compliant checkbox governing multi-factor authentication in a customer relationship management (CRM) platform, the configuration page identifier of a security settings page, and the expected compliant configuration as a checked state of the non-compliant checkbox.

The three-step remediation process 1000 proceeds from the non-compliant interface element input 1002 to a first operation 1004 of the ordered sequence. At the first operation 1004, a remediation engine navigates an artificial intelligence agent to the specific configuration page of the web application identified by the configuration page identifier of the non-compliant interface element input 1002. The remediation engine transmits a navigation instruction to a graphical user interface agent identifying the configuration page containing the non-compliant interface element, and causes the graphical user interface agent to navigate through the rendered graphical user interface of the web application to the configuration page. The graphical user interface agent authenticates to the web application using an administrator credential or another authorized credential, traverses an administrative section of the web application, and causes the web application to render the configuration page containing the non-compliant interface element within the rendered graphical user interface. For example, at the first operation 1004, the graphical user interface agent navigates to a data sharing settings page of a cloud productivity suite on which a toggle governing external file sharing is rendered. In a further example, the graphical user interface agent navigates to a security settings page of a CRM platform on which a checkbox governing multi-factor authentication is rendered. In some embodiments, the first operation 1004 is performed without invoking an application programming interface (API) of the web application and without requiring a structured configuration data export from the web application, and the graphical user interface agent navigates to the configuration page through the rendered graphical user interface of the web application.

The three-step remediation process 1000 proceeds from the first operation 1004 to a second operation 1006 of the ordered sequence. At the second operation 1006, a computer vision module locates the non-compliant interface element on the configuration page to which the graphical user interface agent has navigated at the first operation 1004. The computer vision module applies a computer vision model to a rendered display of the configuration page and identifies the non-compliant interface element within the rendered display based on spatial position, visual presentation, and associated on-screen textual content of the non-compliant interface element. For example, at the second operation 1006, the computer vision module identifies a toggle governing external file sharing within the rendered display based on a label adjacent to the toggle reading “Allow users to share files externally” and a positional indicator of the toggle on the rendered display. In a further example, the computer vision module identifies a checkbox governing multi-factor authentication within the rendered display based on a label adjacent to the checkbox reading “Require multi-factor authentication for all users” and a positional indicator of the checkbox on the rendered display. In one embodiment, the second operation 1006 further determines a current visual state of the non-compliant interface element at the time of the locating, so that the simulated user interaction generated at the third operation 1008 is appropriate to transition the non-compliant interface element from the current visual state to a compliant visual state.

The three-step remediation process 1000 proceeds from the second operation 1006 to a third operation 1008 of the ordered sequence. At the third operation 1008, the remediation engine alters, through the graphical user interface, a configuration state of the non-compliant interface element by generating at least one simulated user interaction with the non-compliant interface element. The at least one simulated user interaction is dispatched through the graphical user interface agent to a rendering pipeline of the web application as a user-facing input event, and causes the web application to update an internal configuration store of the web application and to re-render the non-compliant interface element in an altered displayed state consistent with the expected compliant configuration defined by the one or more predefined security baselines.

The at least one simulated user interaction generated at the third operation 1008 is selected from a group of simulated-interaction options 1010 and comprises at least one of a simulated mouse click 1012, a simulated keyboard input 1014, or a simulated control selection 1016. The simulated mouse click 1012 comprises a programmatically generated mouse event dispatched at a screen coordinate associated with the non-compliant interface element. The simulated mouse click 1012 includes, without limitation, a single-click event, a double-click event, or a click-and-drag event dispatched to the rendered graphical user interface. For example, the simulated mouse click 1012 is dispatched at a coordinate of a toggle governing external file sharing, whereupon the web application responds by toggling the toggle from an enabled position to a disabled position. In a further example, the simulated mouse click 1012 is dispatched at a coordinate of a checkbox governing multi-factor authentication, whereupon the web application responds by transitioning the checkbox from an unchecked state to a checked state.

The simulated keyboard input 1014 comprises a programmatically generated keyboard event dispatched to the non-compliant interface element as a user-facing input event. The simulated keyboard input 1014 includes, without limitation, a key-press event, a key-release event, or a sequence of key-press events representing a text string entered into a text-input interface element. For example, the simulated keyboard input 1014 comprises a sequence of key-press events representing a session timeout duration entered into a text-input field governing a session timeout setting. In a further example, the simulated keyboard input 1014 comprises a key-press event representing a tab key dispatched to shift input focus from a first interface element to a second interface element of the configuration page.

The simulated control selection 1016 comprises a programmatically generated selection event dispatched to a selection-type interface element associated with the non-compliant interface element. The simulated control selection 1016 includes, without limitation, a dropdown menu selection, a radio button selection, or a slider adjustment. For example, the simulated control selection 1016 comprises a dropdown menu selection dispatched to a dropdown menu governing a session timeout duration, wherein the simulated control selection 1016 selects a session timeout duration corresponding to the expected compliant configuration defined by the one or more predefined security baselines for the dropdown menu. In a further example, the simulated control selection 1016 comprises a radio button selection dispatched to a radio button group governing a user privilege level, wherein the simulated control selection 1016 selects a user privilege level corresponding to the expected compliant configuration for the radio button group.

The third operation 1008 produces an altered non-compliant interface element rendered on the rendered graphical user interface of the web application, the altered non-compliant interface element being the non-compliant interface element after the web application has responded to the at least one simulated user interaction by updating the internal configuration store and re-rendering the non-compliant interface element in the altered displayed state. In some embodiments, the third operation 1008 is performed through the rendered graphical user interface of the web application without invoking an application programming interface of the web application. In a further embodiment, the third operation 1008 causes the web application to dispatch a client-side rendering update that re-renders the non-compliant interface element with a displayed state that reflects an enabled or a disabled security configuration state consistent with the expected compliant configuration.

The three-step remediation process 1000 proceeds from the third operation 1008 to a post-correction verification 1018. The post-correction verification 1018 is an entry point of a verification process by which the computer vision module and a semantic interpretation module are re-invoked on the rendered graphical user interface of the web application after the third operation 1008 to determine a second compliance state of the altered non-compliant interface element, and by which a policy evaluation engine confirms that the altered non-compliant interface element matches the expected compliant configuration defined by the one or more predefined security baselines. The post-correction verification 1018 receives as input the altered non-compliant interface element produced at the third operation 1008 and initiates a re-detection of the altered non-compliant interface element by the computer vision module and a re-application of a language model of the semantic interpretation module to on-screen textual content associated with the altered non-compliant interface element as rendered after the third operation 1008. If the second compliance state indicates that the altered non-compliant interface element is non-compliant with the one or more predefined security baselines, the policy evaluation engine generates a verification failure alert.

The three-step remediation process 1000 enables the at least one corrective modification to be applied to each non-compliant interface element of the plurality of web applications through the ordered sequence of the first operation 1004, the second operation 1006, and the third operation 1008, wherein each of the first operation 1004, the second operation 1006, and the third operation 1008 operates on the rendered graphical user interface of the web application. In one embodiment, the three-step remediation process 1000 is executed for each non-compliant interface element identified in a single monitoring cycle of a continuous monitoring loop. In a further embodiment, the three-step remediation process 1000 is repeated across successive monitoring cycles for each non-compliant interface element of the plurality of web applications.

### Post-Correction Verification Process

FIG. 11 illustrates a post-correction verification process 1100. The post-correction verification process 1100 depicts a closed-loop visual verification mechanism by which a computer vision module and a semantic interpretation module are re-invoked on a rendered graphical user interface of a web application of a plurality of web applications after at least one corrective modification has been performed on an altered interface element, to determine a second compliance state of the altered interface element and to confirm that the altered interface element matches an expected compliant configuration defined by one or more predefined security baselines. In one embodiment, the altered interface element is an interface element that was non-compliant prior to the corrective modification. The post-correction verification process 1100 is implemented as one or more software processes executing on one or more computing devices.

The post-correction verification process 1100 begins at a corrective modification 1102. The corrective modification 1102 identifies an altered interface element of a web application of the plurality of web applications, wherein the altered interface element has been altered through at least one simulated user interaction dispatched to a rendering pipeline of the web application. The corrective modification 1102 further identifies an application identifier of the web application, an expected compliant configuration defined by the one or more predefined security baselines for the altered interface element, and a timestamp of the at least one simulated user interaction. In one embodiment, the corrective modification 1102 further identifies a security policy classification of the altered interface element. For example, the corrective modification 1102 identifies an altered toggle governing external file sharing in a cloud productivity suite, the expected compliant configuration as a disabled state of the toggle, and the timestamp of a simulated click dispatched to the toggle. In a further example, the corrective modification 1102 identifies an altered checkbox governing multi-factor authentication in a customer relationship management (CRM) platform, the expected compliant configuration as a checked state of the checkbox, and the timestamp of a simulated click dispatched to the checkbox.

The post-correction verification process 1100 proceeds from the corrective modification 1102 to a re-detect modified element using computer vision module operation 1104. At the re-detect operation 1104, the computer vision module re-detects the altered interface element from a rendered display of the rendered graphical user interface of the web application as rendered after the at least one simulated user interaction. The rendered display processed at the re-detect operation 1104 is produced by the rendering pipeline of the web application in response to the at least one simulated user interaction, and reflects an altered displayed state of the altered interface element consistent with an internal configuration store of the web application as updated by the web application in response to the at least one simulated user interaction. The computer vision module applies a computer vision model to the rendered display, re-identifies the altered interface element based on spatial position, visual presentation, and associated on-screen textual content, and determines a current visual state of the altered interface element including whether the altered interface element reflects an enabled or a disabled security configuration state. For example, the computer vision module re-detects a toggle governing external file sharing as rendered after a simulated click and determines the current visual state of the toggle as disabled. In a further example, the computer vision module re-detects a checkbox governing multi-factor authentication as rendered after a simulated click and determines the current visual state of the checkbox as checked.

The post-correction verification process 1100 proceeds from the re-detect operation 1104 to a re-interpret element using semantic interpretation module operation 1106. At the re-interpret operation 1106, the semantic interpretation module re-interprets the altered interface element re-detected at the re-detect operation 1104 by applying a language model to on-screen textual content associated with the altered interface element as rendered after the at least one simulated user interaction. The on-screen textual content processed at the re-interpret operation 1106 comprises textual content visible on the rendered graphical user interface of the web application at the time of the re-detect operation 1104 and is produced by the rendering pipeline of the web application in response to the at least one simulated user interaction. In one embodiment, the on-screen textual content processed at the re-interpret operation 1106 comprises a label of the altered interface element, descriptive text rendered in proximity to the altered interface element, a tooltip rendered on hover or focus of the altered interface element, and a section heading under which the altered interface element is rendered. The re-application of the language model at the re-interpret operation 1106 yields the second compliance state of the altered interface element, the second compliance state indicating whether the altered interface element is compliant or non-compliant with the one or more predefined security baselines. In one embodiment, the second compliance state comprises a binary indicator of compliance or non-compliance and is paired with a security policy classification of the altered interface element re-confirmed at the re-interpret operation 1106. For example, the re-interpret operation 1106 produces a second compliance state indicating compliance with a predefined security baseline that specifies external file sharing is to be disabled for an altered toggle governing external file sharing. In a further example, the re-interpret operation 1106 produces a second compliance state indicating compliance with a predefined security baseline that specifies multi-factor authentication is to remain active for an altered checkbox governing multi-factor authentication.

The post-correction verification process 1100 proceeds from the re-interpret operation 1106 to a rendered state compliant decision 1108. At the rendered state compliant decision 1108, a policy evaluation engine compares the second compliance state produced at the re-interpret operation 1106 against the expected compliant configuration defined by the one or more predefined security baselines and determines whether a rendered state of the altered interface element matches the expected compliant configuration. The rendered state compliant decision 1108 produces a verification output indicating whether the altered interface element matches the expected compliant configuration.

If, at the rendered state compliant decision 1108, the second compliance state indicates that the rendered state of the altered interface element matches the expected compliant configuration, the post-correction verification process 1100 proceeds along a first branch to a log success operation 1110. At the log success operation 1110, a verification success output is produced confirming that the at least one simulated user interaction transitioned the altered interface element to a compliant state matching the expected compliant configuration. The log success operation 1110 records a result of compliant for the altered interface element, and the verification success output together with the second compliance state is transmitted to a compliance logging module.

The post-correction verification process 1100 proceeds from the log success operation 1110 to a tamper-evident audit record 1112. The tamper-evident audit record 1112 is generated by the compliance logging module and comprises an identifier of the web application, an identifier of the altered interface element, a first compliance state detected before the corrective modification, the simulated user interaction, a timestamp of the corrective modification, and the second compliance state produced at the re-interpret operation 1106. In one embodiment, the tamper-evident audit record 1112 further comprises a description of the corrective modification performed. The tamper-evident audit record 1112 is stored in a tamper-resistant audit trail for regulatory compliance and administrative oversight, and in certain embodiments is cryptographically hashed or chained across successive tamper-evident audit records to preserve tamper-evidence.

If, at the rendered state compliant decision 1108, the second compliance state indicates that the rendered state of the altered interface element does not match the expected compliant configuration, the post-correction verification process 1100 proceeds along a second branch to a verification failure alert 1114. At the verification failure alert 1114, a verification failure output is produced indicating that the at least one simulated user interaction did not transition the altered interface element to a compliant state matching the expected compliant configuration. For example, the verification failure alert 1114 is generated when a simulated click dispatched to a toggle governing external file sharing fails to transition the toggle to a disabled state, such that the second compliance state indicates that the toggle remains in an enabled state inconsistent with the expected compliant configuration. In a further example, the verification failure alert 1114 is generated when a simulated click dispatched to a checkbox governing multi-factor authentication fails to transition the checkbox to a checked state, such that the second compliance state indicates that the checkbox remains in an unchecked state inconsistent with the expected compliant configuration.

In one embodiment, following the verification failure alert 1114, the post-correction verification process 1100 initiates a retry by returning to the re-detect operation 1104, so that the altered interface element is re-detected and re-interpreted to determine whether the rendered state has transitioned to a compliant state. In a further embodiment, the retry is performed up to a predetermined maximum number of retry attempts. If the predetermined maximum number of retry attempts is reached without the altered interface element matching the expected compliant configuration, or if the retry is not initiated, the post-correction verification process 1100 proceeds from the verification failure alert 1114 to an escalate to administrator operation 1116.

At the escalate to administrator operation 1116, the verification failure alert 1114 is escalated to an administrator through an administrator notification channel. The administrator notification channel includes, without limitation, an electronic mail notification, a text message notification, a notification rendered on an administrator dashboard, or a notification transmitted to an external compliance infrastructure system comprising a security information and event management (SIEM) platform or a security orchestration, automation, and response (SOAR) system. The escalate to administrator operation 1116 includes the application identifier of the web application, the identifier of the altered interface element, the second compliance state produced at the re-interpret operation 1106, and a description of the corrective modification that failed to transition the altered interface element to the compliant state, so that the administrator is informed of the verification failure and of the specific altered interface element for which the verification failed. The verification failure alert 1114 and, in some embodiments, the escalate to administrator operation 1116 are further recorded in the tamper-evident audit record 1112 associated with the corrective modification.

The post-correction verification process 1100 closes the compliance loop on each corrective modification by re-invoking the computer vision module and the semantic interpretation module on the rendered graphical user interface of the web application after the at least one simulated user interaction, so that compliance is determined from the actual altered state rendered by the web application rather than from an assumption that the at least one simulated user interaction produced the expected compliant configuration. In one embodiment, the post-correction verification process 1100 is performed for each corrective modification in a single monitoring cycle of a continuous monitoring loop. In a further embodiment, the post-correction verification process 1100 is repeated across successive monitoring cycles for each altered interface element across the plurality of web applications.

### Multi-Application Coordinated Pipeline

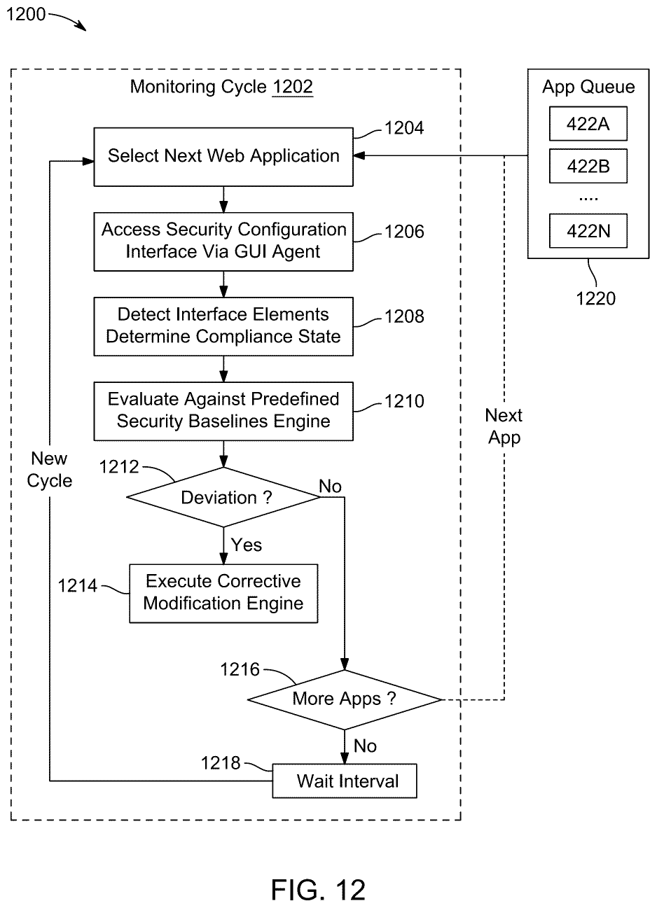

FIG. 12 illustrates a multi-application coordinated pipeline 1200. The multi-application coordinated pipeline 1200 orchestrates security configuration drift detection and remediation across a plurality of web applications 422 within a single monitoring cycle, and periodically repeats the orchestration across the plurality of web applications 422 without manual initiation of each monitoring cycle. The multi-application coordinated pipeline 1200 operates across an enterprise web application estate comprising a first web application 422A, a second web application 422B, and additional web applications through an Nth web application 422N of the plurality of web applications 422. The multi-application coordinated pipeline 1200 is implemented as one or more software processes executing on one or more computing devices.

The multi-application coordinated pipeline 1200 operates within a monitoring cycle 1202. The monitoring cycle 1202 refers to a single end-to-end pass of the multi-application coordinated pipeline 1200 across the plurality of web applications 422. The monitoring cycle 1202 comprises selection of each web application of the plurality of web applications 422 from an application queue 1220, execution of an inner loop of security configuration drift detection and remediation operations for the selected web application, and iteration to a next web application of the plurality of web applications 422 until each web application has been processed during the monitoring cycle 1202. The monitoring cycle 1202 terminates with a wait interval 1218, after which a new monitoring cycle 1202 is initiated. The application queue 1220 comprises an ordered set of application identifiers corresponding to the first web application 422A, the second web application 422B, and additional web applications through the Nth web application 422N. In one embodiment, the application queue 1220 is pre-populated from an enterprise application inventory. In a further embodiment, the application queue 1220 is dynamically updated based on an addition of a new web application to the plurality of web applications 422 or based on a removal of a web application from the plurality of web applications 422.

The multi-application coordinated pipeline 1200 begins at a select next web application operation 1204. At the select next web application operation 1204, a web application is selected from the application queue 1220 for processing during the monitoring cycle 1202. The web application selected at the select next web application operation 1204 is one of the first web application 422A, the second web application 422B, or a further web application of the plurality of web applications 422 through the Nth web application 422N. For example, during a first iteration of the monitoring cycle 1202, the select next web application operation 1204 selects the first web application 422A, and during a second iteration, the select next web application operation 1204 selects the second web application 422B. In one embodiment, the select next web application operation 1204 further retrieves one or more predefined security baselines specific to the web application, the one or more predefined security baselines being associated with an application type of the web application, the application type including, without limitation, a cloud productivity suite, a customer relationship management (CRM) platform, a video conferencing application, a collaboration platform, a human capital management platform, or an identity and access management (IAM) portal.

The multi-application coordinated pipeline 1200 proceeds from the select next web application operation 1204 to an access security configuration interface via GUI agent operation 1206. At the access security configuration interface via GUI agent operation 1206, a graphical user interface agent accesses a security configuration interface of the selected web application through the rendered graphical user interface of the web application. The graphical user interface agent authenticates to the web application using an administrator credential, navigates to an administrative section of the web application, and causes the web application to render the security configuration interface. In some embodiments, the access security configuration interface via GUI agent operation 1206 is performed through the rendered graphical user interface of the web application without invoking an application programming interface (API) of the web application and without requiring a structured configuration data export from the web application.

The multi-application coordinated pipeline 1200 proceeds from the access security configuration interface via GUI agent operation 1206 to a detect interface elements and determine compliance state operation 1208. The detect interface elements and determine compliance state operation 1208 combines detection of interface elements and determination of a first compliance state for each detected interface element. At the detect interface elements and determine compliance state operation 1208, a computer vision module detects a plurality of interface elements from a rendered display of the security configuration interface, each detected interface element being associated with a respective security configuration setting of the web application and comprising one of a toggle, a dropdown menu, a radio button, a slider, a checkbox, or a status indicator. In one embodiment, an interface element associated with a respective security configuration setting is alternatively referred to as a security-relevant interface element. The computer vision module further determines a current visual state of each detected interface element, the current visual state indicating whether the detected interface element reflects an enabled or a disabled security configuration state. A semantic interpretation module then determines, for each detected interface element, a first compliance state by applying a language model to on-screen textual content associated with the detected interface element. The first compliance state indicates whether the detected interface element is compliant or non-compliant with the one or more predefined security baselines specific to the web application retrieved at the select next web application operation 1204. In one embodiment, the first compliance state comprises a binary indicator of compliance or non-compliance and is paired with a security policy classification identifying a security control category governed by the detected interface element.

The multi-application coordinated pipeline 1200 proceeds from the detect interface elements and determine compliance state operation 1208 to an evaluate against predefined security baselines operation 1210. At the evaluate against predefined security baselines operation 1210, a policy evaluation engine evaluates the first compliance state determined for each detected interface element against the one or more predefined security baselines specific to the web application and identifies one or more configuration deviations in the web application. Each configuration deviation identified at the evaluate against predefined security baselines operation 1210 is associated with a respective non-compliant interface element whose first compliance state does not satisfy the one or more predefined security baselines specific to the web application.

The multi-application coordinated pipeline 1200 proceeds from the evaluate against predefined security baselines operation 1210 to a deviation decision 1212. At the deviation decision 1212, a determination is made as to whether a configuration deviation has been detected for the selected web application. If no configuration deviation is detected at the deviation decision 1212, the multi-application coordinated pipeline 1200 proceeds along a first branch of the deviation decision 1212 to a more apps decision 1216, bypassing corrective modification for the selected web application. If at least one configuration deviation is detected at the deviation decision 1212, the multi-application coordinated pipeline 1200 proceeds along a second branch of the deviation decision 1212 to an execute corrective modification engine operation 1214.

At the execute corrective modification engine operation 1214, a remediation engine alters, through the graphical user interface, a configuration state of a non-compliant interface element associated with the configuration deviation by generating at least one simulated user interaction with the non-compliant interface element. The at least one simulated user interaction comprises at least one of a simulated mouse click, a simulated keyboard input, or a simulated control selection on the non-compliant interface element, and is dispatched to the rendering pipeline of the web application as a user-facing input event. The execute corrective modification engine operation 1214 is followed by a post-correction verification performed on the altered interface element by re-invoking the computer vision module and the semantic interpretation module, and a tamper-evident audit record for the configuration deviation and the at least one corrective modification is generated by a compliance logging module.

The multi-application coordinated pipeline 1200 proceeds from the execute corrective modification engine operation 1214, or along the first branch of the deviation decision 1212 if no configuration deviation was detected, to the more apps decision 1216. At the more apps decision 1216, a determination is made as to whether a further web application of the plurality of web applications 422 remains in the application queue 1220 to be processed during the monitoring cycle 1202. If at least one further web application remains in the application queue 1220, the multi-application coordinated pipeline 1200 proceeds along a first branch of the more apps decision 1216 to the select next web application operation 1204. If no further web application remains in the application queue 1220, the multi-application coordinated pipeline 1200 proceeds along a second branch of the more apps decision 1216 to the wait interval 1218.

At the wait interval 1218, the multi-application coordinated pipeline 1200 pauses for a predetermined duration before initiating a new monitoring cycle 1202. The predetermined duration of the wait interval 1218 is configured based on a monitoring cadence associated with the plurality of web applications 422 and is expressed in hours, days, or weeks. For example, the wait interval 1218 is a predetermined duration of twenty-four hours, such that a new monitoring cycle 1202 is initiated daily. In a further example, the wait interval 1218 is a predetermined duration of one week, such that a new monitoring cycle 1202 is initiated weekly. In one embodiment, the wait interval 1218 is configured differently for different subsets of the plurality of web applications 422, such that a first subset of the plurality of web applications 422 is processed at a higher monitoring cadence than a second subset. In a further embodiment, the wait interval 1218 is overridden by an event-driven trigger including, without limitation, detection of an organizational change, a user access event, or a security incident, such that a new monitoring cycle 1202 is initiated immediately upon receipt of the event-driven trigger regardless of the predetermined duration of the wait interval 1218.

Following the wait interval 1218, the multi-application coordinated pipeline 1200 initiates a new monitoring cycle 1202 by returning to the select next web application operation 1204 and re-processing the plurality of web applications 422 from the beginning of the application queue 1220. The return from the wait interval 1218 to the select next web application operation 1204 forms an outer loop of the multi-application coordinated pipeline 1200 that periodically repeats the monitoring cycle 1202 across the plurality of web applications 422 without manual initiation of each monitoring cycle 1202. In one embodiment, the multi-application coordinated pipeline 1200 is executed sequentially across the plurality of web applications 422, each web application being processed in turn before the next web application is selected. In a further embodiment, multiple instances of the multi-application coordinated pipeline 1200 are scheduled across different subsets of the plurality of web applications 422.

### Tamper-Evident Audit Record System

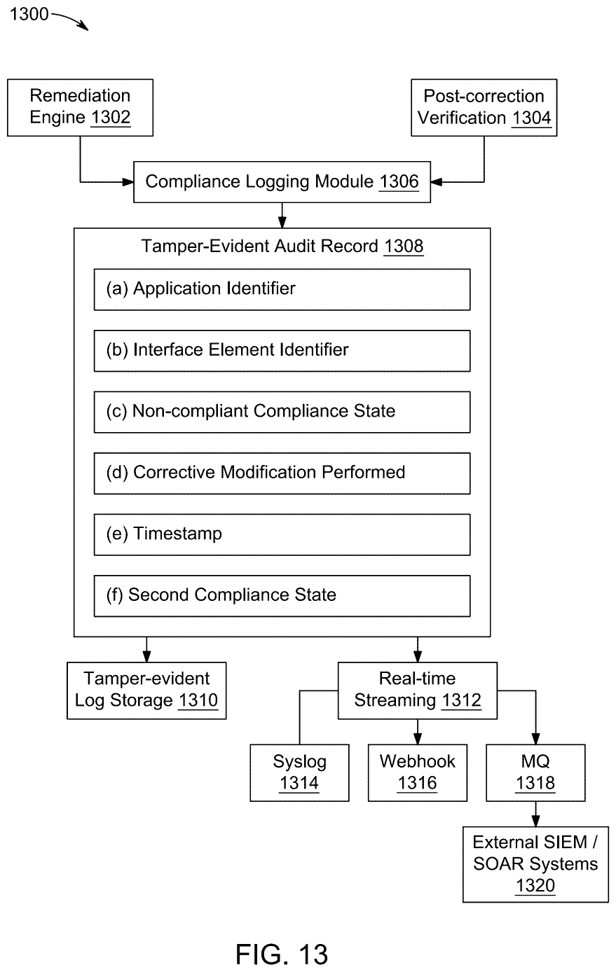

FIG. 13 illustrates a tamper-evident audit record system 1300 implemented by a compliance logging module 1306. The tamper-evident audit record system 1300 depicts a structure of a tamper-evident audit record 1308 generated by the compliance logging module 1306 for each configuration deviation identified for an interface element of a web application of a plurality of web applications and for each corresponding corrective modification executed on the interface element. The tamper-evident audit record system 1300 also depicts a downstream storage and transmission pipeline by which the tamper-evident audit record 1308 is preserved in a tamper-resistant audit trail and transmitted in real time to an external compliance infrastructure system 1320. In one embodiment, the external compliance infrastructure system 1320 is alternatively referred to as one or more external SIEM/SOAR systems. The tamper-evident audit record system 1300 is implemented as one or more software processes executing on a computing device communicatively coupled to a remediation engine 1302, post-correction verification 1304, and a tamper-resistant data store, and is further communicatively coupled to the external compliance infrastructure system 1320 through a network.

The tamper-evident audit record system 1300 receives input from the remediation engine 1302 and the post-correction verification 1304. The remediation engine 1302 provides, for each corrective modification executed by the remediation engine 1302 on an altered interface element, an identifier of the altered interface element, an identifier of the web application containing the altered interface element, a simulated user interaction by which the corrective modification was executed, and a timestamp of the corrective modification. In one embodiment, the remediation engine 1302 further provides a description of the corrective modification performed. The post-correction verification 1304 provides, for each altered interface element, a second compliance state of the altered interface element produced by re-application of a language model to on-screen textual content associated with the altered interface element as rendered after the corrective modification, the on-screen textual content as rendered after the corrective modification being produced by the respective web application in response to the simulated user interaction.

The remediation engine 1302 and the post-correction verification 1304 are each communicatively coupled to the compliance logging module 1306. The compliance logging module 1306 generates, in response to inputs received from the remediation engine 1302 and the post-correction verification 1304, the tamper-evident audit record 1308. The compliance logging module 1306 assembles the tamper-evident audit record 1308 by combining the identifier of the altered interface element, the identifier of the web application, the simulated user interaction, and the timestamp received from the remediation engine 1302 with the second compliance state received from the post-correction verification 1304 and with the first compliance state detected before the corrective modification, so that the tamper-evident audit record 1308 captures both the pre-modification compliance state and the post-correction verification outcome.

The tamper-evident audit record 1308 comprises a plurality of fields. A first field of the tamper-evident audit record 1308 is an application identifier (a). The application identifier (a) identifies the respective web application of the plurality of web applications in which the interface element was detected and uniquely distinguishes the web application from other web applications of the plurality of web applications. For example, the application identifier (a) identifies a cloud productivity suite as the respective web application in which a toggle governing external file sharing was detected. In a further example, the application identifier (a) identifies a customer relationship management (CRM) platform as the respective web application in which a checkbox governing multi-factor authentication was detected.

A second field of the tamper-evident audit record 1308 is an interface element identifier (b). The interface element identifier (b) identifies the altered interface element within the rendered graphical user interface of the respective web application identified by the application identifier (a). In one embodiment, the altered interface element was non-compliant before the corrective modification. The interface element identifier (b) includes, without limitation, a configuration label of the altered interface element, a positional descriptor of the altered interface element on the rendered graphical user interface, a control type identifier of the altered interface element, or any combination of the foregoing. For example, the interface element identifier (b) comprises the configuration label “Allow users to share files externally” together with a positional descriptor identifying a data sharing settings page of the cloud productivity suite. In a further example, the interface element identifier (b) comprises the configuration label “Require multi-factor authentication for all users” together with a control type identifier identifying the altered interface element as a checkbox.

A third field of the tamper-evident audit record 1308 is a first compliance state (c). In one embodiment, the first compliance state (c) is a non-compliant compliance state because the first compliance state (c) represents the configuration deviation that triggered the corrective modification. The first compliance state (c) comprises the first compliance state of the interface element as detected before the corrective modification and, in one embodiment, includes a binary indicator of compliance or non-compliance with one or more predefined security baselines paired with a security policy classification identifying a security control category governed by the interface element. For example, the first compliance state (c) records a non-compliant binary indicator together with a security control category of data sharing and privacy settings for a toggle governing external file sharing in an enabled state. In a further example, the first compliance state (c) records a non-compliant binary indicator together with a security control category of authentication and access control settings for a checkbox governing multi-factor authentication in an unchecked state.

A fourth field of the tamper-evident audit record 1308 is a simulated user interaction (d). In one embodiment, the simulated user interaction (d) is further described as a corrective modification performed. The simulated user interaction (d) records the simulated user interaction executed by the remediation engine 1302 on the interface element and identifies the simulated user interaction as one of a simulated mouse click, a simulated keyboard input, or a simulated control selection on the interface element. For example, the simulated user interaction (d) records a simulated click dispatched to a toggle governing external file sharing to transition the toggle from an enabled state to a disabled state. In a further example, the simulated user interaction (d) records a simulated click dispatched to a checkbox governing multi-factor authentication to transition the checkbox from an unchecked state to a checked state. In one embodiment, the field (d) further includes a description of the corrective modification performed.

A fifth field of the tamper-evident audit record 1308 is a timestamp (e). The timestamp (e) records a time at which the corrective modification was executed and is recorded with a granularity sufficient to support sequencing of multiple corrective modifications applied across the plurality of web applications within a single monitoring cycle and across successive monitoring cycles. For example, the timestamp (e) is recorded in coordinated universal time (UTC) with millisecond granularity. In a further embodiment, the timestamp (e) is recorded as a monotonically increasing sequence number assigned in addition to wall-clock time, so that ordering of the tamper-evident audit records 1308 is preserved even in the presence of clock skew.

A sixth field of the tamper-evident audit record 1308 is a second compliance state (f). The second compliance state (f) comprises the second compliance state of the altered interface element produced by the post-correction verification 1304 after the corrective modification and indicates whether the corrective modification transitioned the altered interface element to a compliant state matching an expected compliant configuration defined by the one or more predefined security baselines. The second compliance state (f) includes, in one embodiment, a binary indicator of compliance or non-compliance of the altered interface element with the one or more predefined security baselines. For example, the second compliance state (f) records a compliant binary indicator for an altered toggle governing external file sharing after a simulated click successfully transitioned the toggle to a disabled state. In a further example, the second compliance state (f) records a non-compliant binary indicator for an altered checkbox governing multi-factor authentication when a simulated click failed to transition the checkbox to a checked state, in which event a verification failure alert is generated and the remediation engine 1302 initiates a retry of the corrective modification or escalates the verification failure alert to an administrator.

The tamper-evident audit record 1308, comprising the application identifier (a), the interface element identifier (b), the first compliance state (c), the simulated user interaction (d), the timestamp (e), and the second compliance state (f), is transmitted by the compliance logging module 1306 to a tamper-evident log storage 1310 and to a real-time streaming 1312. The tamper-evident log storage 1310 comprises a tamper-resistant data store configured to persist the tamper-evident audit record 1308 in an audit trail for regulatory compliance and administrative oversight. In one embodiment, the tamper-evident log storage 1310 is implemented as an append-only data store that does not permit modification or deletion of previously written tamper-evident audit records 1308. In a further embodiment, the tamper-evident log storage 1310 is implemented as a cryptographically chained data store, wherein each tamper-evident audit record 1308 includes a cryptographic hash of a preceding tamper-evident audit record 1308, so that any modification of a previously stored tamper-evident audit record 1308 is detectable by re-computation of the cryptographic hash chain. In yet a further embodiment, the tamper-evident log storage 1310 is implemented as a write-once read-many storage medium or as a distributed ledger.

The real-time streaming 1312 comprises a transmission pipeline by which the compliance logging module 1306 transmits the tamper-evident audit record 1308 in real time to the external compliance infrastructure system 1320, in parallel with persistence to the tamper-evident log storage 1310. The real-time streaming 1312 transmits the tamper-evident audit record 1308 via at least one of Syslog 1314, Webhook 1316, or a message queue (MQ) 1318. The Syslog 1314 comprises a Syslog protocol transmission of the tamper-evident audit record 1308 to a Syslog endpoint of the external compliance infrastructure system 1320 and is implemented in accordance with a Syslog standard such as Internet Engineering Task Force RFC 5424. The Webhook 1316 comprises a hypertext transfer protocol (HTTP) webhook transmission of the tamper-evident audit record 1308 to an HTTP endpoint, wherein the tamper-evident audit record 1308 is encoded as a JavaScript Object Notation (JSON) payload transmitted in an HTTP POST request. The message queue 1318 comprises a message queuing protocol transmission of the tamper-evident audit record 1308 to a message queue endpoint and is implemented in accordance with a message queuing protocol comprising Apache Kafka, Advanced Message Queuing Protocol (AMQP), or an equivalent message queuing protocol.

The external compliance infrastructure system 1320 comprises at least one of a security information and event management (SIEM) platform or a security orchestration, automation, and response (SOAR) system. In one embodiment, the external compliance infrastructure system 1320 includes, for example, Splunk, IBM QRadar, and Microsoft Sentinel. The real-time streaming 1312 enables drift detection events and corresponding remediation actions to be received by the external compliance infrastructure system 1320 as the drift detection events and the corresponding remediation actions are generated, without manual export, and facilitates downstream automated policy enforcement and incident response workflows. In one embodiment, the tamper-evident audit record 1308 is generated regardless of whether the corrective modification was executed through a programmatic interface or through the rendered graphical user interface of the respective web application, so that the tamper-evident audit record 1308 captures remediation actions executed along either path in a uniform record format. In a further embodiment, the tamper-evident audit record 1308 is generated for each retry of the corrective modification initiated in response to a verification failure alert, so that successive retry attempts and their respective post-correction verification outcomes are individually recorded.

### Dynamic Interface Adaptation System

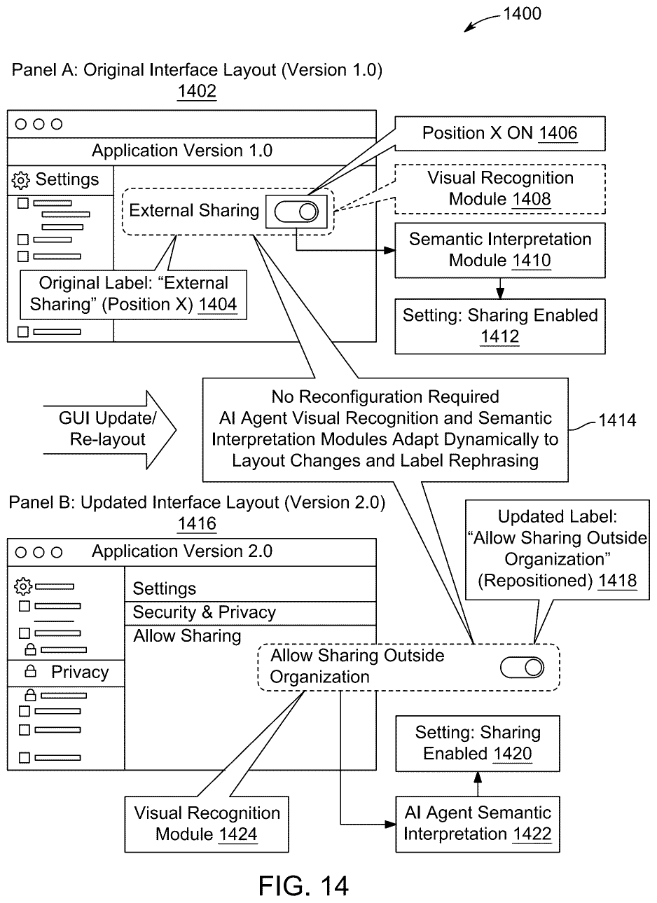

FIG. 14 illustrates a dynamic interface adaptation system 1400. The dynamic interface adaptation system 1400 depicts operation of an artificial intelligence agent across two successive version updates of a security configuration interface of a web application, wherein an interface element associated with a respective security configuration setting of the web application is repositioned and a label associated with the interface element is rephrased between a first version of the security configuration interface and a second version of the security configuration interface. In one embodiment, the interface element associated with the respective security configuration setting is alternatively referred to as a security-relevant interface element. The dynamic interface adaptation system 1400 demonstrates that the artificial intelligence agent continues to detect the interface element, interpret on-screen textual content associated with the interface element, and determine a consistent setting state for the interface element across the two successive version updates without reconfiguration. In one embodiment, the consistent setting state is used to determine a consistent first compliance state relative to one or more predefined security baselines.

The dynamic interface adaptation system 1400 is illustrated through a Panel A 1402 representing the security configuration interface in Version 1.0 of the web application and a Panel B 1416 representing the security configuration interface in Version 2.0 of the web application. The Panel A 1402 and the Panel B 1416 represent successive rendered displays produced by the rendering pipeline of the web application across the two version updates. A graphical user interface update or re-layout occurs between the Panel A 1402 and the Panel B 1416, including, without limitation, repositioning of one or more interface elements rendered on the security configuration interface, modification of one or more labels associated with the interface elements, an updated interface layout including reorganization of section groupings, or a redesigned configuration page structure including changes to a navigation hierarchy of the security configuration interface. A note 1414 indicates that no reconfiguration is required and that visual recognition and semantic interpretation adapt dynamically to layout changes and label rephrasing across the update from the Panel A 1402 to the Panel B 1416.

The Panel A 1402 includes an interface element associated with a respective security configuration setting, rendered as a toggle on the security configuration interface together with an original label 1404 reading “External Sharing.” The original label 1404 is rendered at a first spatial position on the rendered graphical user interface of the security configuration interface in the Version 1.0. A box 1406 indicates that the toggle is rendered at position X and in an ON state in the Version 1.0. The ON state of the toggle reflects that an external sharing setting of the web application is enabled in the Version 1.0.

In the Version 1.0, a visual recognition module 1408 of the artificial intelligence agent detects the toggle from the rendered display of the Panel A 1402. The visual recognition module 1408 identifies the toggle at the first spatial position on the rendered display, identifies the original label 1404 rendered adjacent to the toggle, and determines the current visual state of the toggle as ON as indicated by the box 1406. A semantic interpretation module 1410 of the artificial intelligence agent receives the detected toggle and the original label 1404 from the visual recognition module 1408 and applies a language model to on-screen textual content associated with the toggle. The on-screen textual content comprises the original label 1404 together with descriptive text rendered in proximity to the toggle, a tooltip rendered on hover or focus of the toggle, and a section heading under which the toggle is rendered in the Panel A 1402. The semantic interpretation module 1410 produces, for the toggle, a security policy classification identifying a security control category of data sharing and privacy settings governed by the toggle and determines a setting state indicating that sharing is enabled. The setting state in the Version 1.0 is represented by a setting indicator 1412 reading “Setting: Sharing Enabled.” In one embodiment, where a predefined security baseline specifies that sharing is to be disabled, the setting state represented by the setting indicator 1412 corresponds to a first compliance state indicating non-compliance.

The Panel B 1416 represents the security configuration interface in the Version 2.0 of the web application after the graphical user interface update or re-layout. The Panel B 1416 includes the interface element rendered as the same toggle on the security configuration interface, but with a modified label and a modified spatial position relative to the Panel A 1402. The modified label in the Version 2.0 is an updated label 1418 reading “Allow Sharing Outside Organization,” and the toggle associated with the updated label 1418 is rendered at a repositioned spatial position on the rendered graphical user interface of the security configuration interface in the Version 2.0, the repositioned spatial position being different from the first spatial position associated with the original label 1404 in the Version 1.0.

In the Version 2.0, a visual recognition module 1424 of the artificial intelligence agent detects the toggle from the rendered display of the Panel B 1416. The visual recognition module 1424 identifies the toggle at the repositioned spatial position on the rendered display and identifies the updated label 1418 rendered adjacent to the toggle. The visual recognition module 1424 detects the toggle in the Version 2.0 without reliance on a pre-stored coordinate of the first spatial position in the Version 1.0 and without a pre-configured mapping of the original label 1404 to the toggle, by applying a computer vision model to identify the toggle on the rendered display of the Panel B 1416 based on visual presentation of the toggle and spatial proximity between the toggle and the updated label 1418.

An AI agent semantic interpretation 1422 of the artificial intelligence agent receives the detected toggle and the updated label 1418 from the visual recognition module 1424 and applies the language model to on-screen textual content associated with the toggle in the Panel B 1416. The on-screen textual content associated with the toggle in the Panel B 1416 comprises the updated label 1418 together with descriptive text rendered in proximity to the toggle, a tooltip rendered on hover or focus of the toggle, and a section heading under which the toggle is rendered in the Panel B 1416. The section heading in the Panel B 1416 may differ from the section heading in the Panel A 1402 due to the graphical user interface update or re-layout. The AI agent semantic interpretation 1422 produces, for the toggle in the Version 2.0, the same security policy classification identifying the security control category of data sharing and privacy settings governed by the toggle and determines the same setting state indicating that sharing is enabled. The setting state in the Version 2.0 is represented by a setting indicator 1420 reading “Setting: Sharing Enabled,” consistent with the setting indicator 1412 produced for the toggle in the Version 1.0. In one embodiment, where a predefined security baseline specifies that sharing is to be disabled, the setting state represented by the setting indicator 1420 corresponds to the same first compliance state as in the Version 1.0.

The dynamic interface adaptation system 1400 demonstrates that the artificial intelligence agent produces a consistent security policy classification and a consistent setting interpretation for the interface element across the two successive version updates, despite repositioning of the toggle and rephrasing of the label from the original label 1404 to the updated label 1418. In one embodiment, the consistent setting interpretation supports determination of a consistent first compliance state for the interface element across the two successive version updates. The consistency is achieved because the visual recognition module 1408 and the visual recognition module 1424 each apply the same computer vision model to identify the toggle based on visual presentation on the respective rendered display, and because the semantic interpretation module 1410 and the AI agent semantic interpretation 1422 each apply the same language model to interpret the meaning of the toggle from the on-screen textual content associated with the toggle on the respective rendered display, regardless of the specific wording of the label or the specific spatial position of the toggle. As indicated by the note 1414, no reconfiguration is required to handle the update from the Version 1.0 to the Version 2.0, and the artificial intelligence agent continues to operate on the security configuration interface across the two version updates.

In one embodiment, the dynamic interface adaptation system 1400 accommodates a plurality of further graphical user interface updates or re-layouts of the security configuration interface across a plurality of further version updates of the web application, including, without limitation, a redesigned configuration page structure that relocates the toggle to a different configuration page within the security configuration interface, an updated section heading under which the toggle is rendered, or a modified visual style of the toggle that retains the toggle's role as an interface element associated with a respective security configuration setting but renders the toggle with a different visual presentation. In each such embodiment, the visual recognition module 1408 or the visual recognition module 1424 detects the toggle on the respective rendered display based on visual presentation of the toggle, and the semantic interpretation module 1410 or the AI agent semantic interpretation 1422 interprets the meaning of the toggle from the on-screen textual content associated with the toggle, so that the artificial intelligence agent continues to determine a consistent security policy classification and, in one embodiment, a consistent first compliance state for the toggle across the plurality of further version updates without reconfiguration for any of the plurality of further version updates.

### Drift Alert Generation and Severity Classification System

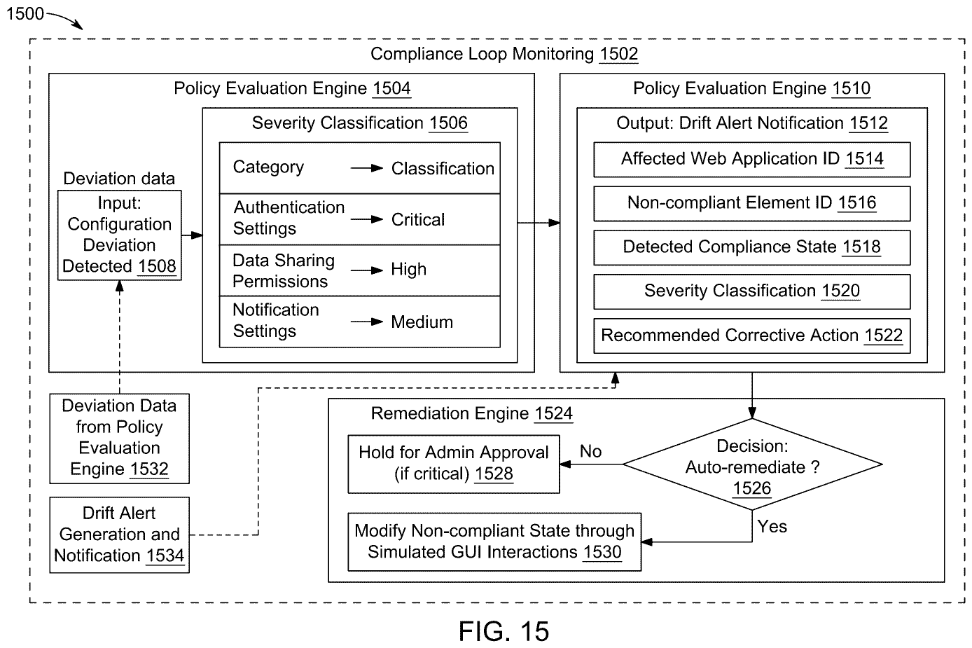

FIG. 15 illustrates a drift alert generation and severity classification system 1500. The drift alert generation and severity classification system 1500 classifies a configuration deviation by severity, generates a drift alert notification 1512 populated with a plurality of fields characterizing the configuration deviation, and routes the drift alert notification 1512 to a remediation engine 1524 for an auto-remediation decision. The drift alert generation and severity classification system 1500 enables differentiation among configuration deviations of varying severity, automated remediation of configuration deviations of lower severity without administrator intervention, and, in some embodiments, administrator approval for configuration deviations of higher severity.

The drift alert generation and severity classification system 1500 operates within a compliance loop monitoring 1502. During the compliance loop monitoring 1502, one or more configuration deviations are detected in a plurality of web applications for each monitoring cycle, each configuration deviation being associated with a respective non-compliant interface element whose first compliance state does not satisfy one or more predefined security baselines.

The drift alert generation and severity classification system 1500 receives, at an input 1508, a configuration deviation detected during the compliance loop monitoring 1502. The configuration deviation received at the input 1508 identifies a non-compliant interface element of a web application, an application identifier of the web application, a first compliance state of the non-compliant interface element, and a security policy classification identifying a security control category governed by the non-compliant interface element. The configuration deviation received at the input 1508 is provided as deviation data 1532 to a policy evaluation engine 1504.

The policy evaluation engine 1504 processes the deviation data 1532 to classify the configuration deviation by severity. The policy evaluation engine 1504 assigns a severity classification to the configuration deviation based on the security control category identified in the security policy classification of the non-compliant interface element. The policy evaluation engine 1504 references a severity classification table 1506 to determine the severity classification associated with the security control category. The severity classification table 1506 maps each of a plurality of security control categories to a respective severity classification, the severity classification representing a level of risk associated with non-compliance of an interface element governing a security configuration setting in the security control category.

In one embodiment, the severity classification table 1506 maps an authentication settings category to a severity classification of “Critical,” a data sharing permissions category to a severity classification of “High,” and a notification settings category to a severity classification of “Medium.” The severity classification of “Critical” is assigned to security control categories whose non-compliance materially exposes an organization to identity-based attack vectors. The severity classification of “High” is assigned to security control categories whose non-compliance materially exposes the organization to data-exfiltration risks. The severity classification of “Medium” is assigned to security control categories whose non-compliance reduces the organization's ability to monitor or respond to security events but does not directly expose the organization to attack. In a further embodiment, the severity classification table 1506 includes additional security control categories and corresponding severity classifications, including, without limitation, a third-party application integration permissions category mapped to “High,” a user role and privilege configurations category mapped to “Critical,” and a session management category mapped to “Medium.” The severity classification table 1506 is maintained in a data store accessible to the policy evaluation engine 1504 and is configurable by an administrator to reflect organizational risk tolerances and regulatory requirements applicable to the plurality of web applications.

For example, the policy evaluation engine 1504 receives, as the deviation data 1532, a configuration deviation identifying a non-compliant checkbox governing multi-factor authentication in a customer relationship management (CRM) platform together with a security control category of authentication settings, and the policy evaluation engine 1504 assigns a severity classification of “Critical” to the configuration deviation by reference to the severity classification table 1506. In a further example, the policy evaluation engine 1504 receives a configuration deviation identifying a non-compliant toggle governing external file sharing in a cloud productivity suite together with a security control category of data sharing permissions, and the policy evaluation engine 1504 assigns a severity classification of “High” to the configuration deviation. In yet a further example, the policy evaluation engine 1504 receives a configuration deviation identifying a non-compliant dropdown menu governing a notification frequency in a collaboration platform together with a security control category of notification settings, and the policy evaluation engine 1504 assigns a severity classification of “Medium” to the configuration deviation.

The drift alert generation and severity classification system 1500 proceeds to a drift alert generation and notification 1534, wherein a policy evaluation engine 1510 generates the drift alert notification 1512 populated with the severity classification assigned by the policy evaluation engine 1504. In one embodiment, the policy evaluation engine 1510 represents a downstream notification-generation stage of the operations performed by the policy evaluation engine 1504. The policy evaluation engine 1510 assembles the drift alert notification 1512 by combining the configuration deviation, the severity classification, and a recommended corrective action determined by the policy evaluation engine 1510 based on the configuration deviation and on the one or more predefined security baselines.

The drift alert notification 1512 comprises a plurality of fields characterizing the configuration deviation. A first field of the drift alert notification 1512 is an affected web application ID 1514. The affected web application ID 1514 identifies the respective web application in which the non-compliant interface element was detected and is populated by the policy evaluation engine 1510 from the application identifier received in the deviation data 1532. For example, the affected web application ID 1514 identifies a CRM platform as the respective web application in which a non-compliant checkbox governing multi-factor authentication was detected. In a further example, the affected web application ID 1514 identifies a cloud productivity suite as the respective web application in which a non-compliant toggle governing external file sharing was detected.

A second field of the drift alert notification 1512 is an interface element identifier 1516. The interface element identifier 1516 identifies the non-compliant interface element associated with the configuration deviation within the rendered graphical user interface of the respective web application identified by the affected web application ID 1514. The interface element identifier 1516 includes, without limitation, a configuration label of the non-compliant interface element, a positional descriptor of the non-compliant interface element on the rendered graphical user interface, a control type identifier of the non-compliant interface element, or any combination of the foregoing. For example, the interface element identifier 1516 comprises the configuration label “Require multi-factor authentication for all users” together with a control type identifier identifying the non-compliant interface element as a checkbox. In a further example, the interface element identifier 1516 comprises the configuration label “Allow users to share files externally” together with a control type identifier identifying the non-compliant interface element as a toggle.

A third field of the drift alert notification 1512 is a first compliance state 1518. The first compliance state 1518 comprises the first compliance state of the non-compliant interface element as detected prior to any corrective modification, and includes a binary indicator of non-compliance of the non-compliant interface element with the one or more predefined security baselines. For example, the first compliance state 1518 records a non-compliant binary indicator and a current visual state of an unchecked state for a checkbox governing multi-factor authentication. In a further example, the first compliance state 1518 records a non-compliant binary indicator and a current visual state of an enabled state for a toggle governing external file sharing.

A fourth field of the drift alert notification 1512 is a severity classification 1520. The severity classification 1520 records the severity classification assigned to the configuration deviation by the policy evaluation engine 1504 based on the severity classification table 1506. The severity classification 1520 comprises one of “Critical,” “High,” “Medium,” or any further severity level defined in the severity classification table 1506, and corresponds to a level of risk associated with non-compliance of the non-compliant interface element identified by the interface element identifier 1516. For example, the severity classification 1520 records “Critical” for a configuration deviation involving a non-compliant checkbox governing multi-factor authentication. In a further example, the severity classification 1520 records “High” for a configuration deviation involving a non-compliant toggle governing external file sharing.

A fifth field of the drift alert notification 1512 is a recommended corrective action 1522. The recommended corrective action 1522 records a corrective action determined by the policy evaluation engine 1510 to transition the non-compliant interface element to a compliant state matching an expected compliant configuration defined by the one or more predefined security baselines for the non-compliant interface element. The recommended corrective action 1522 comprises a description of at least one simulated user interaction to be generated by the remediation engine 1524 to alter the non-compliant interface element through the rendered graphical user interface of the respective web application, the at least one simulated user interaction being one of a simulated mouse click, a simulated keyboard input, or a simulated control selection on the non-compliant interface element. For example, the recommended corrective action 1522 records a description of a simulated click to be dispatched to a non-compliant checkbox governing multi-factor authentication to transition the non-compliant checkbox from an unchecked state to a checked state. In a further example, the recommended corrective action 1522 records a description of a simulated click to be dispatched to a non-compliant toggle governing external file sharing to transition the non-compliant toggle from an enabled state to a disabled state.

The drift alert notification 1512, comprising the affected web application ID 1514, the interface element identifier 1516, the first compliance state 1518, the severity classification 1520, and the recommended corrective action 1522, is transmitted by the policy evaluation engine 1510 to the remediation engine 1524. The remediation engine 1524 determines, based on the drift alert notification 1512, whether the configuration deviation is to be auto-remediated or held for administrator approval prior to remediation.

The remediation engine 1524 evaluates the drift alert notification 1512 at a decision 1526, wherein a determination is made as to whether the configuration deviation is to be auto-remediated. At the decision 1526, the remediation engine 1524 references an auto-remediation policy associated with the severity classification 1520 of the drift alert notification 1512. The auto-remediation policy specifies, for each severity classification of the severity classification table 1506, whether configuration deviations assigned that severity classification are eligible for automated remediation by the remediation engine 1524 without administrator approval, or whether configuration deviations assigned that severity classification are to be held for administrator approval prior to remediation. In one embodiment, the auto-remediation policy permits automated remediation for configuration deviations assigned a severity classification of “Medium” and requires administrator approval for configuration deviations assigned a severity classification of “Critical” or “High.” In a further embodiment, the auto-remediation policy permits automated remediation for configuration deviations assigned any severity classification subject to a rate limit on a number of corrective modifications executed without administrator approval within a predetermined period.

If, at the decision 1526, the configuration deviation is determined not to be eligible for automated remediation, the drift alert generation and severity classification system 1500 proceeds along a first branch of the decision 1526 to a hold for admin approval 1528. At the hold for admin approval 1528, the remediation engine 1524 places the drift alert notification 1512 in a queue of pending administrator approvals and transmits the drift alert notification 1512 to an administrator through an administrator notification channel. The administrator notification channel includes, without limitation, an electronic mail notification, a text message notification, a notification rendered on an administrator dashboard, or a notification transmitted to an external compliance infrastructure system. The remediation engine 1524 awaits an administrator decision on the drift alert notification 1512 at the hold for admin approval 1528. Upon receipt of administrator approval, the remediation engine 1524 proceeds to execute the recommended corrective action 1522. Upon receipt of administrator rejection, the remediation engine 1524 records the administrator rejection together with the drift alert notification 1512 and does not execute the recommended corrective action 1522.

If, at the decision 1526, the configuration deviation is determined to be eligible for automated remediation, the drift alert generation and severity classification system 1500 proceeds along a second branch of the decision 1526 to a modify non-compliant state through simulated GUI interactions 1530. At the modify non-compliant state through simulated GUI interactions 1530, the remediation engine 1524 alters a configuration state of the non-compliant interface element by generating at least one simulated user interaction with the non-compliant interface element through the rendered graphical user interface of the respective web application identified by the affected web application ID 1514. The at least one simulated user interaction comprises at least one of a simulated mouse click, a simulated keyboard input, or a simulated control selection on the non-compliant interface element, and is dispatched to a rendering pipeline of the respective web application as a user-facing input event.

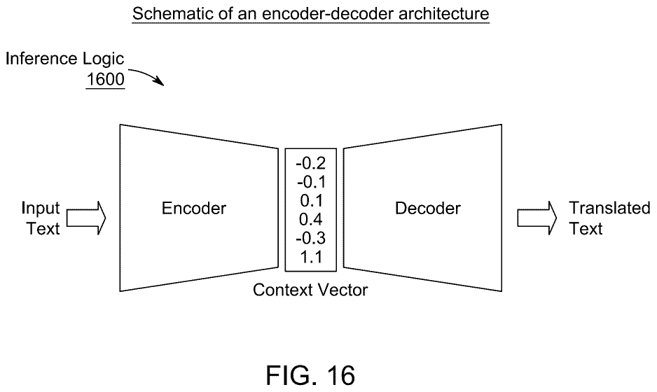

Having described the closed-loop visual compliance architecture with reference to FIG. 4 through FIG. 15, the present disclosure turns to the underlying artificial intelligence components that implement the computer vision module and the language model of the foregoing figures. FIG. 16 through FIG. 25 describe inference logic and neural network architectures by which the computer vision module detects interface elements from rendered displays of graphical user interfaces and by which the language model determines a first compliance state and a security policy classification from on-screen textual content. The architectures described with reference to FIG. 16 through FIG. 25, depicting inference logic 1600, are illustrative examples of trained models that may be employed to implement the computer vision module and the language model, and are not intended to limit the scope of the invention to any particular neural network architecture or training methodology.

### Artificial Intelligence System Implementation

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 16 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t-1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t-1, and the output generated at time step, t-1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using RNNs in an encoder-decoder architecture.

### Attention Mechanism

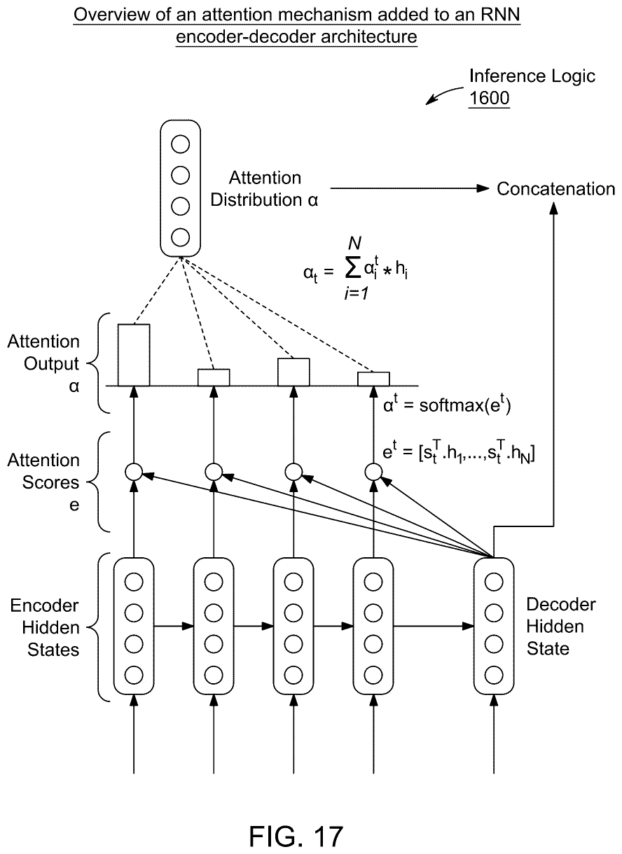

Attention mechanisms distinguish Transformers from other machine learning models. The attention mechanism provides a solution for the vanishing gradient problem. FIG. 17 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

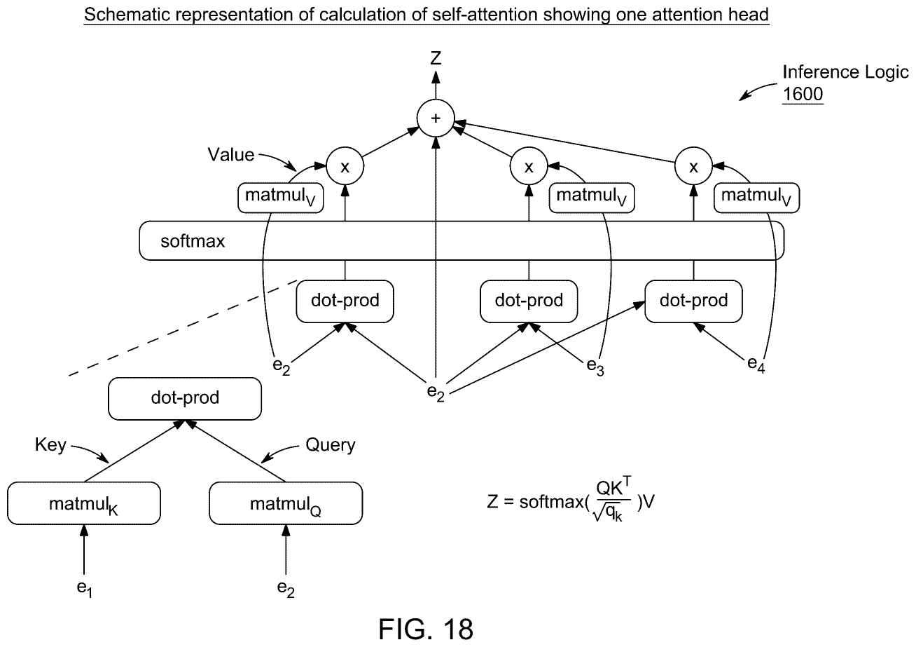

Multi-headed attention is executed in the Transformer. FIG. 18 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

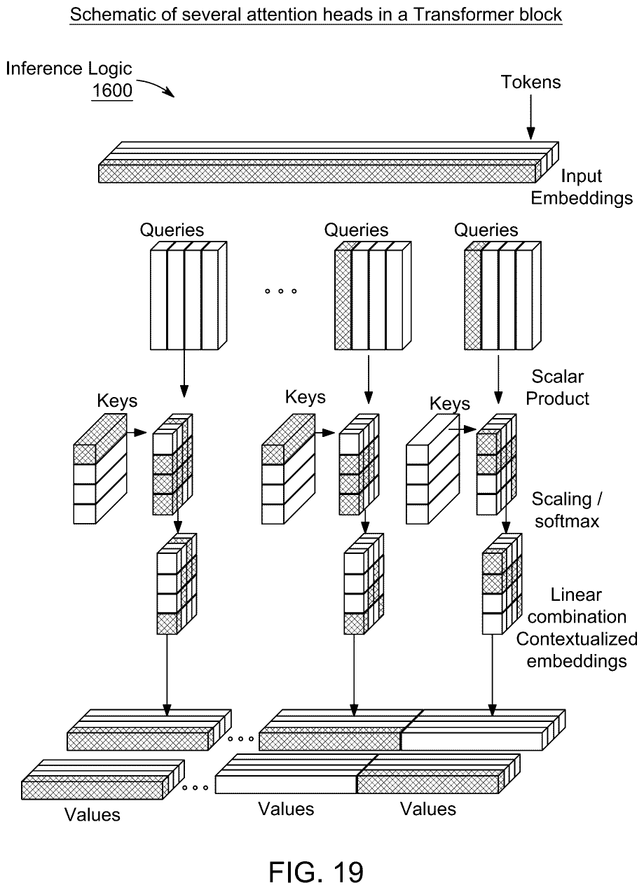

FIG. 19 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and dis the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

X·W_{Q},X·W_{K},X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

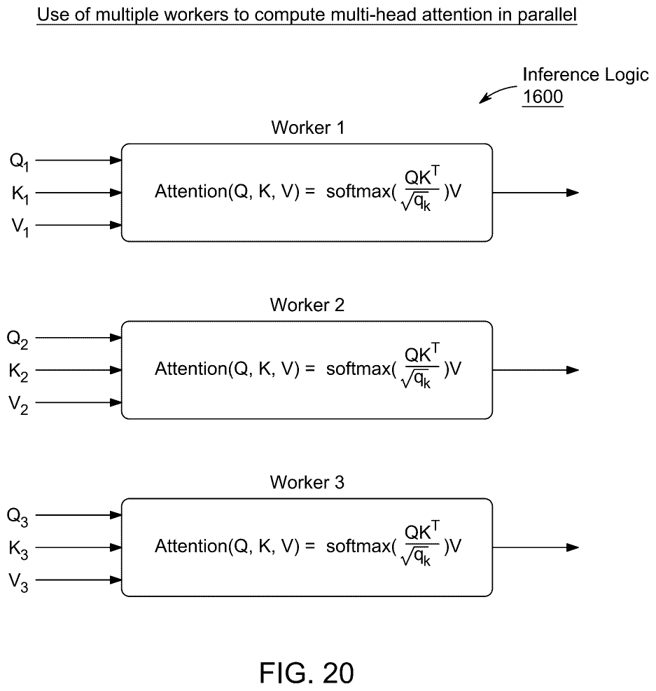

As shown in FIG. 20, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·W_{V}

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$SoftMax ( \frac{{QK}^{T}}{\sqrt{dk}} ) .$$

V is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

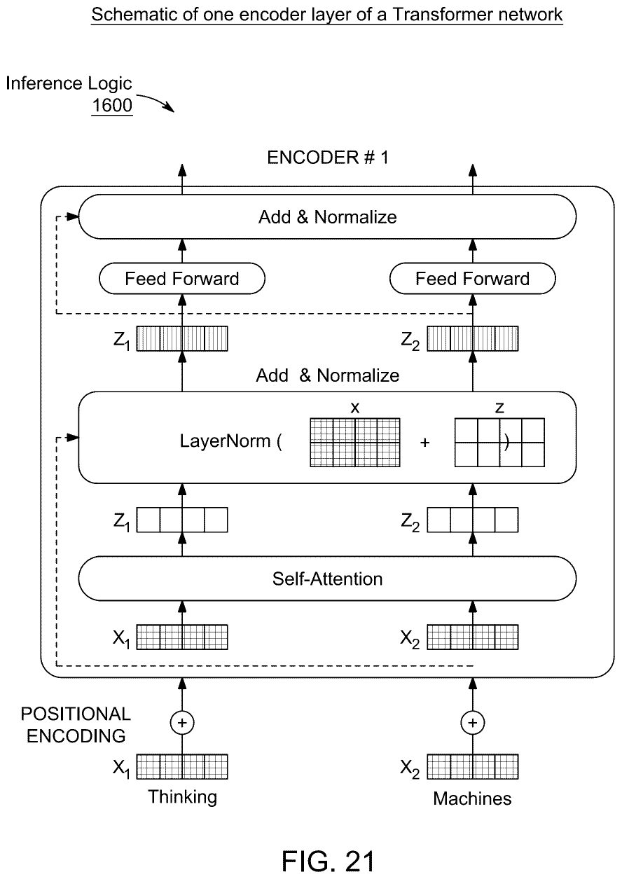

FIG. 21 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

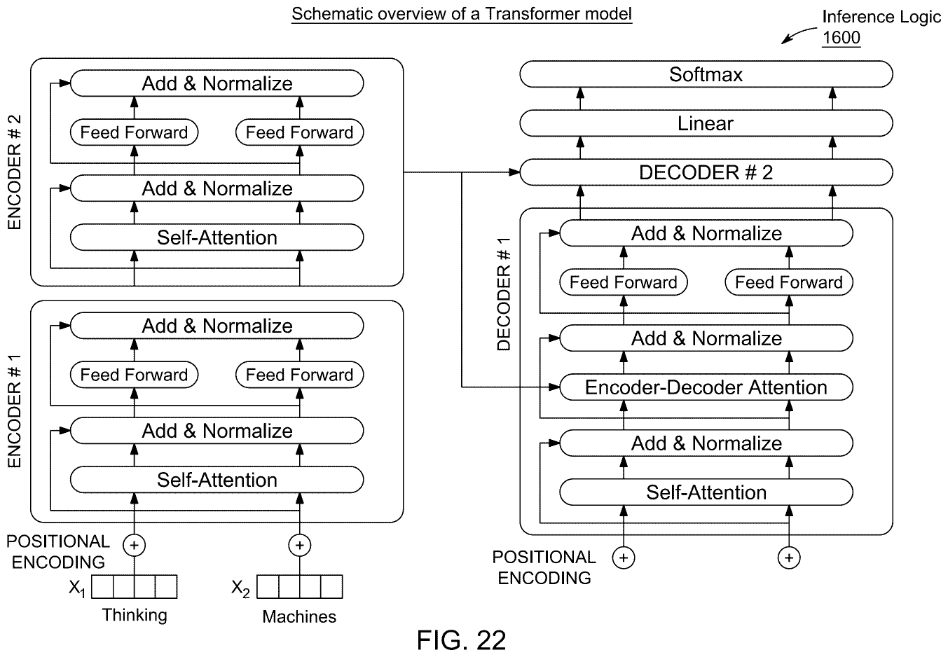

FIG. 22 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

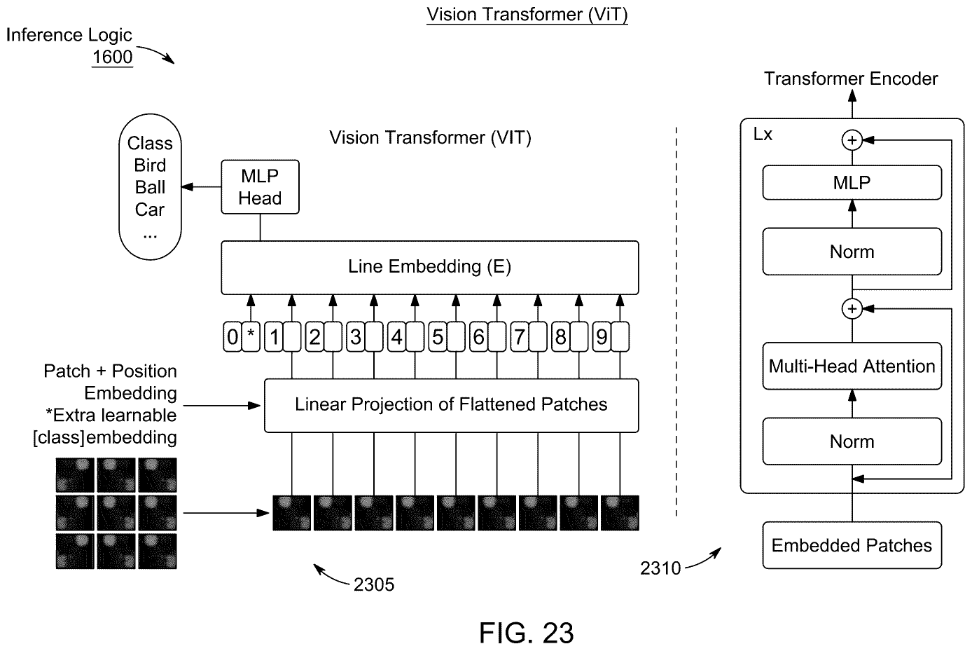

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 23 (2305, 2310), 24 (2405, 2410, 2415, and 2420). Unfortunately, important positional information is lost because image sets are position-invariant. This problem is solved by adding a learned positional encoding into the image patches.

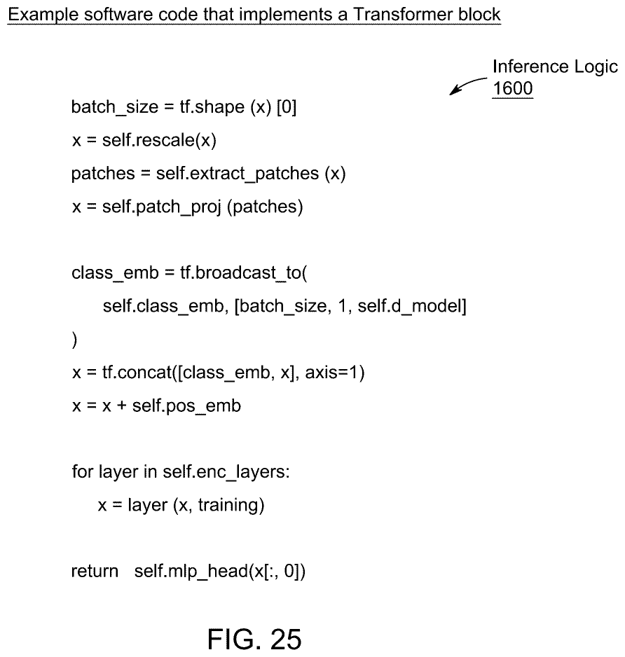

The computations of the ViT architecture can be summarized as follows. The first layer of a ViT extracts a fixed number of patches from an input image (2405). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 25.

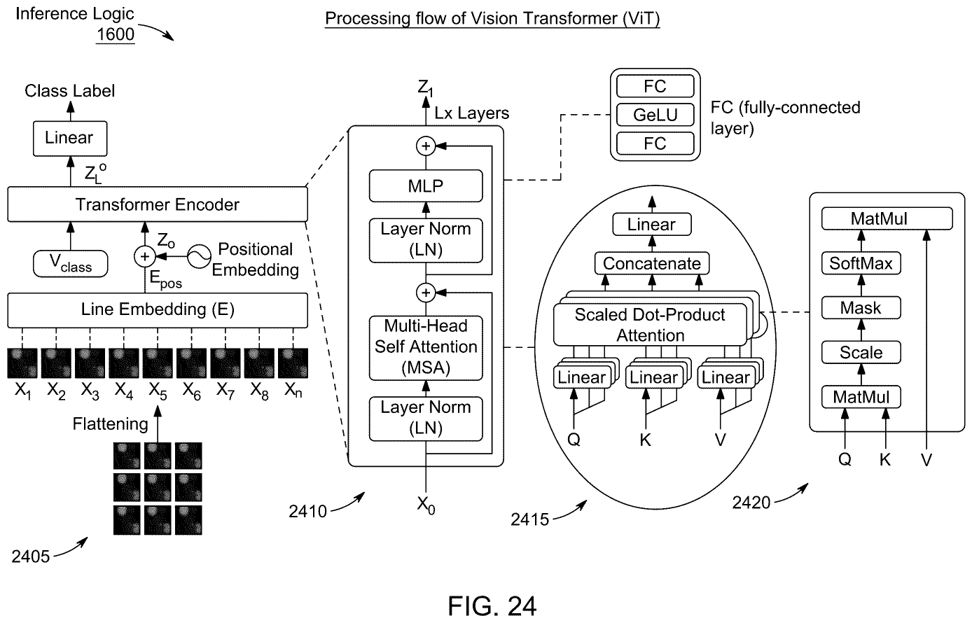

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block in FIG. 24 as 2410, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### Computer System

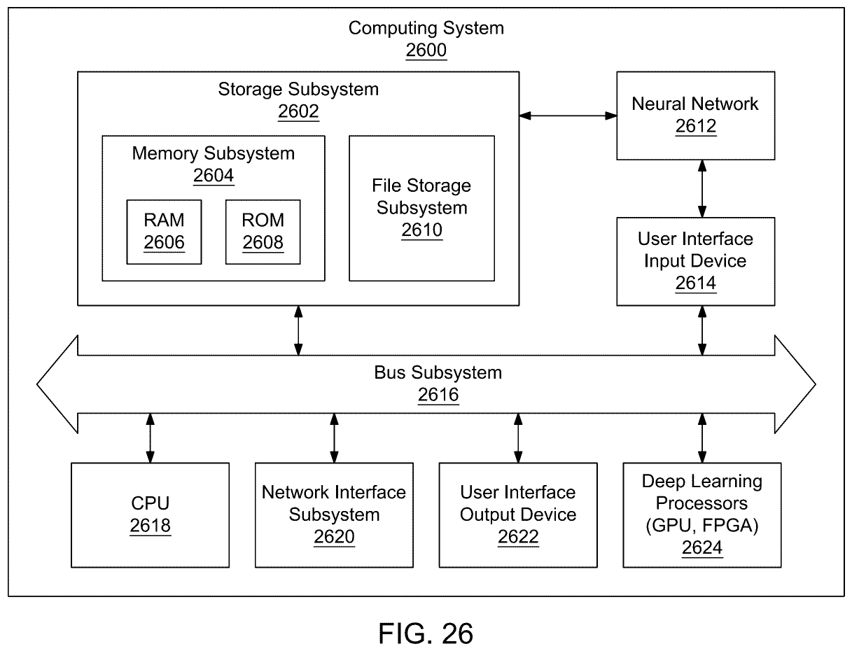

FIG. 26 shows an example computer system 2600 that can be used to implement the technology disclosed. The computer system 2600 is a representation of the system, as described in FIG. 4. The computer system 2600 includes at least one central processing unit (CPU) 2618 that communicates with a number of peripheral devices via bus subsystem 2616. These peripheral devices can include a storage subsystem 2602 including, for example, memory devices and a file storage subsystem 2610, user interface input devices 2614, user interface output devices 2622, and a network interface subsystem 2620. The input and output devices allow user interaction with computer system 2600. Network interface subsystem 2620 provides an interface to outside networks, including an interface to corresponding interface devices in other computer systems.

In one implementation, a neural network 2612 is communicably linked to the storage subsystem 2602 and the user interface input devices 2614.

User interface input devices 2614 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2600.

User interface output devices 2622 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2600 to the user or to another machine or computer system.

Storage subsystem 2602 stores programming and data constructs that provide the functionality of some or all of the modules and methods described herein. These software modules are generally executed by deep learning processors 2624.

Deep learning processors 2624 can be graphics processing units (GPUs), field-programmable gate arrays (FPGAs), application-specific integrated circuits (ASICs), and/or coarse-grained reconfigurable architectures (CGRAs). Processors 2624 can be hosted by a deep learning cloud platform such as Google Cloud Platform™, Xilinx™, and Cirrascale™ Examples of processors 2624 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 2604 used in the storage subsystem 2602 can include a number of memories including a main random-access memory (RAM) 2606 for storage of instructions and data during program execution and a read only memory (ROM) 2608 in which fixed instructions are stored. A file storage subsystem 2610 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2610 in the storage subsystem 2602, or in other machines accessible by the processor.

Bus subsystem 2616 provides a mechanism for letting the various components and subsystems of computer system 2600 communicate with each other as intended. Although bus subsystem 2616 is shown schematically as a single bus, alternative implementations of the bus subsystem can use multiple buses.

Computer system 2600 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 2600 depicted in FIG. 26 is intended only as a specific example for the purpose of illustrating the preferred implementations of the present technology disclosed. Many other configurations of computer system 2600 are possible having more or fewer components than the computer system depicted in FIG. 26.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 26, computer system/server in computing node is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

### CLAUSES

1. A system for monitoring and remediating security configuration drift in web-based applications, the system comprising at least one processor and at least one storage device coupled to the at least one processor and storing instructions that, when executed by the at least one processor, cause the system to:
   cause an interface agent to access security configuration interfaces of one or more web-based applications through rendered displays of graphical user interfaces of the one or more web-based applications;
   cause a visual recognition module to identify a plurality of security-relevant configuration controls from the rendered displays;
   cause a semantic interpretation module to determine, for each identified configuration control of the plurality of security-relevant configuration controls, a first compliance state by applying a trained model to on-screen textual content associated with the identified configuration control;
   cause a policy evaluation engine to compare the first compliance state of each identified configuration control against predefined security governance criteria to identify one or more configuration deviations; and
   cause a remediation engine to execute at least one corrective modification to a non-compliant configuration control associated with each of the one or more configuration deviations through the rendered display of the graphical user interface of the respective web-based application.
2. The system of clause 1, wherein the interface agent accesses and interacts with the security configuration interfaces exclusively through the rendered displays of the graphical user interfaces, without invoking any application-specific application programming interface, structured configuration data export, or system log file of the one or more web-based applications.
3. The system of clause 1, wherein the visual recognition module identifies the plurality of security-relevant configuration controls comprising at least one of toggles, dropdown menus, radio buttons, sliders, checkboxes, or status indicators, and classifies each identified configuration control based on visual presentation of the identified configuration control to determine whether the identified configuration control reflects an enabled or a disabled security configuration state.
4. The system of clause 1, wherein the semantic interpretation module applies the trained model to on-screen text, adjacent labels, tooltips, and contextual section headings associated with each identified configuration control to generate, for each identified configuration control:
   a security policy classification identifying a security control category governed by the identified configuration control; and
   the first compliance state of the identified configuration control as compliant or non-compliant relative to the predefined security governance criteria.
5. The system of clause 1, wherein:
   the predefined security governance criteria specify expected security configuration values for a plurality of web-based application types including at least one of authentication settings, data sharing permissions, third-party integration controls, notification settings, or user access privilege levels; and
   the policy evaluation engine generates a per-element deviation report identifying each identified configuration control whose first compliance state differs from the corresponding expected security configuration value.
6. The system of clause 1, wherein the at least one corrective modification executed by the remediation engine comprises at least one simulated user interaction generated through the rendered display of the graphical user interface of the respective web-based application, the at least one simulated user interaction comprising at least one of: a simulated mouse click on the non-compliant configuration control;
   a simulated keyboard input to the non-compliant configuration control; or a simulated control selection on the non-compliant configuration control.
7. The system of clause 6, wherein the at least one simulated user interaction is dispatched as a user-facing input event to the rendering pipeline of the respective web-based application, and the respective web-based application updates an internal configuration store of the respective web-based application and re-renders the non-compliant configuration control in an altered displayed state in response to the at least one simulated user interaction.
8. The system of clause 1, wherein the visual recognition module and the semantic interpretation module discriminate between security-relevant configuration controls and non-security interface content rendered on the security configuration interfaces, and the semantic interpretation module excludes the non-security interface content from the determination of the first compliance state.
9. The system of clause 1, wherein the visual recognition module and the semantic interpretation module collectively adapt to changes in the rendered displays of the graphical user interfaces of the one or more web-based applications across successive version updates of the one or more web-based applications, including at least one of:
   repositioned configuration controls;
   modified labels of configuration controls; or
   updated interface layouts;
   without reconfiguration of the system for any of the successive version updates.
10. The system of clause 1, wherein the instructions further cause the system to, after the remediation engine executes the at least one corrective modification:
   cause the visual recognition module and the semantic interpretation module to be re-invoked on the rendered display of the graphical user interface of the respective web-based application as rendered after the at least one corrective modification; and
   determine a second compliance state of the altered non-compliant configuration control by re-applying the trained model to on-screen textual content associated with the altered non-compliant configuration control as rendered after the at least one corrective modification.
11. The system of clause 10, wherein the policy evaluation engine:
   compares the second compliance state against an expected compliant configuration defined by the predefined security governance criteria;
   produces a verification output indicating whether the altered non-compliant configuration control matches the expected compliant configuration; and
   generates a verification failure alert when the second compliance state indicates that the altered non-compliant configuration control does not match the expected compliant configuration.
12. The system of clause 1, further comprising a compliance logging module configured to generate a tamper-evident audit record for each configuration deviation and each at least one corresponding corrective modification, the tamper-evident audit record comprising: an application identifier of the respective web-based application;
   a configuration control identifier of the non-compliant configuration control;
   the first compliance state of the non-compliant configuration control prior to the at least one corrective modification;
   a description of the at least one corrective modification;
   a timestamp of the at least one corrective modification; and
   a result status of the at least one corrective modification.
13. The system of clause 1, wherein the instructions further cause the system to operate in a continuous monitoring loop that periodically accesses the security configuration interfaces of the one or more web-based applications and triggers the interface agent, the visual recognition module, the semantic interpretation module, the policy evaluation engine, and the remediation engine in sequence for each periodic access without manual initiation of each periodic access.
14. The system of clause 1, wherein the remediation engine selects, upon identification of each of the one or more configuration deviations, between:
   a programmatic interface path selected when the respective web-based application exposes an application programming interface for the security configuration setting governed by the non-compliant configuration control; and
   a graphical user interface path selected when the respective web-based application does not expose an application programming interface for the security configuration setting governed by the non-compliant configuration control.
15. A computer-implemented method comprising:
   accessing, by an interface agent, security configuration interfaces of one or more web-based applications through rendered displays of graphical user interfaces of the one or more web-based applications;
   identifying, by a visual recognition module, a plurality of security-relevant configuration controls from the rendered displays;
   determining, by a semantic interpretation module, for each identified configuration control of the plurality of security-relevant configuration controls, a first compliance state by applying a trained model to on-screen textual content associated with the identified configuration control;
   comparing, by a policy evaluation engine, the first compliance state of each identified configuration control against predefined security governance criteria to identify one or more configuration deviations; and
   executing, by a remediation engine, at least one corrective modification to a non-compliant configuration control associated with each of the one or more configuration deviations through the rendered display of the graphical user interface of the respective web-based application.
16. The method of clause 15, further comprising:
   periodically repeating the accessing, the identifying, the determining, the comparing, and the executing for the one or more web-based applications without manual initiation of each periodic repetition; and
   generating a tamper-evident audit record for each configuration deviation and each at least one corresponding corrective modification, the tamper-evident audit record comprising an application identifier of the respective web-based application, a configuration control identifier of the non-compliant configuration control, the first compliance state of the non-compliant configuration control prior to the at least one corrective modification, a description of the at least one corrective modification, a timestamp of the at least one corrective modification, and a result status of the at least one corrective modification.
17. A non-transitory computer-readable medium storing instructions that, when executed by at least one processor, cause the at least one processor to perform operations comprising:
   accessing, through an interface agent, security configuration interfaces of one or more web-based applications through rendered displays of graphical user interfaces of the one or more web-based applications;
   identifying, through a visual recognition module, a plurality of security-relevant configuration controls from the rendered displays;
   determining, through a semantic interpretation module, for each identified configuration control of the plurality of security-relevant configuration controls, a first compliance state by applying a trained model to on-screen textual content associated with the identified configuration control;
   comparing the first compliance state of each identified configuration control against predefined security governance criteria to identify one or more configuration deviations; and
   executing at least one corrective modification to a non-compliant configuration control associated with each of the one or more configuration deviations through the rendered display of the graphical user interface of the respective web-based application.
18. A system for monitoring and remediating security configuration drift in web-based applications, the system comprising at least one processor and at least one storage device coupled to the at least one processor and storing instructions that, when executed by the at least one processor, cause the system to:
   cause a graphical user interface agent to autonomously access security configuration interfaces of a plurality of web-based applications through rendered graphical user interfaces of the plurality of web-based applications, without reliance on application-specific application programming interfaces of the plurality of web-based applications;
   cause a computer vision module to detect, from rendered displays of the rendered graphical user interfaces, a plurality of interface elements associated with respective security configuration settings of the plurality of web-based applications, and to determine a current visual state of each detected interface element;
   cause a semantic interpretation module comprising a language model to determine, for each detected interface element, a security policy classification identifying a security control category governed by the detected interface element and a first compliance state of the detected interface element by applying the language model to on-screen textual content associated with the detected interface element, the on-screen textual content being visible on the rendered graphical user interface at a time of the determining;
   cause a policy evaluation engine to evaluate the first compliance state of each detected interface element against one or more predefined security baselines to identify one or more configuration deviations; and
   cause a remediation engine to execute at least one corrective modification to a non-compliant interface element associated with each of the one or more configuration deviations by generating at least one simulated graphical user interface interaction with the non-compliant interface element through the rendered graphical user interface of the respective web-based application.
19. The system of clause 18, wherein:
   the on-screen textual content to which the language model is applied comprises a label of the detected interface element, descriptive text rendered in proximity to the detected interface element, a tooltip rendered on hover or on focus of the detected interface element, and a section heading under which the detected interface element is rendered; and
   the language model produces, for each detected interface element, a structured representation comprising the security policy classification and a binary indicator of compliance or non-compliance of the detected interface element with the one or more predefined security baselines.
20. The system of clause 18, wherein the instructions further cause the system to, after the remediation engine executes the at least one corrective modification:
   re-invoke the computer vision module and the semantic interpretation module on the rendered graphical user interface of the respective web-based application as rendered after the at least one simulated graphical user interface interaction;
   determine a second compliance state of the altered non-compliant interface element by re-applying the language model to on-screen textual content associated with the altered non-compliant interface element as rendered after the at least one simulated graphical user interface interaction, the on-screen textual content as rendered after the at least one simulated graphical user interface interaction being produced by the respective web-based application in response to the at least one simulated graphical user interface interaction; and
   confirm based on the second compliance state that the altered non-compliant interface element matches an expected compliant configuration defined by the one or more predefined security baselines.
21. The system of clause 18, wherein:
   the at least one simulated graphical user interface interaction comprises at least one of a simulated mouse click, a simulated keyboard input, or a simulated control selection on the non-compliant interface element; and
   the at least one simulated graphical user interface interaction is dispatched to a rendering pipeline of the respective web-based application as a user-facing input event such that the respective web-based application updates an internal configuration store of the respective web-based application and re-renders the non-compliant interface element in an altered displayed state in response to the at least one simulated graphical user interface interaction.
22. The system of clause 18, wherein:
   each detected interface element comprises one of a toggle, a dropdown menu, a radio button, a slider, a checkbox, or a status indicator; and
   the computer vision module determines the current visual state of each detected interface element based on at least one of spatial position, color profile, rendering pattern, or visual indicators of the detected interface element.
23. A computer-implemented method comprising:
   autonomously accessing, by a graphical user interface agent, security configuration interfaces of a plurality of web-based applications through rendered graphical user interfaces of the plurality of web-based applications, without reliance on application-specific application programming interfaces of the plurality of web-based applications;
   detecting, by a computer vision module from rendered displays of the rendered graphical user interfaces, a plurality of interface elements associated with respective security configuration settings of the plurality of web-based applications, and determining a current visual state of each detected interface element;
   determining, by a semantic interpretation module comprising a language model, for each detected interface element, a security policy classification identifying a security control category governed by the detected interface element and a first compliance state of the detected interface element by applying the language model to on-screen textual content associated with the detected interface element, the on-screen textual content being visible on the rendered graphical user interface at a time of the determining;
   evaluating, by a policy evaluation engine, the first compliance state of each detected interface element against one or more predefined security baselines to identify one or more configuration deviations; and
   executing, by a remediation engine, at least one corrective modification to a non-compliant interface element associated with each of the one or more configuration deviations by generating at least one simulated graphical user interface interaction with the non-compliant interface element through the rendered graphical user interface of the respective web-based application.
24. The method of clause 23, further comprising, after the executing:
   re-invoking the computer vision module and the semantic interpretation module on the rendered graphical user interface of the respective web-based application as rendered after the at least one simulated graphical user interface interaction;
   determining a second compliance state of the altered non-compliant interface element by re-applying the language model to on-screen textual content associated with the altered non-compliant interface element as rendered after the at least one simulated graphical user interface interaction, the on-screen textual content as rendered after the at least one simulated graphical user interface interaction being produced by the respective web-based application in response to the at least one simulated graphical user interface interaction; and
   confirming based on the second compliance state that the altered non-compliant interface element matches an expected compliant configuration defined by the one or more predefined security baselines.
25. A non-transitory computer-readable medium storing instructions that, when executed by at least one processor, cause the at least one processor to perform operations comprising:
   autonomously accessing, through a graphical user interface agent, security configuration interfaces of a plurality of web-based applications through rendered graphical user interfaces of the plurality of web-based applications, without reliance on application-specific application programming interfaces of the plurality of web-based applications;
   detecting, through a computer vision module from rendered displays of the rendered graphical user interfaces, a plurality of interface elements associated with respective security configuration settings of the plurality of web-based applications, and determining a current visual state of each detected interface element;
   determining, through a semantic interpretation module comprising a language model, for each detected interface element, a security policy classification identifying a security control category governed by the detected interface element and a first compliance state of the detected interface element by applying the language model to on-screen textual content associated with the detected interface element, the on-screen textual content being visible on the rendered graphical user interface at a time of the determining;
   evaluating the first compliance state of each detected interface element against one or more predefined security baselines to identify one or more configuration deviations; and
   executing at least one corrective modification to a non-compliant interface element associated with each of the one or more configuration deviations by generating at least one simulated graphical user interface interaction with the non-compliant interface element through the rendered graphical user interface of the respective web-based application.
26. A system for autonomous detection and closed-loop remediation of security configuration drift across a plurality of web-based applications, the system comprising at least one processor and at least one storage device coupled to the at least one processor and storing instructions that, when executed by the at least one processor, cause the system to:
   cause a graphical user interface agent to autonomously navigate to security configuration interfaces of the plurality of web-based applications through rendered graphical user interfaces of the plurality of web-based applications, without invoking any application programming interface of the plurality of web-based applications and without requiring any structured configuration data export from the plurality of web-based applications;
   cause a computer vision module to detect, from rendered displays of the rendered graphical user interfaces, a plurality of interface elements associated with respective security configuration settings of the plurality of web-based applications, the plurality of interface elements comprising at least one of toggles, dropdown menus, radio buttons, sliders, checkboxes, or status indicators, and to determine a current visual state of each detected interface element including whether the detected interface element reflects an enabled or a disabled security configuration state;
   cause a semantic interpretation module comprising a language model to determine, for each detected interface element, a structured representation comprising a security policy classification identifying a security control category governed by the detected interface element and a binary indicator of compliance or non-compliance of the detected interface element with one or more predefined security governance policies, by applying the language model to on-screen textual content associated with the detected interface element, the on-screen textual content comprising:
      a label of the detected interface element;
      descriptive text rendered in proximity to the detected interface element;
      a tooltip rendered on hover or on focus of the detected interface element; and
      a section heading under which the detected interface element is rendered;
   the on-screen textual content being visible on the rendered graphical user interface at a time of the determining, and the semantic interpretation module being further configured to discriminate between security-relevant interface elements and non-security interface content rendered on the security configuration interfaces such that the non-security interface content is excluded from the determining;
   cause a policy evaluation engine to evaluate the structured representation of each detected interface element against the one or more predefined security governance policies to identify one or more configuration deviations and to generate a per-element deviation report identifying each non-compliant interface element whose first compliance state differs from an expected compliant configuration defined by the one or more predefined security governance policies;
   cause a remediation engine to execute, for each non-compliant interface element identified in the per-element deviation report, at least one corrective modification to the non-compliant interface element through a three-step remediation sequence comprising:
      navigating the graphical user interface agent to a configuration page of the respective web-based application containing the non-compliant interface element;
      locating the non-compliant interface element on the configuration page using the computer vision module; and
      modifying a configuration state of the non-compliant interface element by generating at least one simulated user interaction with the non-compliant interface element comprising at least one of a simulated mouse click, a simulated keyboard input, or a simulated control selection, the at least one simulated user interaction being dispatched to a rendering pipeline of the respective web-based application as a user-facing input event;
   cause the computer vision module and the semantic interpretation module to be re-invoked on the rendered graphical user interface of the respective web-based application as rendered after the at least one simulated user interaction, to determine a second compliance state of the altered non-compliant interface element by re-applying the language model to on-screen textual content associated with the altered non-compliant interface element as rendered after the at least one simulated user interaction, the on-screen textual content as rendered after the at least one simulated user interaction being produced by the respective web-based application in response to the at least one simulated user interaction;
   cause the policy evaluation engine to confirm based on the second compliance state that the altered non-compliant interface element matches the expected compliant configuration defined by the one or more predefined security governance policies, and to generate a verification failure alert when the second compliance state indicates that the altered non-compliant interface element does not match the expected compliant configuration; and
   cause a compliance logging module to generate a tamper-evident audit record for each configuration deviation and each at least one corresponding corrective modification, the tamper-evident audit record comprising:
      an application identifier of the respective web-based application;
      an interface element identifier of the non-compliant interface element;
      the first compliance state of the non-compliant interface element prior to the at least one corrective modification;
      a description of the at least one corrective modification;
      a timestamp of the at least one corrective modification; and
      the second compliance state of the altered non-compliant interface element produced after the re-invoking.
27. The system of clause 26, wherein the one or more predefined security governance policies are derived from at least one of:
   Center for Internet Security (CIS) benchmark controls;
   National Institute of Standards and Technology (NIST) Special Publication 800-53 security control requirements;
   SOC 2 trust service criteria; or an organizational security policy defining an expected configuration state for each web-based application of the plurality of web-based applications.
28. The system of clause 26, wherein the compliance logging module transmits the tamper-evident audit record in real time to one or more external security information and event management (SIEM) and security orchestration, automation, and response (SOAR) systems via at least one of:
   Syslog;
   a hypertext transfer protocol (HTTP) webhook; or
   a message queuing protocol comprising Apache Kafka or Advanced Message Queuing Protocol (AMQP);
   the one or more external SIEM and SOAR systems comprising at least one of Splunk, IBM QRadar, or Microsoft Sentinel.
29. A computer-implemented method comprising:
   autonomously navigating, by a graphical user interface agent, to security configuration interfaces of a plurality of web-based applications through rendered graphical user interfaces of the plurality of web-based applications, without invoking any application programming interface of the plurality of web-based applications and without requiring any structured configuration data export from the plurality of web-based applications;
   detecting, by a computer vision module from rendered displays of the rendered graphical user interfaces, a plurality of interface elements associated with respective security configuration settings of the plurality of web-based applications, the plurality of interface elements comprising at least one of toggles, dropdown menus, radio buttons, sliders, checkboxes, or status indicators, and determining a current visual state of each detected interface element including whether the detected interface element reflects an enabled or a disabled security configuration state;
   determining, by a semantic interpretation module comprising a language model, for each detected interface element, a structured representation comprising a security policy classification identifying a security control category governed by the detected interface element and a binary indicator of compliance or non-compliance of the detected interface element with one or more predefined security governance policies, by applying the language model to on-screen textual content associated with the detected interface element, the on-screen textual content comprising:
      a label of the detected interface element;
      descriptive text rendered in proximity to the detected interface element;
      a tooltip rendered on hover or on focus of the detected interface element; and
      a section heading under which the detected interface element is rendered;
   the on-screen textual content being visible on the rendered graphical user interface at a time of the determining, and the method further comprising discriminating between security-relevant interface elements and non-security interface content rendered on the security configuration interfaces such that the non-security interface content is excluded from the determining;
   evaluating, by a policy evaluation engine, the structured representation of each detected interface element against the one or more predefined security governance policies to identify one or more configuration deviations and generating a per-element deviation report identifying each non-compliant interface element whose first compliance state differs from an expected compliant configuration defined by the one or more predefined security governance policies;
   executing, by a remediation engine for each non-compliant interface element identified in the per-element deviation report, at least one corrective modification to the non-compliant interface element through a three-step remediation sequence comprising:
      navigating the graphical user interface agent to a configuration page of the respective web-based application containing the non-compliant interface element;
      locating the non-compliant interface element on the configuration page using the computer vision module; and
      modifying a configuration state of the non-compliant interface element by generating at least one simulated user interaction with the non-compliant interface element comprising at least one of a simulated mouse click, a simulated keyboard input, or a simulated control selection, the at least one simulated user interaction being dispatched to a rendering pipeline of the respective web-based application as a user-facing input event;
   re-invoking the computer vision module and the semantic interpretation module on the rendered graphical user interface of the respective web-based application as rendered after the at least one simulated user interaction, determining a second compliance state of the altered non-compliant interface element by re-applying the language model to on-screen textual content associated with the altered non-compliant interface element as rendered after the at least one simulated user interaction, the on-screen textual content as rendered after the at least one simulated user interaction being produced by the respective web-based application in response to the at least one simulated user interaction;
   confirming, by the policy evaluation engine, based on the second compliance state that the altered non-compliant interface element matches the expected compliant configuration defined by the one or more predefined security governance policies, and generating a verification failure alert when the second compliance state indicates that the altered non-compliant interface element does not match the expected compliant configuration; and
   generating, by a compliance logging module, a tamper-evident audit record for each configuration deviation and each at least one corresponding corrective modification, the tamper-evident audit record comprising:
      an application identifier of the respective web-based application;
      an interface element identifier of the non-compliant interface element;
      the first compliance state of the non-compliant interface element prior to the at least one corrective modification;
      a description of the at least one corrective modification;
      a timestamp of the at least one corrective modification; and
      the second compliance state of the altered non-compliant interface element produced after the re-invoking.
30. A non-transitory computer-readable medium storing instructions that, when executed by at least one processor, cause the at least one processor to perform operations comprising:
   autonomously navigating, through a graphical user interface agent, to security configuration interfaces of a plurality of web-based applications through rendered graphical user interfaces of the plurality of web-based applications, without invoking any application programming interface of the plurality of web-based applications and without requiring any structured configuration data export from the plurality of web-based applications;
   detecting, through a computer vision module from rendered displays of the rendered graphical user interfaces, a plurality of interface elements associated with respective security configuration settings of the plurality of web-based applications, the plurality of interface elements comprising at least one of toggles, dropdown menus, radio buttons, sliders, checkboxes, or status indicators, and determining a current visual state of each detected interface element including whether the detected interface element reflects an enabled or a disabled security configuration state;
   determining, through a semantic interpretation module comprising a language model, for each detected interface element, a structured representation comprising a security policy classification identifying a security control category governed by the detected interface element and a binary indicator of compliance or non-compliance of the detected interface element with one or more predefined security governance policies, by applying the language model to on-screen textual content associated with the detected interface element, the on-screen textual content comprising:
      a label of the detected interface element;
      descriptive text rendered in proximity to the detected interface element;
      a tooltip rendered on hover or on focus of the detected interface element; and
      a section heading under which the detected interface element is rendered;
   the on-screen textual content being visible on the rendered graphical user interface at a time of the determining, and the operations further comprising discriminating between security-relevant interface elements and non-security interface content rendered on the security configuration interfaces such that the non-security interface content is excluded from the determining;
   evaluating the structured representation of each detected interface element against the one or more predefined security governance policies to identify one or more configuration deviations and generating a per-element deviation report identifying each non-compliant interface element whose first compliance state differs from an expected compliant configuration defined by the one or more predefined security governance policies;
   executing, for each non-compliant interface element identified in the per-element deviation report, at least one corrective modification to the non-compliant interface element through a three-step remediation sequence comprising:
      navigating the graphical user interface agent to a configuration page of the respective web-based application containing the non-compliant interface element;
      locating the non-compliant interface element on the configuration page using the computer vision module; and
      modifying a configuration state of the non-compliant interface element by generating at least one simulated user interaction with the non-compliant interface element comprising at least one of a simulated mouse click, a simulated keyboard input, or a simulated control selection, the at least one simulated user interaction being dispatched to a rendering pipeline of the respective web-based application as a user-facing input event;
   re-invoking the computer vision module and the semantic interpretation module on the rendered graphical user interface of the respective web-based application as rendered after the at least one simulated user interaction, determining a second compliance state of the altered non-compliant interface element by re-applying the language model to on-screen textual content associated with the altered non-compliant interface element as rendered after the at least one simulated user interaction, the on-screen textual content as rendered after the at least one simulated user interaction being produced by the respective web-based application in response to the at least one simulated user interaction;
   confirming based on the second compliance state that the altered non-compliant interface element matches the expected compliant configuration defined by the one or more predefined security governance policies, and generating a verification failure alert when the second compliance state indicates that the altered non-compliant interface element does not match the expected compliant configuration; and
   generating, through a compliance logging module, a tamper-evident audit record for each configuration deviation and each at least one corresponding corrective modification, the tamper-evident audit record comprising:
      an application identifier of the respective web-based application;
      an interface element identifier of the non-compliant interface element;
      the first compliance state of the non-compliant interface element prior to the at least one corrective modification;
      a description of the at least one corrective modification;
      a timestamp of the at least one corrective modification; and
      the second compliance state of the altered non-compliant interface element produced after the re-invoking.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method comprising:
determining a first compliance state for each of a plurality of interface elements rendered in a graphical user interface of a web application, wherein each interface element is associated with a security configuration setting of the web application, wherein the first compliance state is determined by applying a language model to on-screen textual content visible on the graphical user interface in association with the interface element, and wherein the first compliance state indicates whether the interface element is compliant or non-compliant with a predefined security baseline;
altering, by a graphical user interface agent through the graphical user interface, a configuration state of an interface element of the plurality of interface elements whose first compliance state indicates non-compliance, by dispatching a simulated user-facing input event to the web application;
after the altering, determining a second compliance state of the altered interface element by applying the language model to on-screen textual content associated with the altered interface element as rendered after the altering, the on-screen textual content associated with the altered interface element as rendered after the altering being produced by the web application in response to the simulated user-facing input event; and
confirming, based on the second compliance state, that the altered interface element matches an expected compliant configuration defined by the predefined security baseline.

2. The method of claim 1, wherein the simulated user-facing input event comprises at least one of a simulated mouse click, a simulated keyboard input, or a simulated control selection.

3. The method of claim 1, further comprising generating, for each of the plurality of interface elements, a structured representation comprising:
a security control category identifying a type of security policy governed by the interface element; and
the first compliance state, the first compliance state comprising a binary indicator of compliance or non-compliance of the interface element with the predefined security baseline.

4. The method of claim 1, wherein the on-screen textual content associated with the interface element comprises a label of the interface element, descriptive text rendered in proximity to the interface element, a tooltip rendered on hover or focus of the interface element, and a section heading under which the interface element is rendered.

5. The method of claim 1, wherein each of the plurality of interface elements comprises one of a toggle, a dropdown menu, a radio button, a slider, a checkbox, or a status indicator.

6. The method of claim 1, further comprising periodically repeating the determining of the first compliance state, the altering, the determining of the second compliance state, and the confirming for each of a plurality of web applications.

7. The method of claim 1, further comprising, in response to the second compliance state indicating that the altered interface element is non-compliant with the predefined security baseline, generating a verification failure alert.

8. The method of claim 1, further comprising generating a tamper-evident audit record comprising an identifier of the web application, an identifier of the altered interface element, the first compliance state, the simulated user-facing input event, a timestamp, and the second compliance state.

9. The method of claim 1, wherein the predefined security baseline is derived from at least one of Center for Internet Security benchmark controls, NIST Special Publication 800-53 security control requirements, SOC 2 trust service criteria, or an organizational security policy.

10. A system comprising at least one processor and at least one storage device coupled to the at least one processor and storing instructions that, when executed by the at least one processor, cause the system to:
determine, for each of a plurality of interface elements rendered in a graphical user interface of a web application, each of the plurality of interface elements being associated with a respective security configuration setting of the web application, a first compliance state by applying a language model to on-screen textual content associated with the interface element, the on-screen textual content being textual content visible on the graphical user interface at the time of the determining, and the first compliance state indicating whether the interface element is compliant or non-compliant with a predefined security baseline;
cause a graphical user interface agent to alter, through the graphical user interface, a configuration state of an interface element of the plurality of interface elements whose first compliance state indicates non-compliance, by dispatching a simulated user-facing input event to the web application;
after the altering, determine a second compliance state of the altered interface element by applying the language model to on-screen textual content associated with the altered interface element as rendered after the altering, the on-screen textual content associated with the altered interface element as rendered after the altering being produced by the web application in response to the simulated user-facing input event; and
confirm, based on the second compliance state, that the altered interface element matches an expected compliant configuration defined by the predefined security baseline.

11. The system of claim 10, wherein the simulated user-facing input event comprises at least one of a simulated mouse click, a simulated keyboard input, or a simulated control selection.

12. The system of claim 10, wherein the instructions further cause the system to generate, for each interface element, a structured representation comprising:
a security control category identifying a type of security policy governed by the interface element; and
the first compliance state, the first compliance state comprising a binary indicator of compliance or non-compliance of the interface element with the predefined security baseline.

13. The system of claim 10, wherein the on-screen textual content associated with the interface element comprises a label of the interface element, descriptive text rendered in proximity to the interface element, a tooltip rendered on hover or focus of the interface element, and a section heading under which the interface element is rendered.

14. The system of claim 10, wherein each of the plurality of interface elements comprises one of a toggle, a dropdown menu, a radio button, a slider, a checkbox, or a status indicator.

15. The system of claim 10, wherein the instructions further cause the system to periodically repeat the determining of the first compliance state, the altering, the determining of the second compliance state, and the confirming for each of a plurality of web applications.

16. The system of claim 10, wherein the instructions further cause the system to, in response to the second compliance state indicating that the altered interface element is non-compliant with the predefined security baseline, generate a verification failure alert.

17. The system of claim 10, further comprising a compliance logging module configured to generate a tamper-evident audit record comprising an identifier of the web application, an identifier of the altered interface element, the first compliance state, the simulated user-facing input event, a timestamp, and the second compliance state.

18. The system of claim 17, wherein the compliance logging module transmits the tamper-evident audit record in real time to an external compliance infrastructure system via at least one of Syslog, an HTTP webhook, or a message queuing protocol, the external compliance infrastructure system comprising at least one of a security information and event management platform or a security orchestration, automation, and response system.

19. The system of claim 10, wherein the determining of the first compliance state accommodates changes to the graphical user interface of the web application, including at least one of repositioned interface elements, modified labels of interface elements, or updated interface layouts.

20. A non-transitory computer-readable medium storing instructions that, when executed by at least one processor, cause the at least one processor to perform operations comprising:
determining, for each of a plurality of interface elements rendered in a graphical user interface of a web application, each of the plurality of interface elements being associated with a respective security configuration setting of the web application, a first compliance state by applying a language model to on-screen textual content associated with the interface element, the on-screen textual content being textual content visible on the graphical user interface at the time of the determining, and the first compliance state indicating whether the interface element is compliant or non-compliant with a predefined security baseline;
causing a graphical user interface agent to alter, through the graphical user interface, a configuration state of an interface element of the plurality of interface elements whose first compliance state indicates non-compliance, by dispatching a simulated user-facing input event to the web application;
after the altering, determining a second compliance state of the altered interface element by applying the language model to on-screen textual content associated with the altered interface element as rendered after the altering, the on-screen textual content associated with the altered interface element as rendered after the altering being produced by the web application in response to the simulated user-facing input event; and
confirming, based on the second compliance state, that the altered interface element matches an expected compliant configuration defined by the predefined security baseline.
